(19) United States
(12) Patent Application Publication
(10) Pub. No.: US 2026/0235942 A1
(43) Pub. Date: Aug. 13, 2026

(54) LIGHT-GUIDING OPTICAL COMPONENT, ILLUMINATION DEVICE USING LIGHT-GUIDING OPTICAL COMPONENT AND PROJECTION DISPLAY DEVICE USING ILLUMINATION DEVICE

(71) Applicant: Okamoto Glass Co., Ltd., Kashiwa-shi (JP)

(72) Inventor: Toshitaka NARA, Kashiwa-shi (JP)

(21) Appl. No.: 19/636,910

(22) Filed: Apr. 2, 2026

Related U.S. Application Data
(63) Continuation of application No. PCT/JP2024/031609, filed on Sep. 3, 2024.

(30) Foreign Application Priority Data
Feb. 16, 2024 (JP) 2024-021998
Jun. 11, 2024 (JP) 2024-094183

(51) Int. Cl. G03B 21/20; G03B 21/56

(52) U.S. Cl. CPC G03B 21/208; G03B 21/2033; G03B 21/56

(57) ABSTRACT

A light-guiding optical component in which a bottom face of a tapered portion of a first rectangular frustum with an inclination angle of β₁ or β₇ in the horizontal direction and β₂ or β₈ in the vertical direction serves as the light exit face and the top face serves as the incident face, and a rectangular CPC, a second rectangular frustum, an elliptical frustum or a circular CPC is formed continuously as the light incident portion with the top face as the bottom face. The inclination angle of the tangent plane at any position on the side faces of these incident portions is greater than the taper angle of the tapered portion at the corresponding position.

### CROSS-REFERENCE TO RELATED APPLICATIONS

This application claims the benefit of priority and is a Continuation application of the prior International Patent Application No. PCT/JP2024/031609, with an international filing date of Sep. 3, 2024, which designated the United States, and is related to the Japanese Patent Application No. 2024-021998, filed Feb. 26, 2024, and the Japanese Patent Application No. 2024-094183, filed Jun. 11, 2024, the entire disclosures of all applications are expressly incorporated by reference in their entirety herein.

### TECHNICAL FIELD

The present invention relates to a light-guiding optical component for guiding light beam from a light source, an illumination device using the light-guiding optical component and a projection display device (also referred to as a projector) using the illumination device, which enable a display element (also referred to as a light valve) such as a transmissive liquid crystal display element, a reflective liquid crystal display element and a DMD (Digital Micromirror Device) display element to be illuminated uniformly and with equal brightness across the surface while making effective use of the light beam from an LED light source.

### BACKGROUND OF THE INVENTION

A data projector is widely used as an image projection device for projecting screen display an image from a personal computer, a video image and the like onto a screen. In recent years, the projector has been used in applications different from conventional presentation use, such as a “smart projector” that can access websites and projecting the video on its own, and an “ultra-compact projector” of palm size.

Some projectors use ultra-high-pressure mercury lamps, LEDs, lasers and other light sources. In recent years, however, the projectors using LEDs as the light source have been increasing because of their long light source life and minimal temperature rise. Except for the types that draw images directly on a screen by means of a scanning laser, most projectors illuminate a light valve serving as a display element and project onto a screen the image reproduced by “on/off” control of light by the display element.

As for a general color projector using display elements, in addition to a method that reproduces images on separate display elements corresponding to three colors RGB and superimposes light carrying the image information, there is a method that illuminates a single display element in time-division fashion with three colors RGB to project the three-color images onto the screen in a time-division manner.

In order for images projected on a screen to appear bright and uniform, it is important to capture as much light from the light source as possible and to illuminate the display element uniformly. Various measures have been devised for illuminating the display element with uniform illuminance using the light emitted from the light source.

As the method for illuminating the display element uniformly, a method using a fly-eye lens and a method using a light tunnel are mainly used.

In an optical system using the fly-eye lens, a combination of two fly-eye lenses and a condenser lens is used so that a real image of each cell of the first fly-eye lens is projected to overlap on the display element. Thus, the illuminance distribution of each cell is averaged to achieve uniform illumination.

In an illuminance-uniformizing optical system using the light tunnel, the intensity at the exit face is uniformized by repeatedly reflecting the incident light inside the light tunnel, and the real image of the uniform illumination is projected onto the display element so that the display element is illuminated with uniform intensity.

When the angle formed between the light illuminating the display element and the optical axis becomes large, disadvantages arise such as decreased light utilization efficiency and difficulty in making compact the optical system for projecting images of the display element. Therefore, many optical systems for illuminating the display element with uniform illuminance are designed to reduce the angle formed between the illuminating light and the optical axis.

The use of a rod lens is proposed as a method for uniformly illuminating a display element (Patent Document 1). According to the above described method, the rod lens not only functions to guide light emitted from a light source to a subsequent polarizing plate, but also uniformizes the illuminance distribution of the light by repeatedly reflecting the light off the inner surface of the rod lens while the light passes through, thereby superimposing the light reflected at various angles at the exit face of the rod lens.

In order to efficiently utilize light emitted from a light source with a large divergence angle, such as an LED light source, and to obtain a bright projected image, a projection image display device is proposed (Patent Document 2) in which an illumination optical system has, for each light source unit, a light pipe array comprising a tapered light pipe having a flared shape that reduce the divergence angle of light rays from the light source unit.

### PRIOR ART DOCUMENT

### Patent Documents

Patent Document 1: Japanese Patent Application Publication No. 2003-329978
Patent Document 2: Japanese Patent Application Publication No. 2006-235338
Patent Document 3: Japanese Patent Application Publication No. H2-1818
Patent Document 4: Japanese Patent Application Publication No. H7-98416
Patent Document 5: Japanese Patent Application Publication No. H11-142780
Patent Document 6: Japanese Patent Application Publication No. 2004-252112
Patent Document 7: Japanese Patent Application Publication No. 2009-31717
Patent Document 8: Japanese Patent Application Publication No. 2011-133899
Patent Document 9: Japanese Patent Application Publication No. 2009-544063
Patent Document 10: Japanese Patent Application Publication No. 2007-199163
Patent Document 11: Japanese Patent Application Publication No. 2007-288169

### SUMMARY OF THE INVENTION

### Problem to be Solved by the Invention

In a light tunnel 101 having a solid rectangular pillar shape shown in FIG. 1, when a light ray entering through an incident face 102 propagates inside while totally reflecting off a side face 104, the angle formed between the light ray and the optical axis does not change. Thus, the angle formed between the light ray exiting through an exit face 103 and the optical axis is the same as the angle formed between the incident light and the optical axis.

In contrast, when a light ray forming an angle with the optical axis is incident on an incident face 202 of a tapered light tunnel 201 having a solid flared rectangular frustum shape tapered as shown in FIG. 2, the angle formed between the light ray and the optical axis decreases each time the light ray captured through the incident face 202 is reflected off an inclined side face 204 of the light tunnel while traveling toward an exit face 203.

Patent Document 3 discloses a light-guiding device having a substantially rectangular frustum shape in which the side faces are paraboloids (non-imaging curved surfaces). This is for the purpose of obtaining a substantially parallel light beam at the exit face of the light-guiding device.

Patent Document 4 also uses a flared light guide for the same reason. In Patent Document 4, as one example, a light guide having a tapered portion and a parallel portion, formed by combining a cylindrical frustum with a cylinder or by combining a cylindrical frustum with a hexagonal prism, is disclosed.

Patent Document 5 discloses a partial taper rod formed by combining a rectangular prism with a rectangular frustum, or by combining a rectangular prism with a cylindrical frustum. Patent Document 5 states that the parallelism of a convergent light beam from a light source lamp can be set to a desired value by controlling the taper angle of the partial taper rod. Thus, the spread angle of the illumination light beam can be reduced, and a relay optical system for forming an image on the illuminated surface can be made compact.

However, if the length of the tapered light tunnel 201 is not sufficient relative to the size of exit face 203, the light ray that is incident on the incident face 202 at a small angle cannot obtain a sufficient number of reflections, and the light ray that is incident on the incident face 202 at a large angle still has a large angle with the optical axis even when reaching the exit face 203 although the light ray has a relatively large number of reflections.

In order to uniformize the illuminance distribution at the exit face 203 by passing the light through a tapered light tunnel, a certain number of reflections at the side face 204 of the tapered light tunnel are needed. In general, it is therefore necessary to aim at increasing the number of reflections by guiding converging light or diverging light of high NA (NA: numerical aperture) to the incident face 202. In addition, when introducing the converging light or the diverging light of low NA with many light rays forming small angles with the optical axis, it is necessary to use a long light tunnel in order to increase the number of reflections.

On the other hand, a shorter tapered light tunnel is desirable for miniaturizing the optical system. However, to uniformize the illuminance distribution at the exit face 203 with a short light tunnel, it is necessary to guide the converging light or the diverging light of high NA, which tends to increase the divergence angle of the light exiting from the exit face 203.

The larger the angle formed between the side face 204 of the tapered light tunnel and the optical axis, the smaller the angle formed between the light ray reflected off the side face 204 and the optical axis tends to be, and the smaller the divergence angle of light exiting from exit face 203 tends to become. However, since a greater number of reflections are advantageous for achieving a uniform intensity distribution at the exit face 203, if the angle formed between the side face 204 and the optical axis is large, the illuminance distribution at the exit face 203 tends to become non-uniform. Namely, for a predetermined length of the light tunnel, it is considered that an appropriate range exists for the angle of inclination of the side face 204 of the tapered light tunnel with respect to the optical axis.

Therefore, in a tapered light tunnel having a short length relative to the size of the exit face 203, it becomes extremely difficult to simultaneously achieve both uniform illuminance distribution at the exit face 203 and a small divergence angle of the exiting light.

Patent Document 6 relates to an image projection device and an illumination device used in the image projection device. A lamp is placed at the first focal point of an elliptical reflective mirror, and the center of the incident face of a light tunnel is placed at the second focal point. The light tunnel comprises a tapered portion with a cross-sectional shape that continuously decreases from the incident face toward the exit face, and a parallel portion with a constant cross-sectional shape. The shape of the exit face is formed to be similar in shape to the incident face of the light valve. However, according to the above described invention, although the utilization efficiency of the incident light source is improved, since the light tunnel includes a parallel portion, the spread of the light beam at the exit face is not improved.

Patent Document 7 provides an optical system unit having a light-guiding device capable of emitting the light beam substantially parallel to the optical axis, and a projector equipped with the optical system unit. The optical system unit includes a light tunnel as a light-guiding device constituting a light-source-side optical system. The light tunnel is formed in a substantially flared rectangular frustum shape by having four plates forming upper, lower, left and right faces, arranging both side plates diagonally facing each other, and overlapping and fixing the upper and lower plates on the sides of the side plates. As a result, the side plates are formed diagonally so that the area of the exit face of the light tunnel is larger than the area of the incident face, enabling the horizontal angle of the light beam to be brought close to the light beam parallel to the optical axis. However, with a diagonally arranged light tunnel alone, as already described, uniformity of light and reduction of the divergence angle cannot be achieved simultaneously.

Patent Document 8 relates to a light-guiding device and a projector. For the purpose of capturing more of the light beam emitted from a light source device and emitting even the light beam forming a large angle with the optical axis as the light beam forming a gentle angle, the device comprises an externally rectangular hollow cylindrical light tunnel having a reflective surface on its inner surface with the inner space serving as a light guide path, and a glass rod having a flared inclined portion extending from the incident opening side toward the exit opening side end, with the inclined portion arranged within the light guide path of the light tunnel and the bottom face of the glass rod serving as the light exit. However, according to the above described invention, since the light-guiding device consists of a hollow cylindrical light tunnel having a reflective surface on its inner surface and a glass rod having a flared inclined portion, the problem of the light-guiding device being complex and expensive is unavoidable.

Patent Document 9 discloses a concentrator for use in the projection field. The concentrator collects light from surface-emitting light sources (e.g., LEDs) of different colors through input light pipes. As one example of the concentrator in the specification, a light pipe having a double-taper shape in one planar direction is disclosed.

Patent Document 10 aims to efficiently uniformize illumination unevenness at an exit face without extending the total length when diverging light is guided to an optical member having an optical face parallel to the optical axis. A light-guiding member is provided for guiding the diverging light emitted from a light source to an optical member having an optical face parallel to the optical axis. The light-guiding member comprises an incident end arranged on the light source side, an exit end arranged on the optical member side, and a plurality of tapered rod portions adjacently arranged along the direction of a central axis passing through substantially the centers of the incident end and the exit end. Each of the tapered rod portions has a shape that gradually widens from the incident end toward the exit end at a constant taper angle, and the taper angle of each tapered rod portion is set smaller than the taper angle of the adjacent tapered rod portion on the incident end side.

Patent Document 11 realizes an optical element that excels in light utilization efficiency and can be miniaturized, thinned and lightened with a simple configuration, as well as an illumination device and image display device using the same. In the optical element comprising a light source constituted by a light-emitting device capable of emitting a plurality of colors in which a plurality of colors form one set and desired elements can be selectively caused to emit light, and a rod lens array in which rod lenses having a first face and a second face as bottom faces are two-dimensionally arrayed, the first face being made of a member transparent to light from the light source and having an area equal to or greater than the area of the light source and facing the second face, the light source constituted by a light-emitting device comprising a plurality of colors in one set is arranged on the first face side of each rod lens in the rod lens array. This enables the illuminance of each rod lens to be uniformized so that the illuminance for each color can be uniformized at the second face of the rod lens array.

The problem to be solved by the present invention is to provide a light-guiding optical component that can capture even more light from an LED light source than conventional technology, that has uniform emission illuminance, and that can irradiate a light valve with the light beam having a small divergence angle, and that is more compact than conventional technology, along with an illumination device using the light-guiding optical component, and a projection image display device using the illumination device.

### Means for Solving the Problems

In order to solve the above conventional problems, the first embodiment of the present application is a light-guiding optical component comprising a solid tapered portion and a solid incident portion, wherein the solid tapered portion has a length L₁ and is a flared rectangular frustum (frustum of rectangular pyramid) that widens in a propagation direction of light at an angle β₁ in a height direction and at an angle β₂ in a width direction with respect to an optical axis from an incident face having a rectangular shape with a height H₁ and a width W₁ (square shape when H₁=W₁) toward an exit face having a rectangular shape with a height H₂ and a width W₂ (H₂>H₁, W₂>W₁), the solid incident portion has a length L₂ and is formed continuously with the solid tapered portion, the solid incident portion being a rectangular CPC having a bottom face of a rectangular shape with the height H₁ and the width W₁ and a top face of a rectangular shape with a height H₃ and a width W₃ (square shape when H₃=W₃), all upper/lower side faces and left/right side faces constituting the rectangular CPC are formed of internally reflective compound parabolic surfaces, an angle β₃ formed between a tangent plane at any position on the upper/lower side face and a horizontal plane containing the optical axis is greater than the angle β₁, an angle β₄ formed between a tangent plane at any position on the left/right side face and a vertical plane containing the optical axis is greater than the angle β₂, and a sum (total length L) of the length L₁ of the solid tapered portion and the length L₂ of the rectangular CPC is 1.5 times or more and 5 times or less a diagonal length D of the exit face of the solid tapered portion.

Here, the rectangular CPC refers to a shape having the form of a rectangular frustum with a top face, a bottom face and four side faces where all four side faces are formed of internally reflective compound parabolic surfaces. The light enters from the top face of the solid incident portion that is the rectangular CPC reflects off the upper/lower side faces and the left/right side faces, proceeds to the bottom face, advances to the incident face of tapered portion that is the flared rectangular frustum, repeats reflections off the side face of the tapered portion, and advances to the exit face to exit. The fact that the angle β₃ is greater than the angle β₁ and the angle β₄ is greater than the angle β₂ means that the light is reflected in the incident portion that is the rectangular CPC so that the direction of light propagation approaches the optical axis before the light enters the tapered portion that is the flared rectangular frustum.

Namely, in the above described light-guiding optical component, the light entering the top face, which is the rectangular or square top face having height H₃ and width W₃, is reflected off the four side faces (the upper/lower side faces and left/right side faces) of the rectangular CPC to greatly change direction, reaches the bottom face of the rectangular CPC having height H₁ and width W₁, enters directly into the tapered portion that is the flared rectangular frustum, and while repeating reflections off the side face of the tapered portion, reaches the rectangular exit face having height H₂ and width W₂ and exits from the exit face.

It is clarified by the ray-tracing simulation described later is that the illuminance distribution of light rays at the exit face of the tapered portion stably becomes uniform and the divergence angle of light rays diverging from the exit face stably becomes small (i.e., the rectilinearity also increases) when the sum (total length L) of the length L₁ of the tapered portion and the length L₂ of the rectangular CPC is at least 1.5 times the diagonal length D of the exit face of the rectangular frustum that is the tapered portion having the height H₂ and the width W₂. At that time, the length L₂ of the rectangular CPC is in the range of 2.4% to 13.4% of the length L₁ of the tapered portion, the angle β₁ is in the range of 1.9° to 5.8°, and the angle 2 is in the range of 4.1° to 13.8°. Note that the size of the rectangular exit face having the height H₂ and the width W₂ is equal to, or at least similar in shape to, the size of the display element irradiated by the light-guiding optical component of the present invention.

FIG. 3 illustrates one example of the configuration of the light-guiding optical component of the first embodiment. 301 is an overall view, and it can be described as a light tunnel having a double-taper structure consisting of an incident portion that is a rectangular CPC and a tapered portion that is a rectangular frustum. An upper side face 305 of the rectangular frustum serving as the flared tapered portion is formed continuously with an upper side face 307 of the incident portion that is the rectangular CPC, and a right side face 304 of the rectangular frustum is formed continuously with a right side face 308 of the incident portion that is the rectangular CPC. The same applies to a lower side face and a left side face. A top face 302 of the rectangular CPC serves as the incident face for the light from the light source, and a bottom face 303 of the frustum of the rectangular frustum that is the flared tapered portion serves as the exit face. Note that a virtual face 306 is the bottom face of the rectangular CPC and is also the incident face of the frustum of the rectangular frustum.

Here, the inclination angle β₁ (taper angle β₁) that is the angle formed between the horizontal plane containing the optical axis and the upper side face 305 or the lower side face of the tapered portion, and the angle β₂ (taper angle β₂) that is the angle formed between the vertical plane containing the optical axis and the left or right side face 304 of the tapered portion, are as follows (shown in FIG. 4 and FIG. 5).

$${β}_{1} = arctan \{ \{ {H}_{2} - {H}_{1} ) / 2 {L}_{1} \} , {β}_{2} = arctan \{ \{ {W}_{2} - {W}_{1} ) / 2 {L}_{1} \}$$

For the light reflected on the tapered face, a light ray closer to the optical axis improves in parallelism by approximately 21 in the height direction per reflection of the upper/lower faces, and by approximately 232 in the width direction per reflection of the left/right faces. In the present invention, it is found that uniformization of light from the light source and reduction of the divergence angle can be achieved with a shorter length than in the conventional tapered light tunnel when the total length L, which is the sum of the length L₁ of the tapered portion and the length L₂ of the incident portion, is 1.5 times or more the diagonal length D of the exit face. However, it is also found that uniformization of light from the light source and reduction of the divergence angle can be achieved even with a conventional tapered light tunnel when the length is 6 times or more the diagonal length D of the exit face. Therefore, the advantage of the first embodiment lies in the fact that uniformization of light from the light source and reduction of the divergence angle, which cannot be realized with conventional examples, can be achieved even when the total length L is 1.5 times or more and 5 times or less the diagonal length D of the exit face.

In the first embodiment, as the incident portion, an incident portion of a rectangular CPC with the top face 306 of the rectangular frustum that is the tapered portion as the bottom face is further formed continuously, and the top face 302 of the rectangular CPC serves as the incident face for light from the light source. As shown in FIG. 6, the light that enters the incident face 302 at a large incidence angle first strikes the side face 307 of the incident portion and rapidly reduces the angle formed with the optical axis, then proceeds to the tapered portion. At any position on the upper side face 307, which is the upper side face of the incident portion, the angle β₃ formed between the tangent and the optical axis is greater than the taper angle β₁ of the tapered portion. As for the above described relationship, the angle formed between the tangent plane at a certain position and the horizontal plane or the vertical plane containing the optical axis is greater than the corresponding taper angle of the tapered portion also in the lower side face, the left side face and the right side face of the incident portion.

FIG. 7 illustrates how the light entering the light-guiding optical component of the first embodiment repeats reflections in the incident portion and the tapered portion and reaches the exit face. Due to the presence of the incident portion comprising the rectangular CPC, the light entering the incident face 302 of the incident portion reaches the exit face 303 of the tapered portion in a uniformized manner with a shorter length than the conventional tapered light tunnel which serves as the light-guiding optical component consisting only of the rectangular frustum.

Next, the second embodiment of the present application is a light-guiding optical component comprising a solid tapered portion and a solid incident portion, wherein the solid tapered portion has a length L₁ and is a first flared rectangular frustum that widens in a propagation direction of light at an angle β₁ in a height direction and at an angle β2 in a width direction with respect to an optical axis from an incident face having a rectangular shape (square shape when H₁=W₁) with a height H₁ and a width W₁ toward an exit face having a rectangular shape with a height H₂ and a width W₂ (H₂>H₁, W₂>W₁), the solid incident portion has a length L₂ and is formed continuously with the solid tapered portion, the solid incident portion being a second rectangular frustum having a bottom face of a rectangular or square shape with the height H₁ and the width W₁ and a top face of a rectangular or square shape with a height H₃ and a width W₃, four side faces of the second rectangular frustum are formed of flat trapezoids, an angle β₅ formed between each of the flat trapezoids of upper/lower side faces and a horizontal plane containing the optical axis is greater than the angle β1 at any position, an angle β₆ formed between each of the flat trapezoids of left/right side faces and a vertical plane containing the optical axis is greater than the angle β₂ at any position, and a sum (total length L) of the length L₁ of the solid tapered portion and the length L₂ of the second rectangular frustum is 2.4 times or more and 5 times or less a diagonal length D of the exit face of the solid tapered portion that is the first flared rectangular frustum. As will be explained in detail later, the length L₂ of the second rectangular frustum is in the range of 5.8% to 19.6% of the length L₁ of the tapered portion, the angle β₁ is in the range of 1.1° to 3.3°, and the angle β₂ is in the range of 3.3° to 6.4°.

Namely, in the second embodiment, the second rectangular frustum with taper angles β₈ and β₆ and length L₂ is formed continuously with the first rectangular frustum, the relationship β₅>β₁ and β₆>β₂ is satisfied in the taper angles β₁ and 2 and the length L₁, and the relationship 2.4D≤L (=L₁+L₂)≤5D is satisfied between the diagonal length D of the incident face and the total length L. The relationship 5.8% L₁≤L_{2≤19.6}% L₁ is satisfied between the length L₂ of the incident portion and the length L₁ of the tapered portion, and the ranges are 1.1≤β_{1≤ 3.3}° and 3.3°≤β_{2≤6.4} at that time.

In the second embodiment, the light-guiding optical component has the incident portion that is the second rectangular frustum formed continuously with the tapered portion that is the first rectangular frustum. Thus, the four side faces that are trapezoids of the second rectangular frustum are formed continuously with the four side faces that are trapezoids of the first rectangular frustum. The taper angle β₅, which is the angle formed between two of the four side faces of the second rectangular frustum (i.e., the upper and lower two side faces) and the optical axis, is greater than the taper angle β₁, which is the angle formed between two of the four side faces of the first rectangular frustum (i.e., the upper and lower two side faces) and the optical axis, and the taper angle β₆, which is the angle formed between two of the four side faces of the second rectangular frustum (i.e., the left and right two side faces) and the optical axis, is greater than the taper angle 2, which is the angle formed between two of the four side faces of the first rectangular frustum (i.e., the left and right two side faces) and the optical axis.

In the above described light-guiding optical component, the light entering the square or rectangular top face of the second rectangular frustum having the height H₃ and the width W₃ is reflected off the side face of the second rectangular frustum to change direction, reaches the bottom face of the second rectangular frustum having the height H₁ and the width W₁, enters directly into the tapered portion that is the flared first rectangular frustum, reaches the rectangular exit face having the height H₂ and the width W₂ while repeating reflections off the side face, and exits from the exit face.

Namely, in the light-guiding optical component of the second embodiment as well, the light entering the top face of the second rectangular frustum is reflected off the upper, lower, left and right side faces of the second rectangular frustum according to the inclination angle β₅ or β₆ to greatly change its direction of propagation, approaches the optical axis, and proceeds toward the exit face that is the bottom face. Then, the light enters the tapered portion that is the first rectangular frustum, changes its direction of propagation according to the taper angle β₁ in the height direction and the taper angle β₂ in the width direction with respect to the optical axis, and proceeds in a manner increasingly approaching the optical axis.

As described above, this is the effect of the fact that the angle β₅ formed with the optical axis is greater than the angle β₁ at any position on the upper/lower side faces among the four side faces of the second rectangular frustum and the angle β₆ formed with the optical axis is greater than the angle β₂ of the tapered portion at any position on the left/right side faces among the four side faces. Due to the presence of the above described second rectangular frustum, the light entering the incident face of the second rectangular frustum reaches the exit face of the first rectangular frustum in a uniformized manner with a shorter length than the light-guiding optical component consisting only of the first rectangular frustum serving as the conventional tapered light tunnel.

In the second embodiment, the sum (total length L) of the length L₁ of the tapered portion that is the first rectangular frustum and the length L₂ of the second rectangular frustum must be 2.4 times or more and 5 times or less the diagonal length D of the exit face. When the total length L is below 2.4 times, the conditions for improving the uniformity of the exiting light could not be found. When the total length L exceeds 5 times and reaches 6 times, the light beam can be approximately uniform at the exit face with a small divergence angle even by a conventional tapered light tunnel. However, a uniform light beam with a small divergence angle could not be produced by a conventional tapered light tunnel of 5 times or less.

In the second embodiment, when uniformization of the exiting light and narrowing of the divergence angle were achieved, the length L₂ of the incident portion was in the range of 5.8% to 19.6% of the length L₁ of the tapered portion. At that time, the inclination angle β₁ of the tapered portion that was the first rectangular frustum was in the range of 1.1° to 3.3°, and the inclination angle β₂ of the tapered portion was in the range of 3.3° to 6.4°.

The first embodiment and the second embodiment are the same in that they have the first rectangular frustum as the tapered portion with taper angles β₁ and β₂, but differ in the shape of the incident portion formed continuously with the tapered portion. In the first embodiment, as shown in the development view of FIG. 8, the side face of the rectangular CPC of the incident portion is an internally reflective compound parabolic surface. In the second embodiment, as shown in the development view of FIG. 9, a simple rectangular frustum is adopted. Both the first embodiment and the second embodiment are the same in that the inclination angle at each position of the incident portion is greater than the corresponding taper angle of the first rectangular frustum.

Next, the third embodiment of the present application is a light-guiding optical component comprising a tapered portion and an incident portion, wherein the tapered portion has a length L₁ and is a first flared solid rectangular frustum that widens in a propagation direction of light at an angle β₇ in a height direction and at an angle β₈ in a width direction with respect to an optical axis from an incident face having a rectangular shape with a height a₁ and a width b₁ toward an exit face having a rectangular shape with a height H₂ and a width W₂ (H₂>a₁, W₂>b₁), the incident portion has a length L₂ and is formed continuously with the tapered portion, the incident portion being an elliptical frustum (frustum of elliptical cone) having a bottom face having a rectangular shape with a height a₁ and width b₁ and a top face having an ellipse shape with a minor axis a₃ and a major axis b₃, an angle β, formed between an inclined face and the optical axis of the elliptical frustum is greater than the angle β₇ and the angle β8 at any position, and a total length L of the length L₁ of the tapered portion and the length L₂ of the elliptical frustum is 2 times or more and 5 times or less a diagonal length D of the exit face of the tapered portion. In the above described light-guiding optical component, both uniformity of light at the exit face and narrowing of the divergence angle are achieved.

When both uniformity of light at the exit face and narrowing of the divergence angle are achieved, the length L₂ of the elliptical frustum is in the range of 14.2% to 41.6% of the length L₁ of the tapered portion, the angle β₇ is in the range of 1.2° to 4.2°, and the angle β₈ is in the range of 3.1° to 7.3°.

The difference between the third embodiment and the second embodiment is that the incident portion is the elliptical frustum of the length L₂, not the rectangular frustum of the length L₂ (shown in FIG. 10 and FIG. 13). FIG. 13 shows only the incident portion that is the elliptical frustum.

The taper angle β₇ formed between the upper/lower faces of the tapered portion and the optical axis, and the taper angle β₈ formed between the left/right faces and the optical axis, are as follows (shown in FIG. 11 and FIG. 12).

$${β}_{7} = arctan \{ \{ {H}_{2} - {a}_{1} ) / 2 {L}_{1} \} , {β}_{8} = arctan \{ \{ {W}_{2} - {b}_{1} ) / 2 {L}_{1} \}$$

For the light ray reflected on the tapered face, the parallelism of the light traveling in a direction approximately perpendicular to the optical axis improves by approximately 2β7 in the height direction in each reflection, and the parallelism of the light traveling in a direction approximately horizontal to the optical axis improves by approximately 2β₈ in the width direction in each reflection.

In FIG. 10, the bottom face 303 of the flared rectangular frustum is the rectangular exit face. In the present invention, a tapered elliptical frustum is formed continuously with the top face of the rectangular frustum as the bottom face, and the top face of the tapered elliptical frustum is elliptical and serves as the light incident face 302.

The light entering the incident face 302 of the incident portion of the elliptical frustum at a large incidence angle strikes the inner side face (inclination angle β₉) of the elliptical frustum, which has a steeper inclination than the inclination angles β₇ and β₈ of the tapered portion, is reflected, and greatly reduces the angle with the optical axis. After entering the tapered portion, the angle with the optical axis decreases by approximately 2β₇ or 2β₈ per reflection, and the light reaches the exit face 303 while improving uniformity. The length L₁ of the tapered portion can be made sufficiently shorter than the length of a conventional tapered light tunnel. Specifically, the sum (total length L) of the length L₁ of the tapered portion and the length L₂ of the elliptical frustum may be 2 times or more and 5 times or less the diagonal length D of the exit face.

In the behavior of the light rays inside the light-guiding optical component of the present invention shown in FIG. 3 and FIG. 10, the incident light contains a mixture of light rays forming large angles with the optical axis and light rays forming small angles with the optical axis. By selectively reflecting only light rays with large inclination angles off the side face of the incident portion, the angle formed between the reflected light rays and the optical axis is greatly reduced, while light rays that already form small angles with the optical axis at the stage of entering the incident face are not reflected off the side face of the incident portion and enter directly. Since these rays are reflected only off the side face of the tapered portion, the number of reflections is not reduced. This enables narrowing the light rays exiting from the exit face without greatly reducing the uniformity of illuminance distribution at the exit face.

In addition, by adopting a double-taper structure that combines the two shapes of the incident portion and the tapered portion, the degree of freedom in design increases compared to the tapered light tunnel having a simple rectangular frustum shown in FIG. 2. Therefore, by independently adjusting the shapes of the incident portion and the tapered portion, it is possible to contribute to uniformization of the illuminance distribution at the exit face.

For these reasons, in the third embodiment, it becomes possible in a short light-guiding optical component in which the total length L is 2 times or more and 5 times or less the diagonal length D of the exit face to simultaneously achieve both uniformization of the illuminance distribution at the exit face and narrowing of the divergence angle of the exiting light.

FIG. 14 shows that the side face of the elliptical frustum is a paraboloid bulging outward, which can also be regarded as a variation of the shape of the incident portion in the third embodiment. FIG. 13 shows a simple elliptical frustum, while FIG. 14 shows that the inclined face of the elliptical frustum is a paraboloid or a singly curved surface bulging outward.

Next, the fourth embodiment of the present application is a light-guiding optical component comprising a tapered portion and an incident portion, wherein the tapered portion has a length L₁ and is a flared rectangular frustum that widens at an angle β₇ in a height direction and at an angle β₈ in a width direction with respect to an optical axis from an incident face having a rectangular shape with a height a₁ and a width b₁ toward an exit face having a rectangular with a height H₂ and a width W₂, the incident portion has a length L₂ and is formed continuously with the tapered portion is an incident portion having a length L₂, the incident portion comprising a circular CPC having a rectangular bottom face with a height a₁ and a width b₁ and a circular top face with a diameter a₃, and a side face that is an internally reflective paraboloid, an angle β₁₀ formed between a tangent plane on the side face of the incident portion and the optical axis is greater than the angle β₇ and the angle β₈ at any position, and a total length L of the length L₁ of the tapered portion and the length L₂ of the circular CPC is in the range of 2.4 times or more and 5 times or less a diagonal length D of the exit face of the tapered portion.

Namely, the incident portion of the fourth embodiment is a circular CPC as shown in FIG. 15. The top face of the incident portion is not elliptical but circular with a diameter a₃, the bottom face of the incident portion is a rectangle of a₁×b₁, and the side face of the incident portion is an internally reflective compound parabolic surface (the above described shape of the incident portion is called a circular CPC). The tapered portion, as in the third embodiment, comprises a flared rectangular frustum that widens at an angle β₇ in the height direction and at an angle β₈ in the width direction with respect to the optical axis, from the rectangular incident face having the height a₁ and the width b₁ toward the rectangular exit face having the height H₂ and the width W₂. The length of the incident portion is L₂. The inclination angle β₁₀ of the tangent plane is greater than the angles β₇ and β₈ formed between the side face of the flared rectangular frustum that is the tapered portion and the optical axis at any position on the side face of the circular CPC that is the incident portion.

In the fourth embodiment, when the sum (total length L) of the length L₁ of the tapered portion and the length L₂ of the incident portion that is the circular CPC is in the range of 2.4 times or more and 5 times or less the diagonal length D of the exit face, excellent uniformity of light at the exit face and a small divergence angle are obtained. At that time, the length L₂ of the circular CPC is in the range of 11.3% to 16.7% of the length L₁ of the tapered portion, the angle β₇ is in the range of 0.5° to 3.5°, and the angle β₈ is in the range of 3.0° to 8.1°.

The light enters the circular incident face of the incident portion, is reflected off the paraboloid to proceed in a direction approaching the optical axis, and enters the tapered portion. In the tapered portion, the light is brought approximately 2β₇° closer to the optical axis in each reflection of the upper/lower faces although it depends on the incidence angle and the direction, and the light is brought approximately 2β₈° closer to the optical axis in each reflection of the left/right faces although it depends on the incidence angle and direction, and the light proceeds toward the exit face while improving uniformity, and exits from the exit face.

In the first to fourth embodiments of the present application, when the exit face or the incident face is described as rectangular, it is not strictly necessary for the four corners to be right angles. The corners may be rounded for the purpose of preventing damage due to contact or the like.

Here, in the first to fourth embodiments, as shown in FIG. 16, a converging lens or diverging lens may be integrated at the position of the exit face of the light-guiding optical component to form a light-guiding optical component having a converging action or diverging action. The converging lens or diverging lens used here normally has one face that is approximately flat and is integrated with the exit face, while the opposite face is a convex lens or concave lens having a curvature. This eliminates loss due to divergence of light components with a large divergence angle at the exit face position, enabling irradiation forward from the converging lens. In the case of using the diverging lens, the irradiation area can be increased.

The fifth embodiment of the present application is a light-guiding optical component in which a plurality of light-guiding optical components disclosed in any one of the first to fourth embodiments of the present application is arranged and integrated. The “plurality” may be two or may be arranged in M rows and N columns, for example. When described as M rows and N columns, at least one of M or N is two or more. When constituting an illumination device, the number and arrangement are made equal to those of LED elements, and the incident face of the incident portion of each light-guiding optical component is arranged facing each LED element. For example, if the LED elements are arranged in two rows and three columns, the light-guiding optical components are also arranged in two rows and three columns and integrated, and the incident face of the incident portion of each light-guiding optical component is arranged in contact with each LED element to form an illumination device. In the M-row N-column arrangement, it is possible not to arrange the light-guiding optical component at the corners or to omit some of the central portion for ease of handling, to prevent damage due to contact, or from the standpoint of ease of manufacture. Even in the above described examples, there is no significant problem with the uniformity of illuminance on the irradiated face. Also in the fifth embodiment, a converging lens or diverging lens may be integrated at the position of the exit face as shown in FIG. 16.

FIG. 17 and FIG. 18 illustrate one aspect of the five-row five-column light-guiding optical component that is one embodiment of the fifth embodiment. FIG. 17 is an overall perspective view seen from the exit face side of light. FIG. 18 is a front view seen from the incident face side of light. In this embodiment, a converging lens is integrated at the exit face of each light-guiding optical component. In this embodiment, in the five-row five-column configuration, the size of the exit face has a shape similar to the shape of the light valve that is the display element.

The sixth embodiment of the present application is an illumination device in which an LED element is arranged in contact with the incident face of the incident portion of the light-guiding optical component described in any one of the first to fifth embodiments of the present application. For example, the sixth embodiment is an illumination device in which an LED element is arranged in contact with the position of the incident face 302 in FIG. 3 or the position of the incident face 302 in FIG. 10. Regardless of which light-guiding optical component is used, an illumination device with a uniform illuminance distribution at the exit face can be obtained.

The seventh embodiment of the present application is a projection display device comprising the illumination device of the sixth embodiment, in which the light beam at the exit face of the illumination device is condensed by a condenser lens system and irradiated onto a light valve that is a display element, an image generated by the display element is enlarged by an enlargement projection optical system, and projected onto a screen.

One example of the configuration of the projection display device is shown in FIG. 19. The examples of the light valve for the projection display device include a transmissive liquid crystal display panel, a reflective liquid crystal display panel and a DMD (Digital Micromirror Device). According to the present invention, since uniform parallel light with uniform illuminance can be obtained, the effect on the DMD display element arranged at a distance from the light source and the light-guiding optical component is particularly great.

Since it is assumed that uniform illuminance is achieved by projecting a real image of the exit face 303 onto a display element such as a liquid crystal display element or DMD used in a projector or the like, it is desirable that the ratio of the width to the height of the exit face 303 is approximately the same as that of the display element. The ratio of the width W to the height H of the display element is typically 16:9 or 4:3.

### Effects of the Invention

According to the light-guiding optical component of the present invention, by separately controlling the parameters of the incident portion and the tapered portion, and setting the inclination angle at each position of each side face of the incident portion to be greater than the taper angle of the tapered portion, with a total length equal to or shorter than that of the conventional tapered light tunnel, the light from the light source reaches the exit face of the light-guiding optical component as uniform light with a small divergence angle, with a short length that could not be achieved with conventional examples. The ratio of the diagonal length D of the exit face to the sum (total length L) of the length L₁ of the tapered portion and the length L₂ of the incident portion is in the range of 1.5 to 5 when the incident portion is a rectangular CPC, 2.4 to 5 when the incident portion is the second rectangular frustum, 2 to 5 when the incident portion is the elliptical frustum, and 2.4 to 5 when the incident portion is a circular CPC. Thus, uniform exit light with a small divergence angle can be obtained. In addition, by arranging and integrating a plurality of light-guiding optical components, a light-guiding optical component with a large area can be obtained.

According to the illumination device using the light-guiding optical component and the LED light-emitting elements of the present invention, an illumination device with a uniform illuminance distribution and small divergence angle can be obtained. Furthermore, a light-guiding optical component formed by arranging and integrating a plurality of light-guiding optical components, together with LED light-emitting elements, can constitute an illumination device that emits light over a wide area.

According to the projection display element using the illumination device of the present invention, since the light valve is irradiated with illumination of narrow divergence angle at an extremely uniform illuminance, a projected image with excellent illuminance distribution can be projected onto a screen. According to the illumination device of the present invention, since parallel light with a uniform illuminance distribution and small divergence angle can be irradiated, it is suitable for use in a projection display device using a DMD in which the distance between the illumination device and the light valve is large.

### BRIEF DESCRIPTION OF DRAWINGS

FIG. 1 is a diagram showing reflection of light in a light tunnel having a rectangular pillar shape.

FIG. 2 is a diagram showing reflection of light in a tapered light tunnel having a flared rectangular frustum shape.

FIG. 3 is a perspective view showing one example of the configuration of a light-guiding optical component according to the first embodiment of the present application.

FIG. 4 is a side view of one example of the configuration of the light-guiding optical component according to the first embodiment of the present application.

FIG. 5 is a plan view of one example of the configuration of the light-guiding optical component according to the first embodiment of the present application.

FIG. 6 is a diagram showing a path of light entering an incident portion of the first embodiment of the present application.

FIG. 7 is a diagram showing how the light entering an incident face reaches and exits from an exit face in the first embodiment of the present application.

FIG. 8 is a diagram showing a rectangular CPC that is the incident portion of the light-guiding optical component of the first embodiment of the present application.

FIG. 9 is a diagram showing a rectangular frustum that is the incident portion of the light-guiding optical component of the second embodiment of the present application.

FIG. 10 is a perspective view showing one example of the configuration of the light-guiding optical component according to the third embodiment of the present application.

FIG. 11 is a side view of one example of the configuration of the light-guiding optical component according to the third embodiment of the present application.

FIG. 12 is a plan view of one example of the configuration of the light-guiding optical component according to the third embodiment of the present application.

FIG. 13 is a diagram showing an elliptical frustum that is the incident portion of the light-guiding optical component of the third embodiment of the present application.

FIG. 14 is a diagram showing another embodiment of the elliptical frustum that is one example of the incident portion of the light-guiding optical component of the third embodiment of the present application.

FIG. 15 is a diagram showing a circular CPC that is one example of the incident portion of the light-guiding optical component of the fourth embodiment of the present application.

FIG. 16 is a diagram showing an example in which a converging lens is integrated at the exit face of the light-guiding optical component that is one example of the first embodiment of the present application.

FIG. 17 is a perspective view showing one example of the light-guiding optical component formed by arranging and integrating a plurality of light-guiding optical components of the first embodiment of the present application.

FIG. 18 is a plan view showing one example of the light-guiding optical component formed by arranging and integrating a plurality of light-guiding optical components of the first embodiment of the present application.

FIG. 19 is a diagram showing one example of the configuration of a projection display device of the seventh embodiment of the present application using one example of an illumination device of the sixth embodiment of the present application.

FIG. 20 is a diagram showing an angle β₃ formed between a tangent plane and a horizontal plane containing an optical axis at any position of an upper/lower face of the rectangular CPC in the first embodiment of the present application.

FIG. 21 is a diagram showing one example of a result of a ray-tracing simulation for light rays entering the light-guiding optical component of the first embodiment.

FIG. 22 is a diagram showing one example of an illuminance distribution in the X direction (width direction) at the exit face of light rays entering the light-guiding optical component of the first embodiment.

FIG. 23 is a diagram showing one example of an illuminance distribution in the Y direction (height direction) at the exit face of light rays entering the light-guiding optical component of the first embodiment.

FIG. 24 is a diagram showing one example of a divergence angle distribution in the X direction (width direction) and the Y direction (height direction) at the exit face of light rays entering the light-guiding optical component of the first embodiment.

FIG. 25 is a diagram showing another example of the result of a ray-tracing simulation for light rays entering the light-guiding optical component of the first embodiment.

FIG. 26 is a diagram showing another example of the illuminance distribution in the X direction (width direction) at the exit face of light rays entering the light-guiding optical component of the first embodiment.

FIG. 27 is a diagram showing another example of the illuminance distribution in the Y direction (height direction) at the exit face of light rays entering the light-guiding optical component of the first embodiment.

FIG. 28 is a diagram showing another example of the divergence angle distribution in the X direction and the Y direction at the exit face of light rays entering the light-guiding optical component of the first embodiment.

FIG. 29 is a diagram showing one example of the result of a ray-tracing simulation for light rays entering a tapered light tunnel serving as a comparative example.

FIG. 30 is a diagram showing one example of the illuminance distribution in the X direction at the exit face of light rays entering a tapered light tunnel serving as a comparative example.

FIG. 31 is a diagram showing one example of the illuminance distribution in the Y direction at the exit face of light rays entering a tapered light tunnel serving as a comparative example.

FIG. 32 is a diagram showing one example of the result of a ray-tracing simulation for light rays entering the light-guiding optical component of the second embodiment.

FIG. 33 is a diagram showing one example of the illuminance distribution in the X direction (width direction) at the exit face of light rays entering the light-guiding optical component of the second embodiment.

FIG. 34 is a diagram showing one example of the illuminance distribution in the Y direction (height direction) at the exit face of light rays entering the light-guiding optical component of the second embodiment.

FIG. 35 is a diagram showing one example of the divergence angle distribution in the X direction (width direction) and the Y direction (height direction) at the exit face of light rays entering the light-guiding optical component of the second embodiment.

FIG. 36 is a diagram showing another example of the result of a ray-tracing simulation for light rays entering the light-guiding optical component of the second embodiment.

FIG. 37 is a diagram showing another example of the illuminance distribution in the X direction (width direction) at the exit face of light rays entering the light-guiding optical component of the second embodiment.

FIG. 38 is a diagram showing another example of the illuminance distribution in the Y direction (height direction) at the exit face of light rays entering the light-guiding optical component of the second embodiment.

FIG. 39 is a diagram showing another example of the divergence angle distribution in the X direction and the Y direction at the exit face of light rays entering the light-guiding optical component of the second embodiment.

FIG. 40 is a diagram showing one example of the result of a ray-tracing simulation for light rays entering the light-guiding optical component of the third embodiment.

FIG. 41 is a diagram showing one example of the illuminance distribution in the X direction (width direction) at the exit face of light rays entering the light-guiding optical component of the third embodiment.

FIG. 42 is a diagram showing one example of the illuminance distribution in the Y direction (height direction) at the exit face of light rays entering the light-guiding optical component of the third embodiment.

FIG. 43 is a diagram showing one example of the divergence angle distribution in the X direction (width direction) and the Y direction (height direction) at the exit face of light rays entering the light-guiding optical component of the third embodiment.

FIG. 44 is a diagram showing another example of the result of a ray-tracing simulation for light rays entering the light-guiding optical component of the third embodiment.

FIG. 45 is a diagram showing another example of the illuminance distribution in the X direction (width direction) at the exit face of light rays entering the light-guiding optical component of the third embodiment.

FIG. 46 is a diagram showing another example of the illuminance distribution in the Y direction (height direction) at the exit face of light rays entering the light-guiding optical component of the third embodiment.

FIG. 47 is a diagram showing another example of the divergence angle distribution in the X direction and the Y direction at the exit face of light rays entering the light-guiding optical component of the third embodiment.

FIG. 48 is a diagram showing an angle β₁₀ formed between the tangent plane and the optical axis at any position of the circular CPC that is the incident portion in the fourth embodiment.

FIG. 49 is a diagram showing one example of the result of a ray-tracing simulation for light rays entering the light-guiding optical component of the fourth embodiment.

FIG. 50 is a diagram showing one example of the illuminance distribution in the X direction (width direction) at the exit face of light rays entering the light-guiding optical component of the fourth embodiment.

FIG. 51 is a diagram showing one example of the illuminance distribution in the Y direction (height direction) at the exit face of light rays entering the light-guiding optical component of the fourth embodiment.

FIG. 52 is a diagram showing one example of the divergence angle distribution in the X direction (width direction) and the Y direction (height direction) at the exit face of light rays entering the light-guiding optical component of the fourth embodiment.

FIG. 53 is a diagram showing another example of the result of a ray-tracing simulation for light rays entering the light-guiding optical component of the fourth embodiment.

FIG. 54 is a diagram showing another example of the illuminance distribution in the X direction (width direction) at the exit face of light rays entering the light-guiding optical component of the fourth embodiment.

FIG. 55 is a diagram showing another example of the illuminance distribution in the Y direction (height direction) at the exit face of light rays entering the light-guiding optical component of the fourth embodiment.

FIG. 56 is a diagram showing another example of the divergence angle distribution in the X direction and the Y direction at the exit face of light rays entering the light-guiding optical component of the fourth embodiment.

FIG. 57 is a diagram showing the illuminance distribution in the X direction (width direction) for the case (Example 51) where the total length L is only 1.2 times the exit face diagonal D in the light-guiding optical component according to the first embodiment.

FIG. 58 is a diagram showing the illuminance distribution in the Y direction (height direction) for the case (Example 51) where the total length L is only 1.2 times the exit face diagonal D in the light-guiding optical component according to the first embodiment.

FIG. 59 is a diagram showing the illuminance distribution in the X direction (width direction) for the case (Example 52) where the total length L is only 1.8 times the exit face diagonal D in the light-guiding optical component according to the third embodiment.

FIG. 60 is a diagram showing the illuminance distribution in the Y direction (width direction) for the case (Example 52) where the total length L is only 1.8 times the exit face diagonal D in the light-guiding optical component according to the third embodiment.

FIG. 61 is a diagram showing the illuminance distribution in the X direction (width direction) for the case (Example 54) where the total length L is 2.4 times the exit face diagonal D in the light-guiding optical component according to the second embodiment.

FIG. 62 is a diagram showing the illuminance distribution in the Y direction (width direction) for the case (Example 54) where the total length L is 2.4 times the exit face diagonal D in the light-guiding optical component according to the second embodiment.

FIG. 63 is a diagram showing the illuminance distribution in the X direction (width direction) for the case (Example 55) where the total length L is 2.4 times the exit face diagonal D in the light-guiding optical component according to the fourth embodiment.

FIG. 64 is a diagram showing the illuminance distribution in the Y direction (width direction) for the case (Example 55) where the total length L is 2.4 times the exit face diagonal D in the light-guiding optical component according to the fourth embodiment.

FIG. 65 is a diagram showing the result of a ray-tracing simulation for light rays entering the light-guiding optical component in which a plurality of light-guiding optical components (five rows, five columns) of the sixth embodiment are integrated.

FIG. 66 is a diagram showing the illuminance distribution in the X direction of light rays entering the light-guiding optical component in which a plurality of light-guiding optical components (five rows, five columns) of the sixth embodiment are integrated.

FIG. 67 is a diagram showing the illuminance distribution in the Y direction of light rays entering the light-guiding optical component in which a plurality of light-guiding optical components (five rows, five columns) of the sixth embodiment are integrated.

FIG. 68 is a diagram showing the change in the X direction illuminance distribution when the taper angle is enlarged compared to Example 2 used as the standard model.

FIG. 69 is a diagram showing the change in the X direction illuminance distribution when the taper angle is reduced compared to Example 2 used as the standard model.

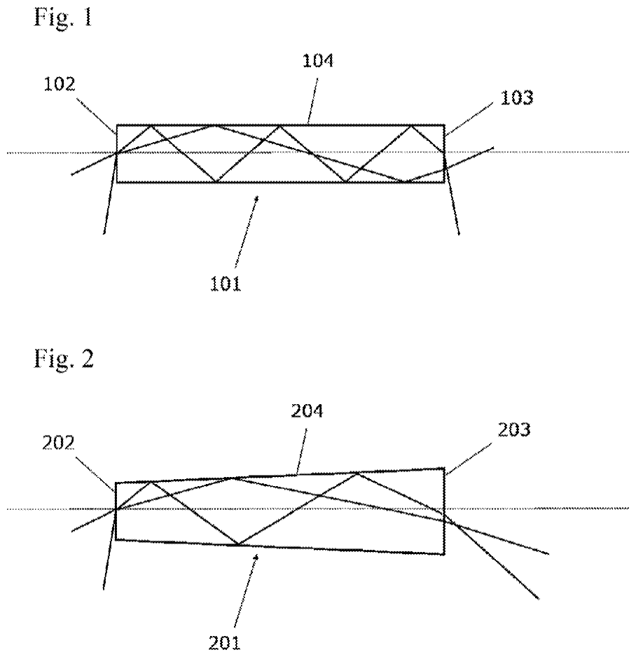

### DETAILED DESCRIPTION OF THE INVENTION

Hereinafter, simulation results of examples of the first to fourth embodiments of the present application and comparative examples are shown. The obtained data are summarized in tables. For some results, the obtained data are presented as-is.

### Example 1

For the first embodiment of the present application, as a means for illuminating a display element (light valve) in a projector, as shown in FIG. 19, an illumination device using a scattered light source 701 comprising an LED element and a light-guiding optical component 301 of the first embodiment of the present application and a projection display device using the illumination device, were configured.

In the subsequent simulations, an LED element with a wavelength of 550 nm, a light-emitting face diameter of 0.255 mm and FWHM of ±60° was used as the LED light source. In addition, the design wavelength was 550 nm and the refractive index n of the glass constituting the light-guiding optical component and the tapered light tunnel of the present invention was 1.5185. While the glass was selected as the material constituting the light-guiding optical component here, the material is not limited to the glass, and resins may also be used. Note that FWHM refers to the full width at half maximum of the radiance distribution of the LED element.

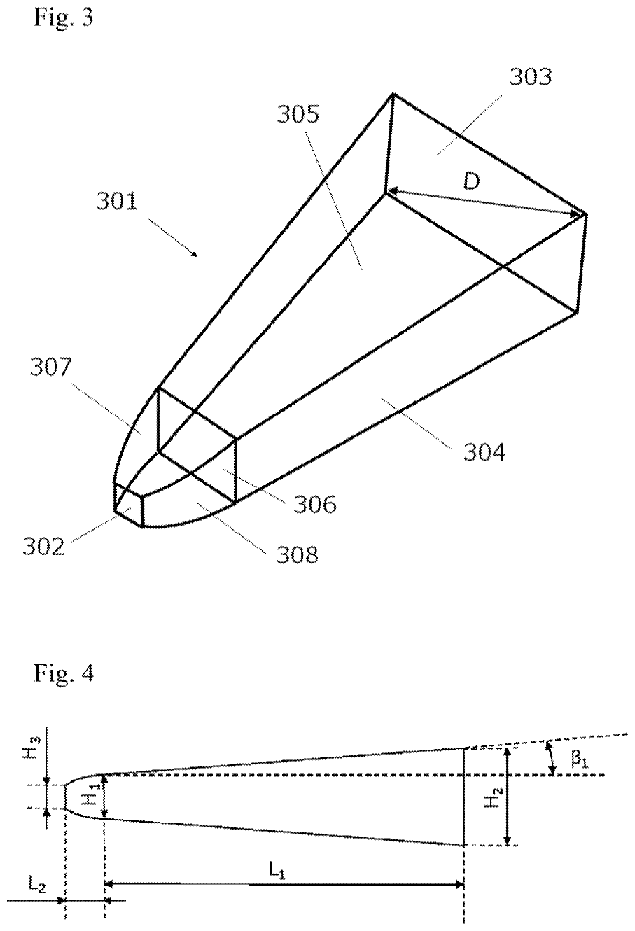

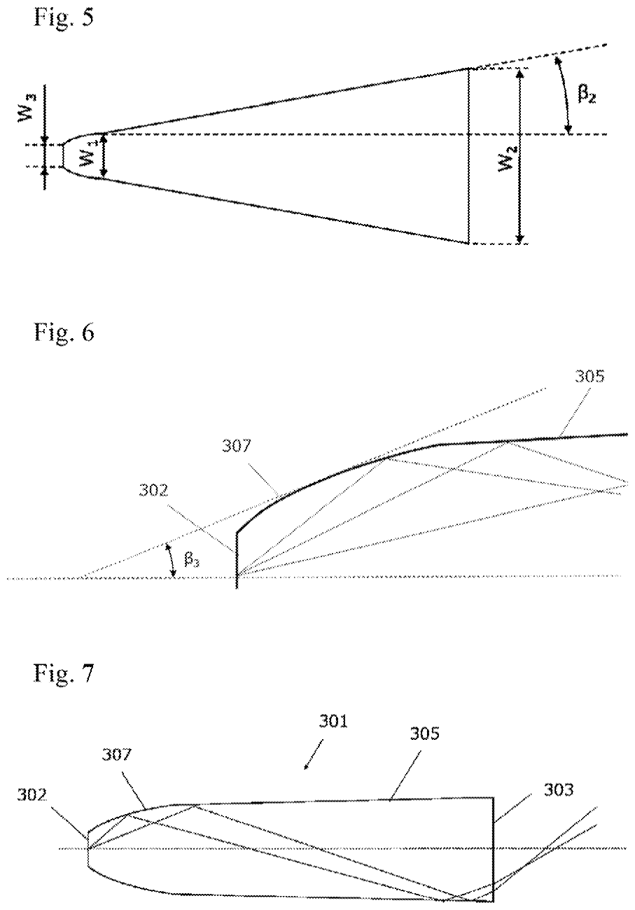

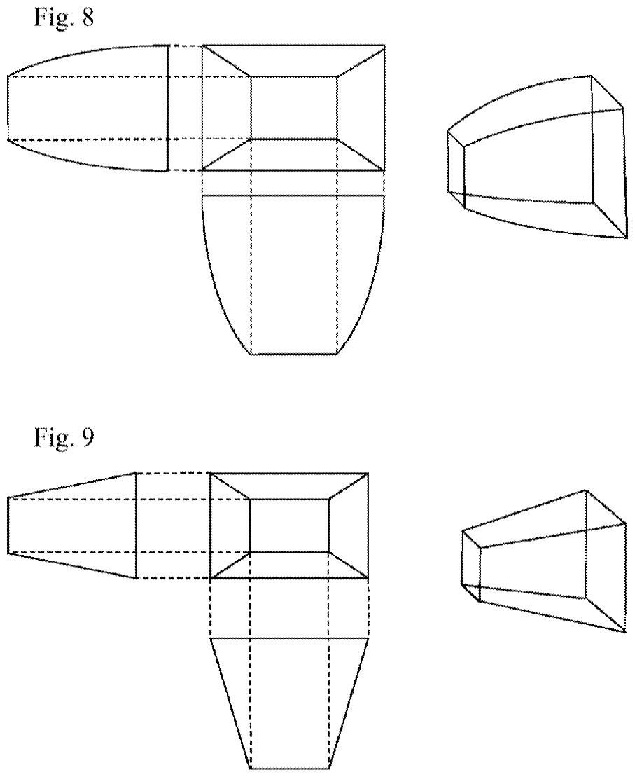

In the optical system of FIG. 19, when the light-guiding optical component 301 is used with the light-guiding optical component of the first embodiment consisting of the tapered portion and the incident portion that is the rectangular CPC shown in FIG. 3, and when the existing tapered light tunnel having a rectangular frustum shape shown in FIG. 2 is used, ray tracing simulations are performed to determine how the light rays entering each component are transmitted and exit from exit face 303. The results are summarized in Table 1. The FWHM shown in Table 1 is the full width at half maximum of the divergence angle of the LED light that has passed through the light-guiding optical component obtained by the ray-tracing simulation. In the uniformity of the exiting light, the examples with a flat illuminance distribution and extremely excellent uniformity are indicated by a double circle mark, the examples with a favorable illuminance distribution with less than 5% variation in illuminance distribution are indicated by a circle mark, the examples with approximately 5% to 10% variation in illuminance distribution are indicated by a triangle mark, and the examples with 10% or more variation in illuminance distribution are indicated by a cross mark.

TABLE 1
tapered light tunnel having length 1.5
times of diagonal length D of exit face
length: 3.825 mm, exit face: 2.22 × 1.25 mm

| | comparative | comparative | comparative |
|---|---|---|---|
| | example 1 | example 2 | example 3 |
| incident face size | 0.3 × 0.3 mm | 0.7 × 0.4 mm | 1.1 × 0.6 mm |
| X divergence angle | ±19.26° | ±23.59° | ±25.47° |
| (FWHM) | | | |
| Y divergence angle | ±11.39° | ±15.12° | ±26.04° |
| (FWHM) | | | |
| uniformity of exit | X | X | X |
| light | | | |

first embodiment (incident portion: rectangular CPC)
total length L: 3.825 mm = 1.5D,
exit face: 2.22 × 1.25 mm

| | embodiment 1 | |
|---|---|---|
| incident portion | 0.4 | mm |
| length L₂ | | |
| incident face size | 0.3 × 0.3 | mm |

| | |
|---|---|
| X divergence angle | ±19.83° |
| (FWHM) | |
| Y divergence angle | ±15.53° |
| (FWHM) | |
| uniformity of exit | ◯ |
| light | |

tapered light tunnel having length 2
times of diagonal length D of exit face
length: 5.10 mm, exit face: 2.22 × 1.25 mm

| | comparative | comparative | comparative |
|---|---|---|---|
| | example 4 | example 5 | example 6 |
| incident face size | 0.3 × 0.3 mm | 0.7 × 0.4 mm | 1.1 × 0.6 mm |
| X divergence angle | ±16.90° | ±17.17° | ±24.23° |
| (FWHM) | | | |
| Y divergence angle | ±12.36° | ±16.85° | ±26.65° |
| (FWHM) | | | |
| uniformity of exit | X | Δ | Δ |
| light | | | |

first embodiment (incident portion: rectangular CPC)
total length L: 5.10 mm = 2D,
exit face: 2.22 × 1.25 mm

| | embodiment 2 | | embodiment 3 | | embodiment 4 | |
|---|---|---|---|---|---|---|
| incident portion | 0.5 | mm | 0.6 | mm | 0.7 | mm |
| length L₂ | | | | | | |
| incident face size | 0.3 × 0.3 | mm | 0.4 × 0.4 | mm | 0.7 × 0.4 | mm |

| | | | |
|---|---|---|---|
| X divergence angle | ±13.35° | ±9.65° | ±22.05° |
| (FWHM) | | | |
| Y divergence angle | ±16.97° | ±19.24° | ±22.56° |
| (FWHM) | | | |
| uniformity of exit | ⊚ | ◯ | Δ |
| light | | | |

tapered light tunnel having length 3
times of diagonal length D of exit face
length: 7.65 mm, exit face: 2.22 × 1.25 mm

| | comparative | comparative | comparative |
|---|---|---|---|
| | example 7 | example 8 | example 9 |
| incident face size | 0.3 × 0.3 mm | 0.7 × 0.4 mm | 1.1 × 0.6 mm |
| X divergence angle | ±12.06° | ±14.66° | ±25.50° |
| (FWHM) | | | |
| Y divergence angle | ±11.81° | ±16.90° | ±26.92° |
| (FWHM) | | | |
| uniformity of exit | X | X | ◯ |
| light | | | |

first embodiment (incident portion: rectangular CPC)
total length L: 7.65 mm = 3D,
exit face: 2.22 × 1.25 mm

| | embodiment 5 | | embodiment 6 | |
|---|---|---|---|---|
| incident portion | 0.4 | mm | 0.4 | mm |

length L₂

| | | | | |
|---|---|---|---|---|
| incident face size | 0.3 × 0.3 | mm | 0.4 × 0.4 | mm |

| | | |
|---|---|---|
| X divergence angle | ±12.12° | ±12.34° |
| (FWHM) | | |
| Y divergence angle | ±15.01° | ±20.24° |
| (FWHM) | | |
| uniformity of exit | ⊚ | ◯ |
| light | | |

tapered light tunnel having length 4
times of diagonal length D of exit face
length: 10.20 mm, exit face: 2.22 × 1.25 mm

| | comparative | comparative | comparative |
|---|---|---|---|
| | example 10 | example 11 | example 12 |
| incident face size | 0.3 × 0.3 mm | 0.7 × 0.4 mm | 1.1 × 0.6 mm |
| X divergence angle | ±9.01° | ±16.49° | ±27.68° |
| (FWHM) | | | |
| Y divergence angle | ±11.65° | ±18.08° | ±28.45° |
| (FWHM) | | | |
| uniformity of exit | X | Δ | ◯ |
| light | | | |

first embodiment (incident portion: rectangular CPC)
total length L: 10.20 mm = 4D,
exit face: 2.22 × 1.25 mm

| | embodiment 7 | | embodiment 8 | |
|---|---|---|---|---|
| incident portion | 0.4 | mm | 0.6 | mm |

length L₂

| | | | | |
|---|---|---|---|---|
| incident face size | 0.3 × 0.3 | mm | 0.4 × 0.4 | mm |

| | | |
|---|---|---|
| X divergence angle | ±9.69° | ±10.26° |
| (FWHM) | | |
| Y divergence angle | ±15.35° | ±20.86° |
| (FWHM) | | |
| uniformity of exit | ⊚ | ⊚ |
| light | | |

tapered light tunnel having length 5
times of diagonal length D of exit face
length: 12.75 mm, exit face: 2.22 × 1.25 mm

| | comparative | comparative | comparative |
|---|---|---|---|
| | example 13 | example 14 | example 15 |
| incident face size | 0.3 × 0.3 mm | 0.7 × 0.4 mm | 1.1 × 0.6 mm |
| X divergence angle | ±7.97° | ±17.56° | ±28.90° |
| (FWHM) | | | |
| Y divergence angle | ±11.62° | ±17.82° | ±27.74° |
| (FWHM) | | | |
| uniformity of exit | Δ | Δ | ◯ |
| light | | | |

first embodiment (incident portion: rectangular CPC)
total length L: 12.75 mm = 5D,
exit face: 2.22 × 1.25 mm

| | embodiment 9 | |
|---|---|---|
| incident portion | 0.3 | mm |
| length L₂ | | |
| incident face size | 0.3 × 0.3 | mm |

| | |
|---|---|
| X divergence angle | ±10.19° |
| (FWHM) | |
| Y divergence angle | ±15.60° |
| (FWHM) | |
| uniformity of exit | ⊚ |
| light | |

tapered light tunnel having length 6
times of diagonal length D of exit face
length: 15.30 mm, exit face: 2.22 × 1.25 mm

| | comparative | comparative | comparative |
|---|---|---|---|
| | example 16 | example 17 | example 18 |
| incident face size | 0.3 × 0.3 mm | 0.7 × 0.4 mm | 1.1 × 0.6 mm |
| X divergence angle | ±7.68° | ±17.99° | ±29.33° |
| (FWHM) | | | |
| Y divergence angle | ±12.31° | ±18.37° | ±28.16° |
| (FWHM) | | | |
| uniformity of exit | ⊚ | ⊚ | ⊚ |
| light | | | |

All examples in Table 1 relate to the light-guiding optical component of the first embodiment, and all comparative examples relate to conventional tapered light tunnels. The size of the exit face is standardized at 2.22 mm×1.25 mm. The ray-tracing simulations were performed by varying the length of the incident portion from 0.4 mm to 0.7 mm, and using three sizes for the incident face that receives light: 0.3 mm×0.3 mm, 0.4 mm×0.4 mm, and 0.7 mm×0.4 mm. The ray-tracing simulations were also performed for the total length L of the light-guiding optical component at 1.5, 2, 3, 4 and 5 times the diagonal length D of the exit face. For the tapered light tunnel of the comparative example, the total length was set to match the light-guiding optical component of the first embodiment, the maximum is 6 times the diagonal length D of the exit face, and using three types of sizes of the incident face: 0.3 mm×0.3 mm, 0.7 mm×0.4 mm and 1.1 mm×0.6 mm. The ray-tracing simulations were performed for a shape that uniformly widens in a taper from the incident face to the exit face at the angle β₁ formed between the upper/lower faces and the horizontal plane containing the optical axis and the angle β₂ formed between the left/right faces and the vertical plane containing the optical axis.

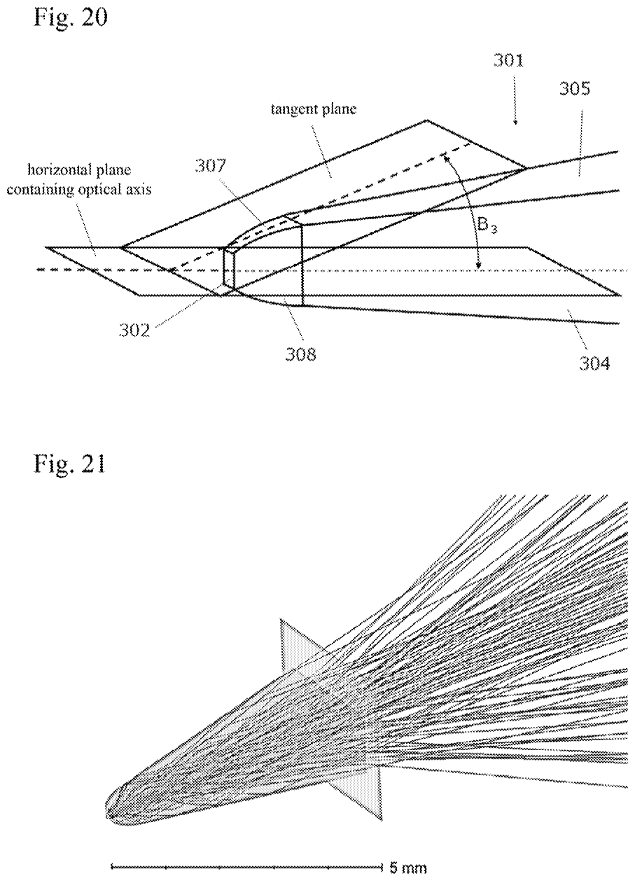

The shape model parameters for the light-guiding optical component of the first embodiment used in the ray-tracing simulation are summarized in Table 2. In addition to the total length L, the length L₁ of the tapered portion, the length L₂ of the incident portion, the size H₃×W₃ of the incident face and the size H₂×W₂ of the exit face, the taper angle β₁, which is the angle formed between the upper/lower faces of the tapered portion and the horizontal direction, and the taper angle β₂, which is the angle formed between the left/right faces and the vertical direction, are also listed. The rectangular frustum having a rectangular CPC shape that is the incident portion of the [Example 1] has the angle β₃ for the tangent plane at any position on either the upper or lower face with respect to the horizontal plane containing the optical axis (shown in FIG. 20), and the angle β₄ for the tangent plane at any position on either the left or right face with respect to the vertical plane containing the optical axis. For the horizontal taper angles β₁ and β₃, the relationship β₃>β₁ is satisfied. For the vertical taper angles β₂ and β₄, the relationship β₄>β₂ is satisfied.

TABLE 2

| | | | embodiment 1 | embodiment 2 | embodiment 3 | embodiment 4 |
|---|---|---|---|---|---|---|
| total | ratio of length L to | | 1.5 times | 2 times | 2 times | 2 times |
| | diagonal length D of | | | | | |
| | exit face | | | | | |
| | total length L (mm) | | 3.825 | 5.10 | 5.10 | 5.10 |
| incident | incident portion length | | 0.4 | 0.5 | 0.6 | 0.7 |
| portion | L₂ (mm) | | | | | |
| (rectangular | incident face size | | 0.3 × 0.3 | 0.3 × 0.3 | 0.4 × 0.4 | 0.7 × 0.4 |
| CPC) | H₃ × W₃ (mm) | | | | | |
| | left/right | maximum | 28.8 | 30.3 | 29.8 | 29.4 |
| | face | angle (°) | | | | |
| | inclination | minimum | 13.9 | 10.1 | 9.3 | 11.5 |
| | angle β₄ | angle (°) | | | | |
| | upper/lower | maximum | 30.1 | 29.2 | 24.6 | 29.2 |
| | face | angle (°) | | | | |
| | inclination | minimum | 9.0 | 5.2 | 4.1 | 4.6 |
| | angle β₃ | angle (°) | | | | |

| tapered | tapered portion length | 3.425 | 4.6 | 4.5 | 4.4 |
|---|---|---|---|---|---|
| portion | L₁ (mm) | | | | |
| (rectangular | incident face size | 0.54 × 0.56 | 0.59 × 0.57 | 0.76 × 0.62 | 1.19 × 0.76 |
| frustum) | H₁ × W₁ (mm) | | | | |
| | left/right face tapered | 13.8 | 10.0 | 9.2 | 6.7 |
| | angle β₂ (°) | | | | |
| | upper/lower face | 5.8 | 4.3 | 4.0 | 3.2 |
| | tapered angle β₁ (°) | | | | |
| | exit face size | 2.22 × 1.25 | | | |
| | H₂ × W₂ (mm) | | | | |

| | | | embodiment 5 | embodiment 6 | embodiment 7 | embodiment 8 | embodiment 9 |
|---|---|---|---|---|---|---|---|
| total | ratio of length L to | | 3 times | 3 times | 4 times | 4 times | 5 times |
| | diagonal length D of | | | | | | |
| | exit face | | | | | | |
| | total length L (mm) | | 7.65 | 7.65 | 10.20 | 10.20 | 12.75 |
| incident | incident portion length | | 0.4 | 0.4 | 0.4 | 0.6 | 0.3 |
| portion | L₂ (mm) | | | | | | |
| (rectangular | incident face size | | 0.3 × 0.3 | 0.4 × 0.4 | 0.3 × 0.3 | 0.4 × 0.4 | 0.3 × 0.3 |
| CPC) | H₃ × W₃ (mm) | | | | | | |
| | left/right | maximum | 32.0 | 29.4 | 24.1 | 24.7 | 24.1 |
| | face | angle (°) | | | | | |
| | inclination | minimum | 11.5 | 11.4 | 5.2 | 4.9 | 5.0 |
| | angle β₄ | angle (°) | | | | | |
| | upper/lower | maximum | 23.8 | 23.8 | 23.7 | 24.6 | 23.8 |
| | face | angle (°) | | | | | |
| | inclination | minimum | 3.3 | 4.5 | 2.4 | 2.0 | 4.7 |
| | angle β₃ | angle (°) | | | | | |

| tapered | tapered portion length | 7.25 | 7.25 | 9.8 | 9.6 | 12.45 |
|---|---|---|---|---|---|---|
| portion | L₁ (mm) | | | | | |
| (rectangular | incident face size | 0.59 × 0.45 | 0.68 × 0.59 | 0.46 × 0.45 | 0.62 × 0.62 | 0.44 × 0.44 |
| frustum) | H₁ × W₁ (mm) | | | | | |
| | left/right face tapered | 6.4 | 6.1 | 5.1 | 4.8 | 4.1 |
| | angle β₂ (°) | | | | | |
| | upper/lower face | 3.2 | 2.6 | 2.3 | 1.9 | 1.9 |
| | tapered angle β₁ (°) | | | | | |
| | exit face size | 2.22 × 1.25 | | | | |
| | H₂ × W₂ (mm) | | | | | |

For example, Example 2 in [Example 1] has a total length L of the light-guiding optical component of 5.1 mm, which is 2 times the diagonal D of the exit face opening, of which 0.5 mm is the length L₂ of the incident portion and 4.6 mm is the length L₁ of the tapered portion. The exit face is 2.22 mm×1.25 mm. The size of the incident face of the incident portion is 0.3 mm×0.3 mm. The taper angle β₁, which is the angle formed between the upper/lower faces of the tapered portion and the horizontal plane containing the optical axis, is 4.3°. The taper angle β₂, which is the angle formed between the width-direction side faces and the vertical plane containing the optical axis, is 10.0°. In contrast, for the incident portion, the minimum inclination angle of the upper/lower faces is 5.2° and the maximum inclination angle is 29.2°, the minimum inclination angle of the left/right faces is 10.1° and the maximum inclination angle is 30.3°, all of which are greater than the taper angle of the corresponding tapered portion.

Similarly, the shape model parameters for the conventional tapered light tunnel for which ray-tracing simulations were performed are summarized in Table 3. In addition to the ratio of the total length L to the diagonal length D of the exit face, the total length L, the size of the incident face and the size of the exit face, the taper angle β₁ of the upper/lower faces and the taper angle β₂ of the left/right faces are also listed.

TABLE 3

| | comparative | comparative | comparative | comparative | comparative | comparative |
|---|---|---|---|---|---|---|
| | example 1 | example 2 | example 3 | example 4 | example 5 | example 6 |
| ratio of total length to | 1.5 times | 1.5 times | 1.5 times | 2 times | 2 times | 2 times |
| diagonal length D of exit | | | | | | |
| face | | | | | | |
| total length (mm) | 3.825 | 3.825 | 3.825 | 5.10 | 5.10 | 5.10 |
| incident face size (mm) | 0.3 × 0.3 | 0.7 × 0.4 | 1.1 × 0.6 | 0.3 × 0.3 | 0.7 × 0.4 | 1.1 × 0.6 |
| left/right face tapered | 14.1 | 11.2 | 8.3 | 10.7 | 8.5 | 6.3 |
| angle β₂ (°) | | | | | | |
| upper/lower face | 7.1 | 6.3 | 4.9 | 5.3 | 4.8 | 3.6 |
| tapered angle β₁ (°) | | | | | | |
| exit face size (mm) | 2.22 × 1.25 | | | | | |
| | comparative | comparative | comparative | comparative | comparative | comparative |
| | example 7 | example 8 | example 9 | example 10 | example 11 | example 12 |
| ratio of total length to | 3 times | 3 times | 3 times | 4 times | 4 times | 4 times |
| diagonal length D of exit | | | | | | |
| face | | | | | | |
| total length (mm) | 7.65 | 7.65 | 7.65 | 10.20 | 10.20 | 10.20 |
| incident face size (mm) | 0.3 × 0.3 | 0.7 × 0.4 | 1.1 × 0.6 | 0.3 × 0.3 | 0.7 × 0.4 | 1.1 × 0.6 |
| left/right face tapered | 7.2 | 5.7 | 4.2 | 5.4 | 4.3 | 3.1 |
| angle β₂ (°) | | | | | | |
| upper/lower face | 3.6 | 3.2 | 2.4 | 2.7 | 2.4 | 1.8 |
| tapered angle β₁ (°) | | | | | | |
| exit face size (mm) | 2.22 × 1.25 | | | | | |
| | comparative | comparative | comparative | comparative | comparative | comparative |
| | example 13 | example 14 | example 15 | example 16 | example 17 | example 18 |
| ratio of total length to | 5 times | 5 times | 5 times | 6 times | 6 times | 6 times |
| diagonal length D of exit | | | | | | |
| face | | | | | | |
| total length (mm) | 12.75 | 12.75 | 12.75 | 15.30 | 15.30 | 15.30 |
| incident face size (mm) | 0.3 × 0.3 | 0.7 × 0.4 | 1.1 × 0.6 | 0.3 × 0.3 | 0.7 × 0.4 | 1.1 × 0.6 |
| left/right face tapered | 4.3 | 3.4 | 2.5 | 3.6 | 2.8 | 2.1 |
| angle β₂ (°) | | | | | | |
| upper/lower face | 2.1 | 1.9 | 1.5 | 1.8 | 1.6 | 1.2 |
| tapered angle β₁ (°) | | | | | | |

| | |
|---|---|
| exit face size (mm) | 2.22 × 1.25 |

Among the examples shown in Table 1, Example 2, Example 5, Example 7, Example 8 and Example 9, which are five examples out of the nine implemented examples, are extremely excellent uniformity of exiting light (evaluated as double circle mark in the table). Example 1, Example 3 and Example 6, which are three examples, are uniformity variation within 5% (evaluated as circle mark in the table). Only Example 4 is uniformity variation of 5% or more (evaluated as triangle mark in the table). On the other hand, for the conventional tapered light tunnels, simulations were performed for eighteen cases listed as comparative examples. However, the examples with excellent uniformity of illuminance distribution were limited to the examples (Comparative examples 16, 17 and 18) with the length 6 times the diagonal of the exit face. Among them, Comparative example 18 had a large divergence angle. Among the other comparative examples, Comparative example 9 and Comparative example 12 had reasonably good uniformity of illuminance distribution (variation within 5%), but both had a large divergence angle of +25° or more. All other comparative examples had illuminance distribution variation of at least 5% or more, or even larger.

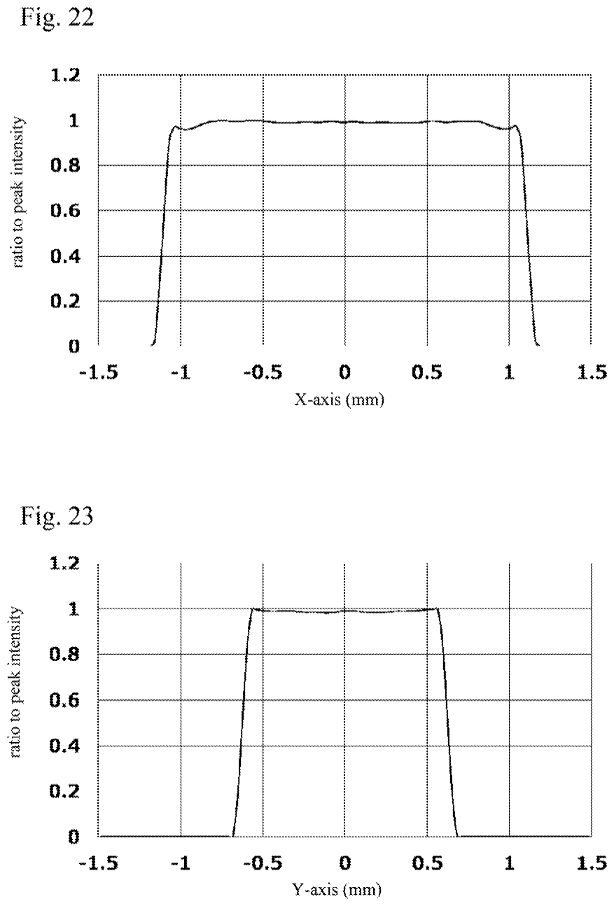

The results of the ray-tracing simulation performed for Example 2 in Table 1 are shown in FIG. 21. The left side of FIG. 21 shows the ray trajectory inside the light-guiding optical component, and the light beam appears dense. The exit face of the tapered portion is at the center (a rectangle indicating the exit face is visible) and to the right of the exit face of the tapered portion is the outside of the light-guiding optical component where the light rays diverge from the exit face and appear sparse. The illuminance distributions in the X-axis direction and the Y-axis direction at the exit face obtained from the light beam at the exit face position of the tapered portion in FIG. 21 are shown in FIG. 22 and FIG. 23 respectively. Furthermore, the radiance distribution in angle space is shown in FIG. 24. The radiance distribution in angle space refers to the radiance that appears distributed in angle space when the light-guiding optical component is observed from a position distant from the exit face. In the radiance distribution diagram, the line shown by the thick solid line is the X-direction divergence angle distribution, and the line that appears as a dash-dot line is the Y-direction divergence angle distribution. In both the X direction and the Y direction, it can be seen that the shape of the light-guiding optical component of the first embodiment has far superior uniformity of luminance distribution compared to the tapered light tunnel having a rectangular frustum shape shown as a comparative example. From the angular distribution of radiance, it was found that the X-direction divergence angle (FWHM: full width at half maximum) was suppressed to ±13.35° and the Y-direction divergence angle (FWHM: full width at half maximum) was suppressed to ±16.97° when the light-guiding optical component of the present invention was used.

Regarding the results of the examples of the first embodiment, in Example 1 where the total length L is only 1.5 times the diagonal D of the exit face, the divergence angle of the exiting light was kept in a low range and the Y-direction illuminance distribution was uniform, but the X-direction illuminance distribution varied by about 3%. With an illuminance distribution of this level, the uniformity evaluation was evaluated as circle mark. In the case where the total length L is 2 times D, even in Example 3 where the length of the incident portion and the size of the incident face were larger than Example 2, about 3% fluctuation was shown in X-direction illuminance distribution. In Example 4, a nearly 10% drop was shown in illuminance in the center of the X-direction illuminance distribution. Therefore, in the case where the total length was 2 times the diagonal of the exit face, only Example 2 and Example 3 showed good results in all of X-direction illuminance distribution, Y-direction illuminance distribution and the divergence angle.

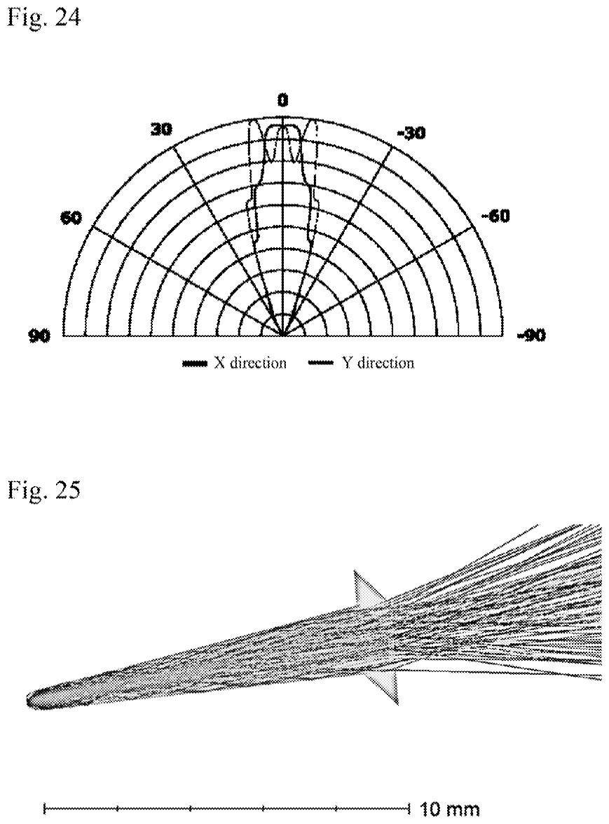

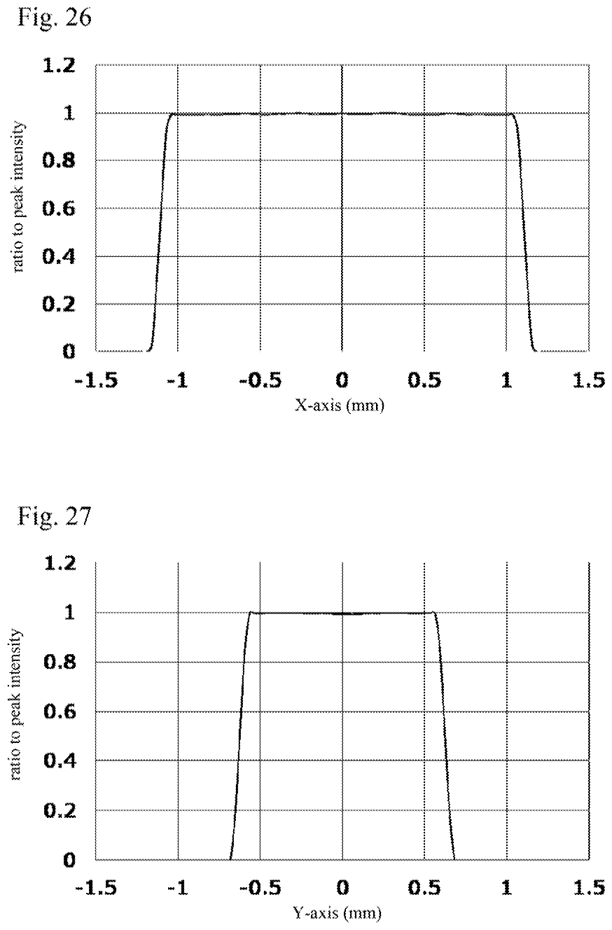

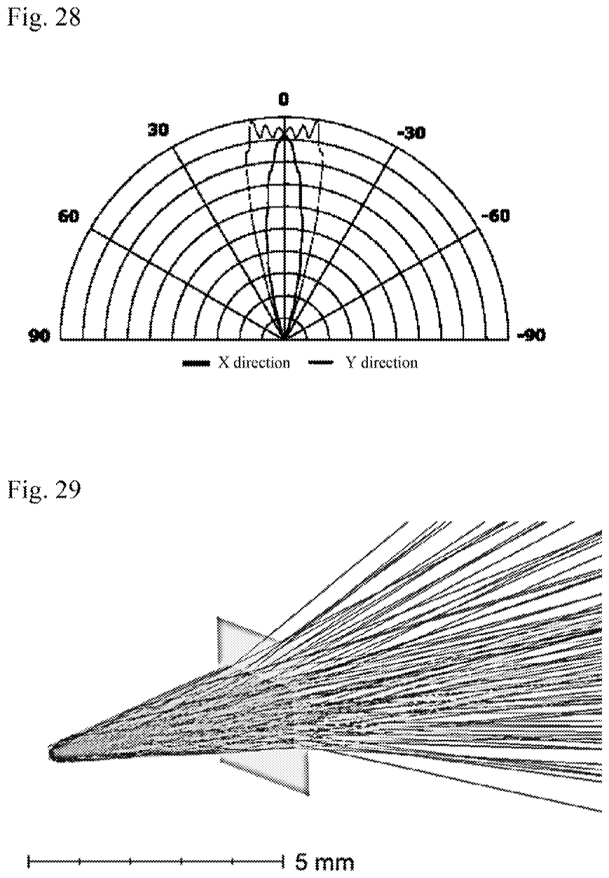

As another example showing good results, the ray-tracing simulation result (FIG. 25), X-direction illuminance distribution (FIG. 26), Y-direction illuminance distribution (FIG. 27) and divergence angle distribution (FIG. 28) for Example 7 in Table 1 are shown. The uniformity of the illuminance distribution is excellent in both X direction and Y direction. In addition, it was found that the divergence angle of radiance was narrowed. The FWHM in the X direction was ±9.69° and the FWHM in the Y direction (height direction) was ±15.35°. The left side of FIG. 25 shows the ray trajectory inside the light-guiding optical component, where the light beam appears dense. A rectangle indicating the exit face of the tapered portion is visible at the center. The right of the exit face of the tapered portion is the outside of the light-guiding optical component, where the light rays diverge from the exit face and appear sparse. In FIG. 28, the line displayed as a solid line is the X-direction divergence angle, and the line displayed as what appears to be a dash-dot line is the Y-direction divergence angle.

From the above results of the examples of the first embodiment, with reference to the results of the comparative example as well, it is found that the uniformity of illuminance distribution and narrowing of the divergence angle can be achieved stably and with good reproducibility when the total length Lis 1.5 times or more and 5 times or less the diagonal length D of the exit face. From the results shown in Table 1 and Table 2, the uniformity of illuminance distribution and narrowing of the divergence angle can be achieved when the ratio L₂/L₁ of the length L₂ of the incident portion to the length L₁ of the tapered portion is between 2.4% and 13.4%. It is also found that the taper angle β₁ of the tapered portion is in the range of 1.9° to 5.8°, and the angle β₂ was in the range of 4.1° to 13.8°.

### COMPARATIVE EXAMPLE

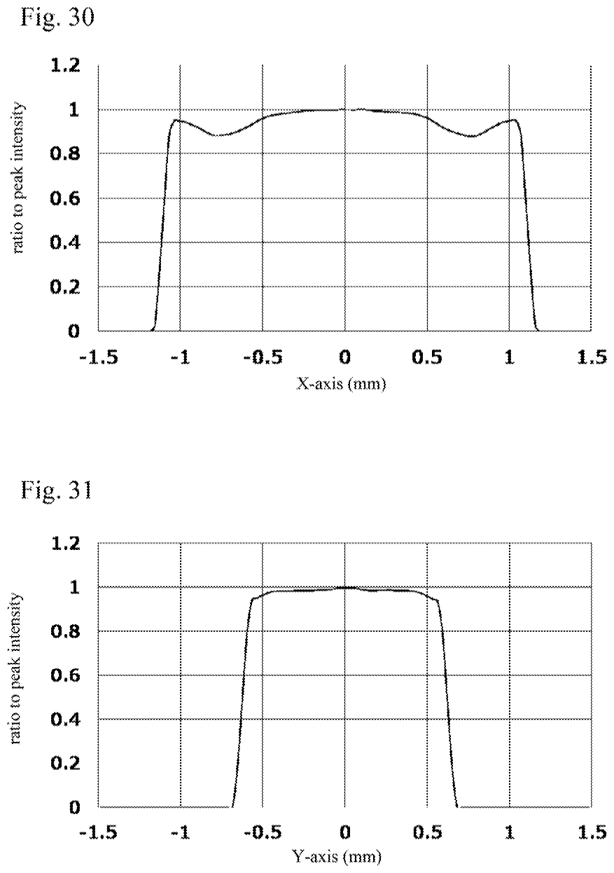

As a comparative example, among conventional tapered light tunnels, a ray-tracing simulation was performed for Comparative example 4 in Table 1 (FIG. 29), and the X-direction illuminance distribution (FIG. 30) and the Y-direction illuminance distribution (FIG. 31) were obtained. It is confirmed that the X-direction illuminance distribution shows two large drops exceeding 10% variation while there is no problem with the Y-direction illuminance distribution, and the illuminance distribution cannot be said to be uniform. The divergence angle is at a nearly acceptable level.

The other results are summarized in Table 1. As described above, similar to Example 2 and Example 7, the examples with excellent uniformity of X-direction and Y-direction illuminance distributions are evaluated as double circle mark, the examples with uniformity variation within 5% are evaluated as circle mark, the examples with uniformity variation exceeding 5% but within 10% are evaluated as triangle mark, and the examples with uniformity problems similar to Comparative example 4 (variation of 10% or more) are evaluated as cross mark. For the divergence angle, the examples within ±15° are considered to have achieved narrowing, the examples within ±20° are within the acceptable range, and the examples exceeding ±20° are evaluated as having insufficient narrowing.

From the results in Table 1, among the Comparative examples 1 to 18 for which ray-tracing simulations of conventional tapered light tunnels were performed, only Comparative examples 16 and 17, which had a length 6 times the diagonal of the exit face and the size of the incident face of 0.3×0.3 mm and 0.7×0.4 mm, were able to achieve both uniformity of illuminance distribution and narrowing of divergence angle. In Comparative example 15, with a length 5 times the diagonal of the exit face and an incident face of 1.1×0.6 mm, the uniformity of illuminance distribution was achieved, but the divergence angle reached nearly ±30°, and narrowing of divergence angle was not achieved. The same can be said for Comparative examples 9 and 12. Namely, it is found that conventional tapered light tunnels cannot simultaneously achieve uniformity of illuminance distribution and narrowing of divergence angle unless the total length Lis 6 times the diagonal length D of the exit face. Conversely, when the total length L is 5 times or less the diagonal length D of the exit face, uniformity of illuminance distribution and narrowing of divergence angle cannot be achieved simultaneously.

### Example 2

Next, the example relating to the light-guiding optical component of the second embodiment of the present application is shown. In [Example 1] of the first embodiment, the light-guiding optical component including an incident portion of the rectangular CPC shape shown in FIG. 8 formed continuously with the top face of the solid rectangular frustum with taper angles β₁ and β₂ is explained. In [Example 2], simulation results are shown for a light-guiding optical component including an incident portion of the general rectangular frustum shape shown in FIG. 9 formed continuously with the top face of the solid first rectangular frustum with taper angles β₁ and 2. The second rectangular frustum that is the incident portion of [Example 2] has taper angles β₈ and β₆, with the relationship β₈>β₁ for the taper angles β₁ in the upper/lower face direction and β₅, and the relationship β₆>β₂ for the taper angles β₂ in the left/right face direction and β₆.

The parameters related to the shape of the light-guiding optical component used in the simulation are shown in Table 4, and the simulation results are shown in Table 5. The taper angle β₁ of the upper/lower faces of the tapered portion is in the range of 0.8° to 6.3°, and the taper angle β₂ of the left/right faces is in the range of 3.3° to 13.1°. On the other hand, for the rectangular frustum in the incident portion, the taper angle β₅ of the upper/lower faces is in the range of 10.7° to 18.7°, and the taper angle β₆ of the left/right faces is in the range of 16.5° to 23.0°, all of which are greater than the taper angle of the tapered portion. The size of the incident face is 0.3 mm×0.3 mm, 0.4 mm×0.4 mm or 0.7 mm×0.4 mm, and the length L₂ of the incident portion is varied from 0.4 mm to 1.3 mm according to the total length L. The ratio of the length L₂ of the incident portion to the length L₁ of the tapered portion is in the range of 5.8% to 34.5%.

For the cases where the total length Lis 3, 4 and 5 times the diagonal length D of the exit face, the uniformity of the illuminance distribution at the exit face is excellent and the divergence angle is small. For the case where the total length L is 2 times the diagonal length D of the exit face, the divergence angle is small, but about 5% variation is seen in the uniformity of the illuminance distribution at the exit face. For the case where the total length L is 1.5 times the diagonal length D of the exit face, the divergence angle is still small, but 5% or more variation is seen in the uniformity of the illuminance distribution at the exit face. Therefore, from the results shown in Table 5, among [Example 2], the cases where the total length L is 2 times the diagonal D of the exit face (Examples 21, 22, and 23) have insufficient uniformity of illuminance distribution, and both uniformity of illuminance distribution and narrowing of the divergence angle can be satisfied when the total length L becomes 3 times the diagonal of the exit face (Examples 25 and 26).

TABLE 4

| | | embodiment 21 | embodiment 22 | embodiment 23 | embodiment 24 |
|---|---|---|---|---|---|
| total | ratio of length L to | 1.5 times | 2 times | 2 times | 2 times |
| | diagonal length D of | | | | |
| | exit face | | | | |
| | total length L (mm) | 3.825 | 5.10 | 5.10 | 5.10 |
| incident | incident portion | 0.4 | 1.0 | 1.1 | 1.3 |
| portion | length L₂ (mm) | | | | |
| (rectangular | incident face size | 0.3 × 0.3 | 0.3 × 0.3 | 0.4 × 0.4 | 0.7 × 0.4 |
| frustum) | H₃ × W₃ (mm) | | | | |
| | left/right face | 21.8 | 16.5 | 22.8 | 19.7 |
| | inclination angle β₆ | | | | |
| | upper/lower face | 13.5 | 12.4 | 18.7 | 11.7 |
| | inclination angle β₅ | | | | |
| tapered | tapered portion length | 3.425 | 4.1 | 4.0 | 3.8 |
| portion | L₁ (mm) | | | | |
| (rectangular | incident face size | 0.62 × 0.49 | 0.89 × 0.74 | 1.32 × 1.14 | 1.63 × 0.94 |
| frustum) | H₁ × W₁ (mm) | | | | |
| | left/right face tapered | 13.1 | 9.2 | 6.4 | 4.4 |
| | angle β₂ (°) | | | | |
| | upper/lower face | 6.3 | 3.6 | 0.8 | 2.3 |
| | tapered angle β₁ (°) | | | | |
| | exit face size | 2.22 × 1.25 | | | |
| | H₂ × W₂ (mm) | | | | |

| | | embodiment 25 | embodiment 26 | embodiment 27 | embodiment 28 | embodiment29 |
|---|---|---|---|---|---|---|
| total | ratio of length L to | 3 times | 3 times | 4 times | 4 times | 5 times |
| | diagonal length D of | | | | | |
| | exit face | | | | | |
| | total length L (mm) | 7.65 | 7.65 | 10.20 | 10.20 | 12.75 |
| incident | incident portion length | 0.8 | 0.8 | 0.8 | 1.0 | 0.7 |
| portion | L₂ (mm) | | | | | |
| (rectangular | incident face size | 0.3 × 0.3 | 0.4 × 0.4 | 0.3 × 0.3 | 0.4 × 0.4 | 0.3 × 0.3 |
| frustum) | H₃ × W₃ (mm) | | | | | |
| | left/right face | 23.0 | 22.6 | 16.7 | 20.8 | 17.1 |
| | inclination angle β₆ | | | | | |
| | upper/lower face | 11.5 | 16.0 | 10.7 | 14.1 | 12.6 |
| | inclination angle β₅ | | | | | |
| tapered | tapered portion length | 6.85 | 6.85 | 9.4 | 9.2 | 12.05 |
| portion | L₁ (mm) | | | | | |
| (rectangular | incident face size | 0.98 × 0.63 | 1.07 × 0.86 | 0.78 × 0.60 | 1.16 × 0.90 | 0.73 × 0.61 |
| frustum) | H₁ × W₁ (mm) | | | | | |
| | left/right face tapered | 5.2 | 4.8 | 4.4 | 3.3 | 3.5 |
| | angle β₂ (°) | | | | | |
| | upper/lower face | 2.6 | 1.6 | 2.0 | 1.1 | 1.5 |
| | tapered angle β₁ (°) | | | | | |
| | exit face size | 2.22 × 1.25 | | | | |
| | H₂ × W₂ (mm) | | | | | |

TABLE 5
tapered light tunnel having length 1.5
times of diagonal length D of exit face
length: 3.825 mm, exit face: 2.22 × 1.25 mm

| | comparative | comparative | comparative |
|---|---|---|---|
| | example 1 | example 2 | example 3 |
| incident face size | 0.3 × 0.3 mm | 0.7 × 0.4 mm | 1.1 × 0.6 mm |
| X divergence angle | ±19.26° | ±23.59° | ±25.47° |
| (FWHM) | | | |
| Y divergence angle | ±11.39° | ±15.12° | ±26.04° |
| (FWHM) | | | |
| uniformity of exit | X | X | X |
| light | | | |

second embodiment (incident portion: rectangular frustum)
total length L: 3.825 mm = 1.5D,
exit face: 2.22 × 1.25 mm

| | embodiment 21 | |
|---|---|---|
| incident portion | 0.4 | mm |
| length L₂ | | |
| incident face size | 0.3 × 0.3 | mm |

| | |
|---|---|
| H₃ × W₃ | |
| X divergence angle | ±17.44° |
| (FWHM) | |
| Y divergence angle | ±13.83° |
| (FWHM) | |
| uniformity of exit | Δ |
| light | |

tapered light tunnel having length 2
times of diagonal length D of exit face
length: 5.10 mm, exit face: 2.22 × 1.25 mm

| | comparative | comparative | comparative |
|---|---|---|---|
| | example 4 | example 5 | example 6 |
| incident face size | 0.3 × 0.3 mm | 0.7 × 0.4 mm | 1.1 × 0.6 mm |
| X divergence angle | ±16.90° | ±17.17° | ±24.23° |
| (FWHM) | | | |
| Y divergence angle | ±12.36° | ±16.85° | ±26.65° |
| (FWHM) | | | |
| uniformity of exit | X | Δ | Δ |
| light | | | |

second embodiment (incident portion: rectangular frustum)
total length L: 5.10 mm = 2D,
exit face: 2.22 × 1.25 mm

| | embodiment 22 | | embodiment 23 | | embodiment 24 | |
|---|---|---|---|---|---|---|
| incident portion | 1.0 | mm | 1.1 | mm | 1.3 | mm |
| length L₂ | | | | | | |
| incident face size | 0.3 × 0.3 | mm | 0.4 × 0.4 | mm | 0.7 × 0.4 | mm |

| | | | |
|---|---|---|---|
| H₃ × W₃ | | | |
| X divergence angle | ±11.32° | ±15.44° | ±19.44° |
| (FWHM) | | | |
| Y divergence angle | ±11.14° | ±12.29° | ±16.49° |
| (FWHM) | | | |
| uniformity of exit | Δ | Δ | Δ |
| light | | | |

tapered light tunnel having length 3
times of diagonal length D of exit face
length: 7.65 mm, exit face: 2.22 × 1.25 mm

| | comparative | comparative | comparative |
|---|---|---|---|
| | example 7 | example 8 | example 9 |
| incident face size | 0.3 × 0.3 mm | 0.7 × 0.4 mm | 1.1 × 0.6 mm |
| X divergence angle | ±12.06° | ±14.66° | ±25.50° |
| (FWHM) | | | |
| Y divergence angle | ±11.81° | ±16.90° | ±26.92° |
| (FWHM) | | | |
| uniformity of exit | X | X | ◯ |
| light | | | |

second embodiment (incident portion: rectangular frustum)
total length L: 7.65 mm = 3D,
exit face: 2.22 × 1.25 mm

| | embodiment 25 | | embodiment 26 | |
|---|---|---|---|---|
| incident portion | 0.8 | mm | 0.8 | mm |

length L₂

| | | | | |
|---|---|---|---|---|
| incident face size | 0.3 × 0.3 | mm | 0.4 × 0.4 | mm |

| | | |
|---|---|---|
| H₃ × W₃ | | |
| X divergence angle | ±12.41° | ±13.44° |
| (FWHM) | | |
| Y divergence angle | ±11.85° | ±14.95° |
| (FWHM) | | |
| uniformity of exit | ◯ | ◯ |
| light | | |

tapered light tunnel having length 4
times of diagonal length D of exit face
length: 10.20 mm, exit face: 2.22 × 1.25 mm

| | comparative | comparative | comparative |
|---|---|---|---|
| | example 10 | example 11 | example 12 |
| incident face size | 0.3 × 0.3 mm | 0.7 × 0.4 mm | 1.1 × 0.6 mm |
| X divergence angle | ±9.01° | ±16.49° | ±27.68° |
| (FWHM) | | | |
| Y divergence angle | ±11.65° | ±18.08° | ±28.45° |
| (FWHM) | | | |
| uniformity of exit | X | Δ | ◯ |
| light | | | |

second embodiment (incident portion: rectangular frustum)
total length L: 10.20 mm = 4D,
exit face: 2.22 × 1.25 mm

| | embodiment 27 | | embodiment 28 | |
|---|---|---|---|---|
| incident portion | 0.8 | mm | 1.0 | mm |

length L₂

| | | | | |
|---|---|---|---|---|
| incident face size | 0.3 × 0.3 | mm | 0.4 × 0.4 | mm |

| | | |
|---|---|---|
| H₃ × W₃ | | |
| X divergence angle | ±8.27° | ±14.08° |
| (FWHM) | | |
| Y divergence angle | ±12.42° | ±13.35° |
| (FWHM) | | |
| uniformity of exit | ⊚ | ⊚ |
| light | | |

tapered light tunnel having length 5
times of diagonal length D of exit face
length: 12.75 mm, exit face: 2.22 × 1.25 mm

| | comparative | comparative | comparative |
|---|---|---|---|
| | example 13 | example 14 | example 15 |
| incident face size | 0.3 × 0.3 mm | 0.7 × 0.4 mm | 1.1 × 0.6 mm |
| X divergence angle | ±7.97° | ±17.56° | ±28.90° |
| (FWHM) | | | |
| Y divergence angle | ±11.62° | ±17.82° | ±27.74° |
| (FWHM) | | | |
| uniformity of exit | Δ | Δ | ◯ |
| light | | | |

second embodiment (incident
portion: rectangular frustum)
total length L: 12.75 mm = 5D,
exit face: 2.22 × 1.25 mm

| | embodiment 29 | |
|---|---|---|
| incident portion | 0.7 | mm |

length L₂

| | | |
|---|---|---|
| incident face size | 0.3 × 0.3 | mm |

| | |
|---|---|
| H₃ × W₃ | |
| X divergence angle | ±8.04° |
| (FWHM) | |
| Y divergence angle | ±12.94° |
| (FWHM) | |
| uniformity of exit | ⊚ |
| light | |

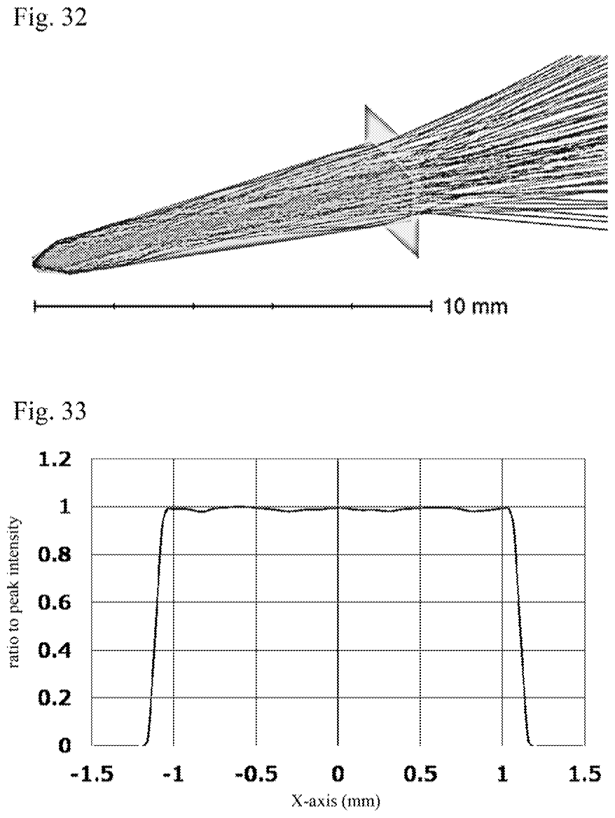

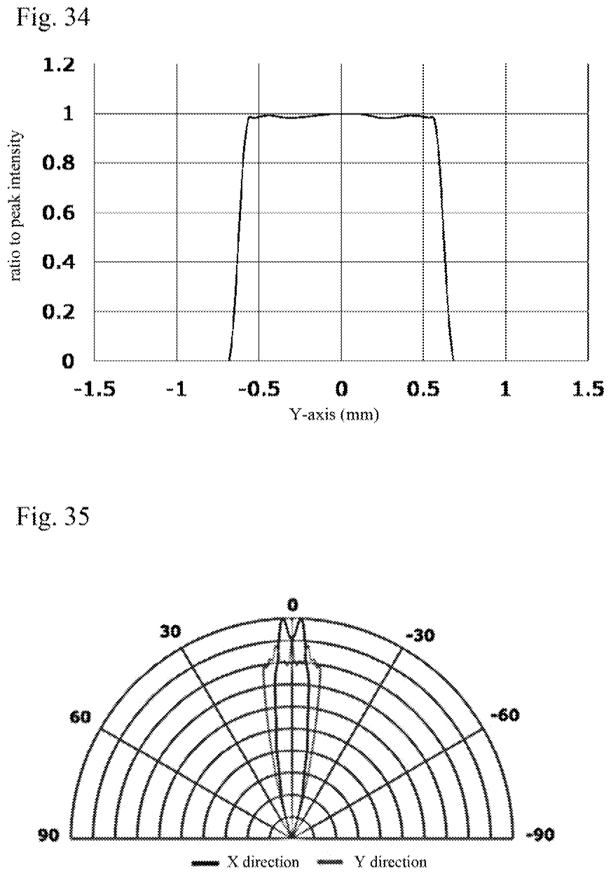

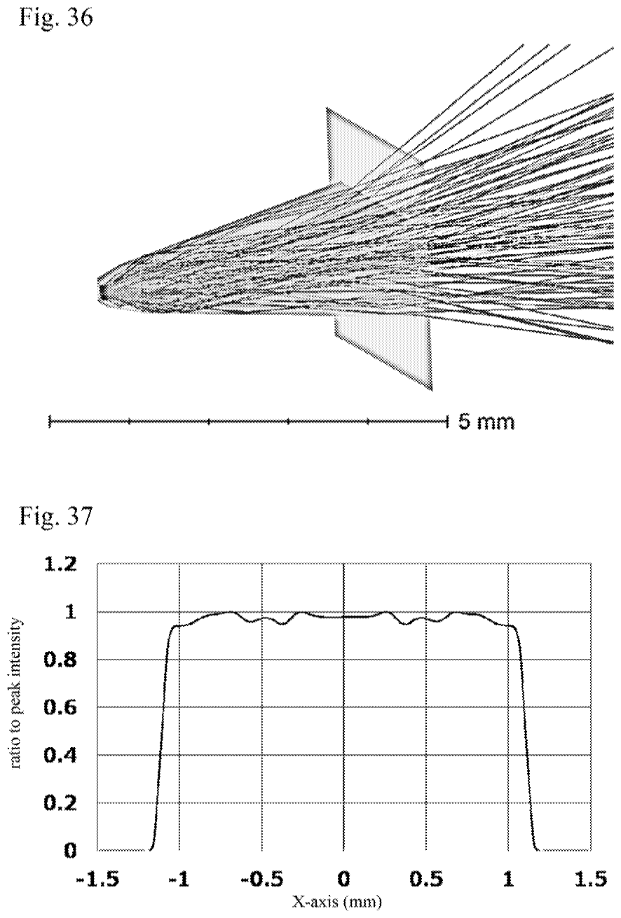

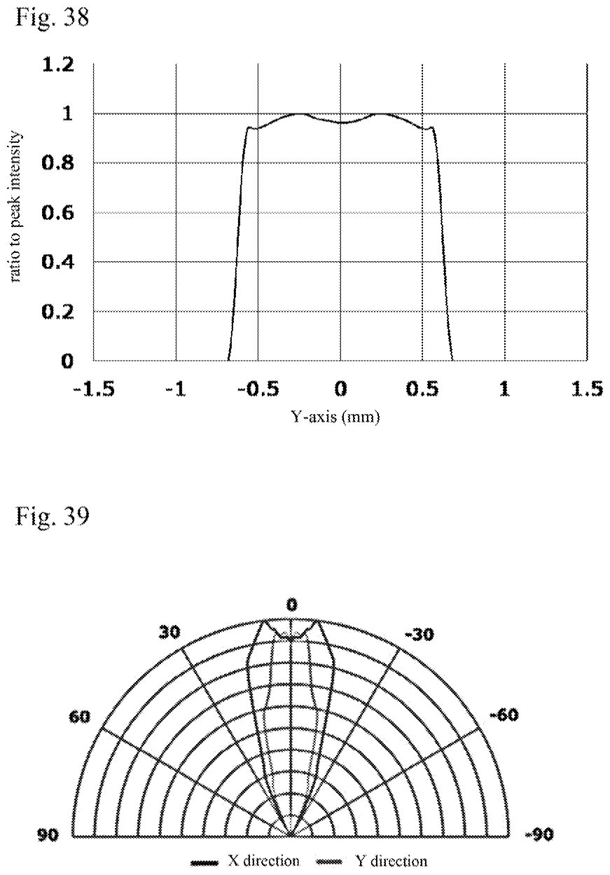

From [Example 2], two examples of ray-tracing simulation results are shown. One is Example 27 with a total length L of 10.2 mm, which is 4 times the diagonal length D of the exit face, and the length L₂ of the incident portion of 0.8 mm, with L₂/L_{1=8.5}%. The ray trajectory is shown in FIG. 32, the uniformity in the X direction (width direction) at the exit face is shown in FIG. 33, the uniformity in the Y direction (height direction) is shown in FIG. 34, and the divergence angle at the exit face is shown in FIG. 35. The other is Example 21 with a total length L of 3.825 mm, which is 1.5 times the diagonal length D of the exit face, and the length L₂ of the incident portion of 0.4 mm, with L₂/L₁=11.7%. The ray trajectory is shown in FIG. 36, the uniformity in the X direction at the exit face is shown in FIG. 37, the Y-direction uniformity is shown in FIG. 38, and the divergence angle at the exit face is shown in FIG. 39. In FIG. 32 and FIG. 36 showing ray trajectories, the left side shows the ray trajectory inside the light-guiding optical component, where the light beam appears dense. A rectangle indicating the exit face of the tapered portion is visible at the center, and to the right of the exit face of the tapered portion is outside the light-guiding optical component, where the light rays diverge from the exit face and appear sparse. In FIG. 35 and FIG. 39, the X-direction divergence angle is shown by the dark solid line, and the Y-direction divergence angle is shown by the light solid line.

In Example 27 of [Example 2], the uniformity of the illuminance distribution at the exit face was excellent as shown in FIG. 33 and FIG. 34, and the divergence angle was within ±15° with excellent rectilinearity as well as shown in FIG. 35. On the other hand, in Example 21, the divergence angle was not a problem as shown in FIG. 39, but the illuminance distribution at the exit face showed variation of 5% or more in both X and Y directions as shown in FIG. 37 and FIG. 38, and the uniformity was not satisfactory. The other results are shown in Table 5, but the examples with total length L 3 times or more the diagonal length D of the exit face showed excellent uniformity similar to Example 27 and also had small divergence angles. On the other hand, examples with total length L of 2 times or less the diagonal length D of the exit face, similar to Example 21, had small divergence angles but were inferior in uniformity of the illuminance distribution at the exit face, with variation of 5% or more.

### Example 3

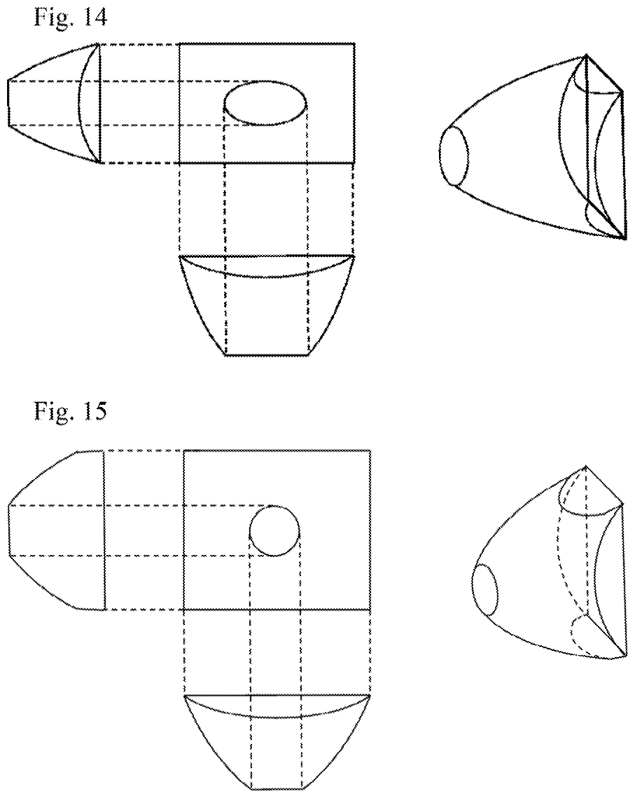

Next, the example for the light-guiding optical component of the third embodiment of the present application is shown. In [Example 1] of the first embodiment and [Example 2] of the second embodiment, the light-guiding optical component had a rectangular CPC-shaped incident portion or a general rectangular frustum-shaped incident portion formed continuously with the top face of the solid rectangular frustum with the taper angles β₁ and β₂. In [Example 3], simulation results are shown for a light-guiding optical component in which the elliptical frustum-shaped incident portion shown in FIG. 13 is formed continuously with the top face of the solid rectangular frustum with taper angles β₇ and β₈. The elliptical frustum that is the incident portion of [Example 3] has an inclination angle β, at any position on the inclined face, with the relationship β₉>β₇, β₈ with respect to the taper angles β₇ and β₈ of the tapered portion. Namely, B, at any position on the inclined face is larger than β₇ and β₈.

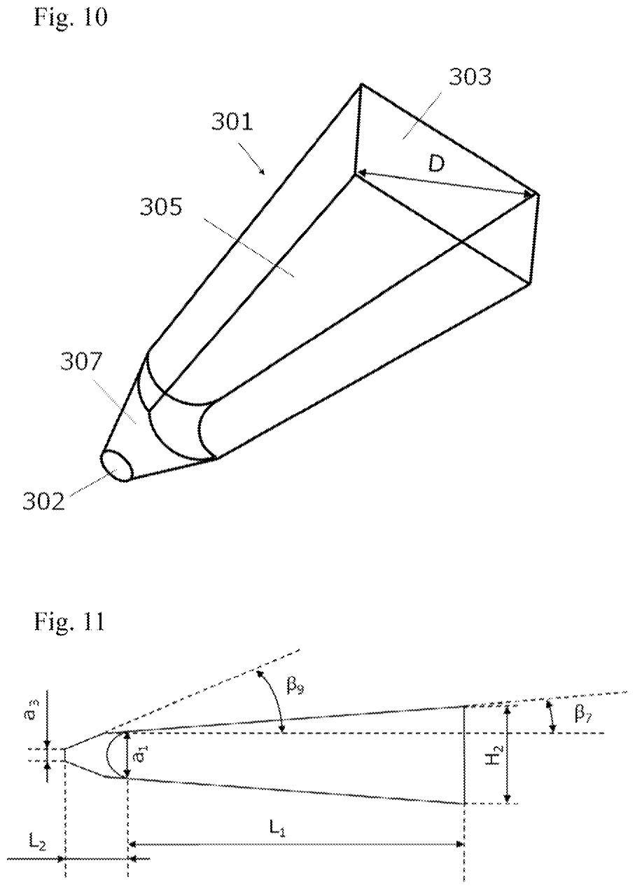

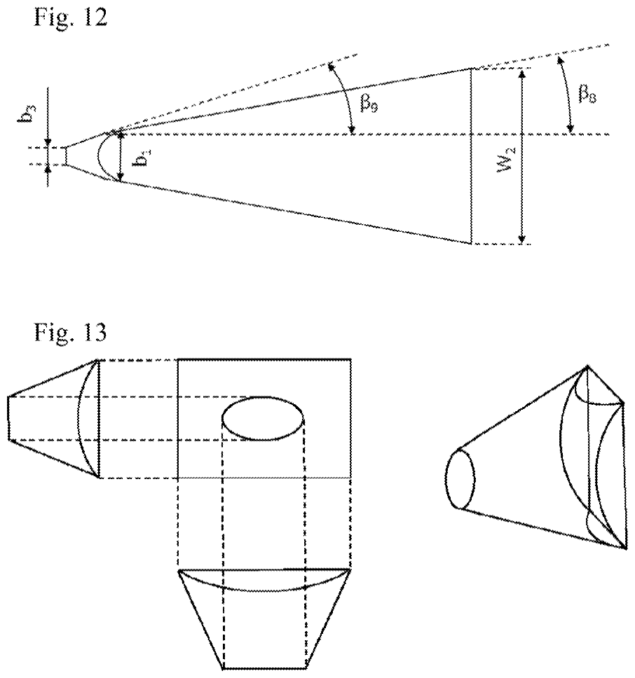

The parameters related to the shape of the light-guiding optical component used in the simulation are shown in Table 6, and the simulation results are shown in Table 7. The taper angle β₇ of the upper/lower faces of the tapered portion is 1.2° to 5.0°, and the taper angle β₈ of the left/right faces is 3.1° to 10.2°. On the other hand, the inclination angle β₈ of the inclined face of the elliptical frustum of the incident portion with respect to the optical axis is 17.8° to 42.9° on the major axis side and 12.7° to 18.7° on the minor axis side. Since the inclination angle β, at positions on the inclined face includes the inclined face on the minor axis a₃ side and the inclined face on the major axis b₃ side (shown in FIG. 11 and FIG. 12), both are listed in Table 6. The size of the incident face was a circle of diameter 0.3 mm, a circle of diameter 0.4 mm, and an ellipse with major axis 0.7 mm and minor axis 0.4 mm. The length L₂ of the incident portion was varied between 0.7 mm and 1.9 mm according to the total length L. The ratio of the length L₂ of the incident portion to the length L₁ of the tapered portion was in the range of 14% to 42%.

TABLE 6

| | | | embodiment 31 | embodiment 32 | embodiment 33 | embodiment 34 |
|---|---|---|---|---|---|---|
| total | ratio of length L to | | 1.5 times | 2 times | 2 times | 2 times |
| | diagonal length D of exit | | | | | |
| | face | | | | | |
| | total length L (mm) | | 3.825 | 5.10 | 5.10 | 5.10 |
| incident | length L₂ (mm) | | 1.1 | 1.5 | 0.7 | 0.8 |
| portion | inclination | left/right | 40.8 | 33.7 | 42.9 | 38.4 |
| (elliptical | angle β₉ | (major side) | | | | |
| frustum) | | inclined face | | | | |
| | | and optical | | | | |
| | | axis | | | | |
| | | upper/lower | 16.2 | 16.7 | 16.7 | 18.7 |
| | | (minor side) | | | | |
| | | inclined face | | | | |
| | | and optical | | | | |
| | | axis | | | | |

| | minor axis a₃-major axis | 0.3-0.3 | 0.3-0.3 | 0.4-0.4 | 0.4-0.7 |
|---|---|---|---|---|---|
| | b₃ of ellipse incident | | | | |
| | face (mm) | | | | |
| tapered | length L₁ (mm) | 2.725 | 3.6 | 4.4 | 4.3 |
| portion | incident face size | 1.24 × 0.78 | 1.30 × 0.99 | 1.16 × 0.60 | 1.27 × 0.72 |
| (rectangular | a₁ × b₁ (mm) | | | | |
| frustum) | left/right face tapered | 10.2 | 7.3 | 6.9 | 6.3 |
| | angle β₈ (°) | | | | |
| | upper/lower face | 5.0 | 2.1 | 4.2 | 3.5 |
| | tapered angle β₇ (°) | | | | |
| | exit face size | 2.22 × 1.25 | | | |
| | H₂ × W₂ (mm) | | | | |

| | | | embodiment 35 | Embodiment 36 | embodiment 37 | embodiment 38 | embodiment 39 |
|---|---|---|---|---|---|---|---|
| total | ratio of length L to | | 3 times | 3 times | 4 times | 4 times | 5 times |
| | diagonal length D of exit | | | | | | |
| | face | | | | | | |
| | total length L (mm) | | 7.65 | 7.65 | 10.20 | 10.20 | 12.75 |
| incident | length L₂ (mm) | | 1.0 | 1.2 | 1.9 | 1.3 | 1.6 |
| portion | inclination | left/right | 33.0 | 24.4 | 17.8 | 22.6 | 20.6 |
| (elliptical | angle β₉ | (major side) | | | | | |
| frustum) | | inclined face | | | | | |
| | | and optical | | | | | |
| | | axis | | | | | |
| | | upper/lower | 16.7 | 14.3 | 14.0 | 15.8 | 12.7 |
| | | (minor side) | | | | | |
| | | inclined face | | | | | |
| | | and optical | | | | | |
| | | axis | | | | | |

| | minor axis a₃-major axis | 0.3-0.3 | 0.4-0.4 | 0.3-0.3 | 0.4-0.4 | 0.3-0.3 |
|---|---|---|---|---|---|---|
| | b₃ of ellipse incident | | | | | |
| | face (mm) | | | | | |
| tapered | length L₁ (mm) | 6.65 | 6.45 | 8.3 | 8.9 | 11.15 |
| portion | incident face size | 1.00 × 0.70 | 0.98 × 0.76 | 1.06 × 0.89 | 1.04 × 0.81 | 0.99 × 0.76 |
| (rectangular | a₁ × b₁ (mm) | | | | | |
| frustum) | left/right face tapered | 5.2 | 5.5 | 4.0 | 3.8 | 3.1 |
| | angle β₈ (°) | | | | | |
| | upper/lower face | 2.4 | 2.2 | 1.2 | 1.4 | 1.2 |
| | tapered angle β₇ (°) | | | | | |
| | exit face size | 2.22 × 1.25 | | | | |
| | H₂ × W₂ (mm) | | | | | |

TABLE 7
tapered light tunnel having length 1.5
times of diagonal length D of exit face
length: 3.825 mm, exit face: 2.22 × 1.25 mm

| | comparative | comparative | comparative |
|---|---|---|---|
| | example 1 | example 2 | example 3 |
| incident face size | 0.3 × 0.3 mm | 0.7 × 0.4 mm | 1.1 × 0.6 mm |
| X divergence angle | ±19.26° | ±23.59° | ±25.47° |
| (FWHM) | | | |
| Y divergence angle | ±11.39° | ±15.12° | ±26.04° |
| (FWHM) | | | |
| uniformity of exit | X | X | X |
| light | | | |

third embodiment (incident
portion: elliptical frustum)
total length L: 3.825 mm = 1.5D,
exit face: 2.22 × 1.25 mm

| | embodiment 31 |
|---|---|
| incident portion size | 0.3 mmφ |
| a₃ × b₃ (mm) | |
| X divergence angle | ±12.94° |
| (FWHM) | |
| Y divergence angle | ±9.40° |
| (FWHM) | |
| uniformity of exit | Δ |
| light | |

tapered light tunnel having length 2
times of diagonal length D of exit face
length: 5.10 mm, exit face: 2.22 × 1.25 mm

| | comparative | comparative | comparative |
|---|---|---|---|
| | example 4 | example 5 | example 6 |
| incident face size | 0.3 × 0.3 mm | 0.7 × 0.4 mm | 1.1 × 0.6 mm |
| X divergence angle | ±16.90° | ±17.17° | ±24.23° |
| (FWHM) | | | |
| Y divergence angle | ±12.36° | ±16.85° | ±26.65° |
| (FWHM) | | | |
| uniformity of exit | X | Δ | Δ |
| light | | | |

third embodiment (incident
portion: elliptical frustum)
total length L: 5.10 mm = 2D,
exit face: 2.22 × 1.25 mm

| | embodiment 32 | | embodiment 33 | | embodiment 34 | |
|---|---|---|---|---|---|---|
| incident portion | 1.5 | mm | 0.7 | mm | 0.8 | mm |
| length L₂ | | | | | | |
| incident portion size | 0.3 | mmφ | 0.4 | mmφ | 0.4 × 0.7 | mm |

| | | | |
|---|---|---|---|
| a₃ × b₃ (mm) | | | |
| X divergence angle | ±16.30° | ±19.58° | ±21.11° |
| (FWHM) | | | |
| Y divergence angle | ±9.27° | ±19.13° | ±21.70° |
| (FWHM) | | | |
| uniformity of exit | ◯ | ◯ | ◯ |
| light | | | |

tapered light tunnel having length 3
times of diagonal length D of exit face
length: 7.65 mm, exit face: 2.22 × 1.25 mm

| | comparative | comparative | comparative |
|---|---|---|---|
| | example 7 | example 8 | example 9 |
| incident face size | 0.3 × 0.3 mm | 0.7 × 0.4 mm | 0.6 × 1.1 mm |
| X divergence angle | ±12.06° | ±14.66° | ±25.50° |
| (FWHM) | | | |
| Y divergence angle | ±11.81° | ±16.90° | ±26.92° |
| (FWHM) | | | |
| uniformity of exit | X | X | ◯ |
| light | | | |

third embodiment (incident
portion: elliptical frustum)
total length L: 7.65 mm = 3D,
exit face: 2.22 × 1.25 mm

| | |
|---|---|
| embodiment 35 | embodiment 36 |

| | | | | |
|---|---|---|---|---|
| incident portion | 1.0 | mm | 1.2 | mm |

length L₂

| | | | | |
|---|---|---|---|---|
| incident portion size | 0.3 | mmφ | 0.4 | mmφ |

| | | |
|---|---|---|
| a₃ × b₃ (mm) | | |
| X divergence angle | ±12.12° | ±9.91° |
| (FWHM) | | |
| Y divergence angle | ±5.65° | ±11.33° |
| (FWHM) | | |
| uniformity of exit | ⊚ | ⊚ |
| light | | |

tapered light tunnel having length 4
times of diagonal length D of exit face
length: 10.20 mm, exit face: 2.22 × 1.25 mm

| | comparative | comparative | comparative |
|---|---|---|---|
| | example 10 | example 11 | example 12 |
| incident face size | 0.3 × 0.3 mm | 0.7 × 0.4 mm | 1.1 × 0.6 mm |
| X divergence angle | ±9.01° | ±16.49° | ±27.68° |
| (FWHM) | | | |
| Y divergence angle | ±11.65° | ±18.08° | ±28.45° |
| (FWHM) | | | |
| uniformity of exit | X | Δ | ◯ |
| light | | | |

third embodiment (incident
portion: elliptical frustum)
total length L: 10.20 mm = 4D,
exit face: 2.22 × 1.25 mm

| | |
|---|---|
| embodiment 37 | embodiment 38 |

| | | | | |
|---|---|---|---|---|
| incident portion | 1.9 | mm | 1.3 | mm |

length L₂

| | | | | |
|---|---|---|---|---|
| incident portion size | 0.3 | mmφ | 0.4 | mmφ |

| | | |
|---|---|---|
| a₃ × b₃ (mm) | | |
| X divergence angle | ±7.21° | ±7.08° |
| (FWHM) | | |
| Y divergence angle | ±7.46° | ±7.40° |
| (FWHM) | | |
| uniformity of exit | ⊚ | ⊚ |
| light | | |

tapered light tunnel having length 5
times of diagonal length D of exit face
length: 12.75 mm, exit face: 2.22 × 1.25 mm

| | comparative | comparative | comparative |
|---|---|---|---|
| | example 13 | example 14 | example 15 |
| incident face size | 0.3 × 0.3 mm | 0.7 × 0.4 mm | 1.1 × 0.6 mm |
| X divergence angle | ±7.97° | ±17.56° | ±28.90° |
| (FWHM) | | | |
| Y divergence angle | ±11.62° | ±17.82° | ±27.74° |
| (FWHM) | | | |
| uniformity of exit | Δ | Δ | ◯ |
| light | | | |

third embodiment (incident
portion: elliptical frustum)
total length L: 12.75 mm = 5D,
exit face: 2.22 × 1.25 mm

| | embodiment 39 |
|---|---|
| incident portion size | 0.3 mmφ |
| a₃ × b₃ (mm) | |
| X divergence angle | ±6.67° |
| (FWHM) | |
| Y divergence angle | ±6.68° |
| (FWHM) | |
| uniformity of exit | ⊚ |
| light | |

In the cases where the total length L was 3, 4 and 5 times the diagonal length D of the exit face (Examples 35 to 39), the uniformity of the illuminance distribution at the exit face was extremely excellent and the divergence angle was also very small. In the cases where the total length L was 2 times the diagonal length D of the exit face (Examples 32 to 34), the divergence angle increased as the incident face became larger, but it was sufficiently small for the size of the incident face of 0.3 mmφ and 0.4 mmφ. About 5% variation was seen in the uniformity of the illuminance distribution at the exit face, but it was sufficiently uniform. In the case where the total length L was 1.5 times the diagonal length D of the exit face (Example 31), the divergence angle remained small, but the uniformity of the illuminance distribution at the exit face showed large variation of about 10%.

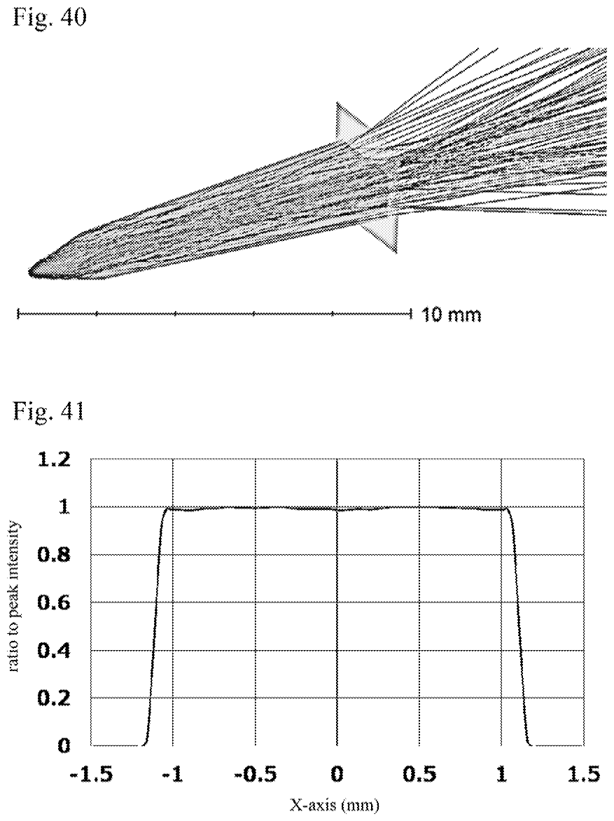

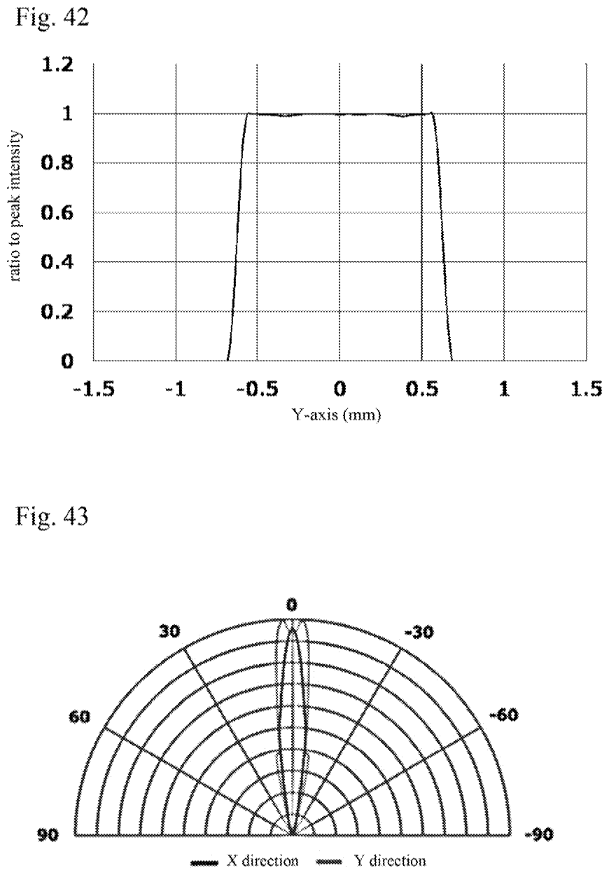

The ray-tracing simulation result for Example 37 is shown in FIG. 40. In the figure, a square plane appears in the middle, indicating the exit face of the light-guiding optical component of the present invention. The left side of the square plane is the ray trajectory inside the light-guiding optical component, and the right side is the trajectory of light rays that have exited the exit face. The illuminance distributions in the X direction (horizontal direction) and the Y direction (vertical direction) at the exit face are shown in FIG. 41 and FIG. 42. It can be seen that the illuminance distribution at the exit face is extremely uniform. FIG. 43 shows the divergence angle at the exit face, where the dark solid line is the X direction and the light solid line is the Y direction divergence angle. Both show extremely small FWHM values of ±7.2° and ±7.5°, confirming that narrowing of the divergence angle has been achieved.

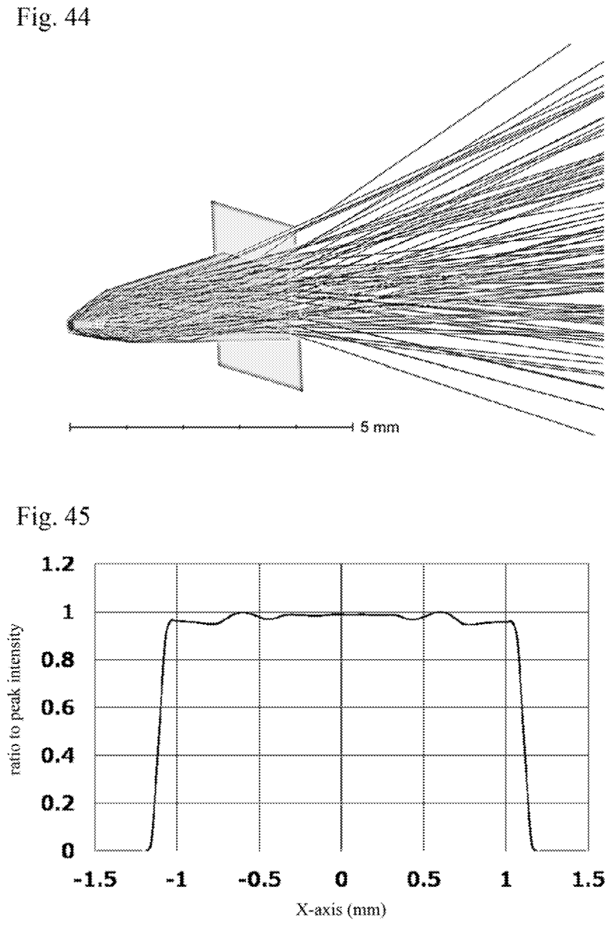

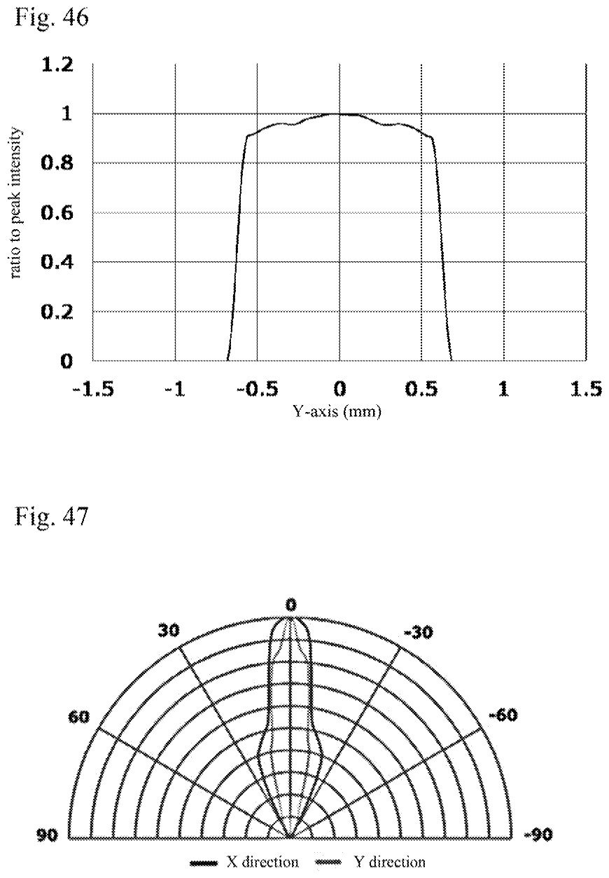

The ray-tracing simulation result for Example 31 is shown in FIG. 44. Similar to FIG. 40, the square plane appears in the middle, indicating the exit face of the light-guiding optical component of the present invention. The left side of the square plane is the ray trajectory inside the light-guiding optical component, and the right side is the trajectory of light rays that have exited the exit face. The illuminance distributions in the X direction (horizontal direction) and the Y direction (vertical direction) at the exit face are shown in FIG. 45 and FIG. 46. The illuminance distribution at the exit face shows variation of around 5% in the X direction, and the variation exceeds 10% at the ends in the Y direction. This confirms that the uniformity of the illuminance distribution at the exit face is poor. FIG. 47 shows the divergence angle at the exit face, where the dark solid line is the X direction and the light solid line is the Y direction divergence angle. The FWHM values are ±12.9° and ±9.4°, both small values, confirming that there is no problem with rectilinearity.

The other examples can be read from Table 7. For Examples 35, 36, 38 and 39, where the total length Lis 3 times or more the diagonal length D of the exit face, similarly to Example 37 whose results were shown earlier, the uniformity of the illuminance distribution at the exit face was excellent, the divergence angle was also small, and excellent rectilinearity was also confirmed. On the other hand, in the cases where the total length L is 2 times the diagonal length D of the exit face, the illuminance distribution at the exit face showed variation close to 5%, and the divergence angle was not as small as in Example 37. Examples 32 and 33 were considered to have satisfactory illuminance distribution uniformity and divergence angle. However, Example 34, with a larger size of the incident face, had a large divergence angle and was judged to have insufficient performance.

### Example 4

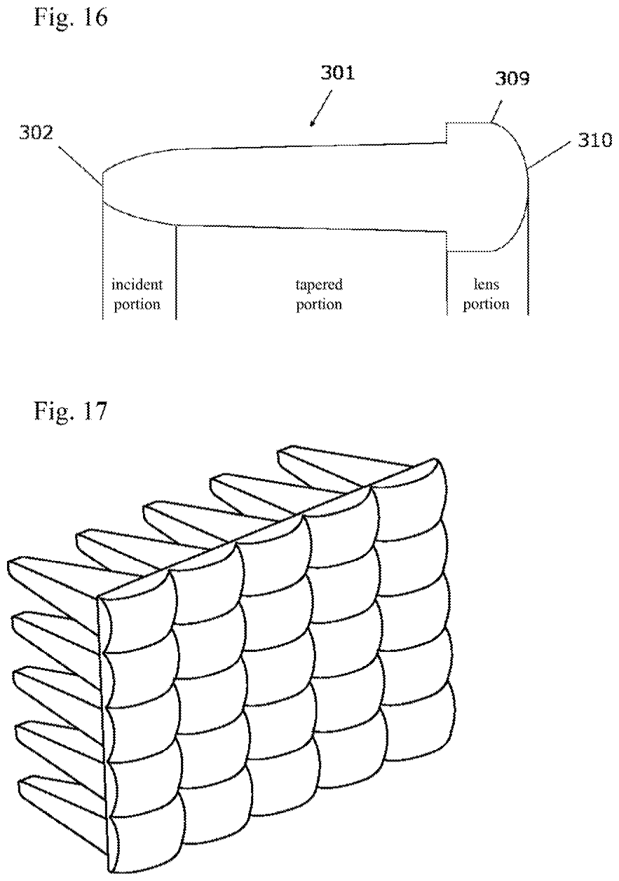

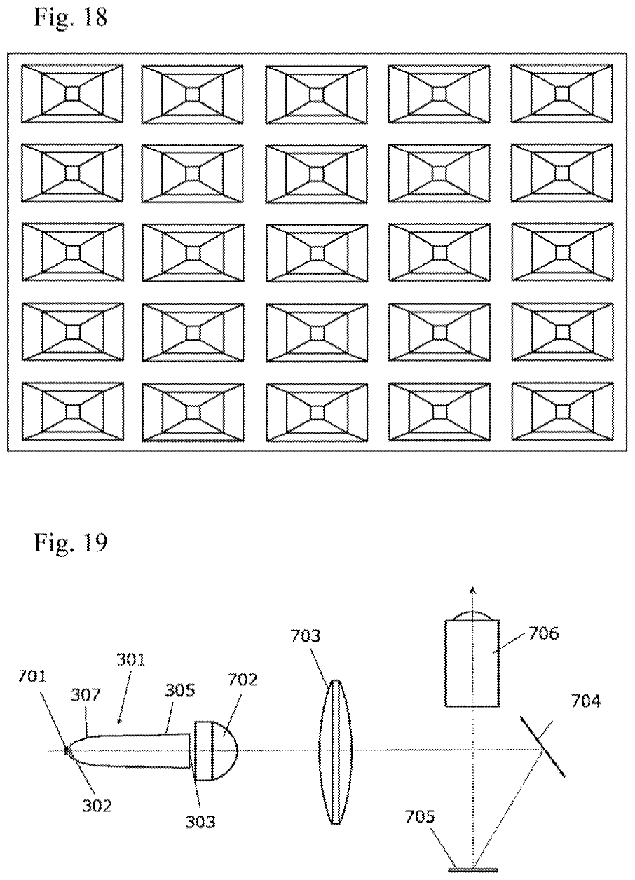

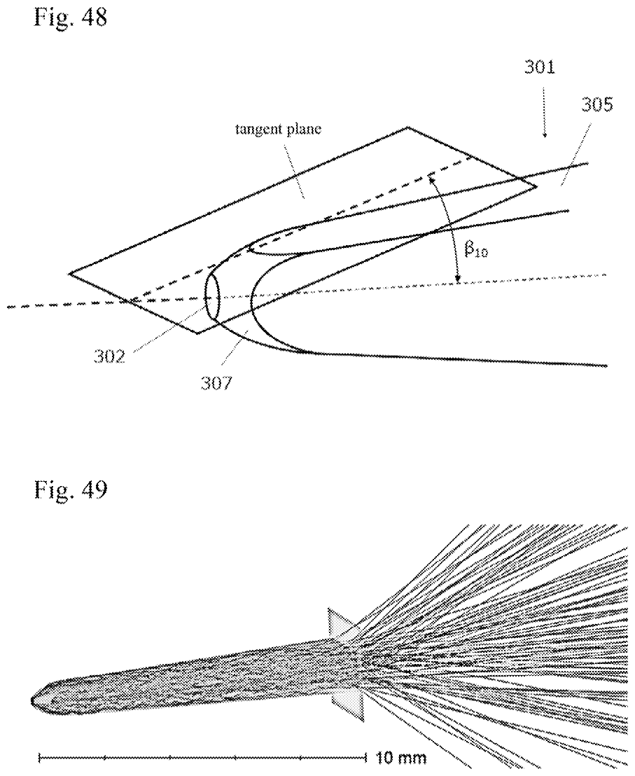

Next, the example relating to the light-guiding optical component of the fourth embodiment of the present application is shown. In [Example 3], which is the example of the third embodiment of the present application, simulation results were shown for the light-guiding optical component in which the incident portion of the shape shown in FIG. 13 (i.e., the elliptical frustum shape) is formed continuously with the top face of the solid rectangular frustum with the taper angles β₇ and β₈. However, the incident portion of [Example 4] is the circular CPC shape as shown in FIG. 15, in which the incident face of the incident portion is circular, the bottom face is square, and the inclined face is a CPC (internally reflective paraboloid). Similar to the third example [Example 3], the tapered portion is a solid rectangular frustum with the taper angles β₇ and β₈. Namely, simulations were performed for a light-guiding optical component in which an incident portion of a circular CPC was formed continuously on top of the tapered portion of the solid rectangular frustum. In this case, the relationship β₁₀>β₇, β₈ is satisfied between the inclination angle β₁₀ of the tangent plane at any position on the inclined face of the circular CPC incident portion and the taper angle of the tapered portion. Namely, β₁₀ is greater than β₇ and β₈ (shown in FIG. 48).

The parameters related to the shape of the light-guiding optical component used in the simulation are shown in Table 8, and the simulation results are shown in Table 9. The taper angle β₇ of the upper/lower faces of the tapered portion is 0.5° to 5.3°, and the taper angle β₈ of the left/right faces is 3.0° to 11.2°. On the other hand, for the circular CPC incident portion, the inclination angle β₁₀ with respect to the optical axis shows the maximum angle at the position adjacent to the incident face, and the minimum angle at the horizontal direction end and vertical direction end. These angles are also listed in Table 8. The size of the incident face was a circle of diameter 0.3 mm, a circle of diameter 0.4 mm or a circle of diameter 0.5 mm. The length L₂ of the incident portion was varied from 0.8 mm to 1.5 mm according to the total length L. The ratio of the length L₂ of the incident portion to the length L₁ of the tapered portion was in the range of 11% to 42%.

TABLE 8

| | | | embodiment 41 | embodiment 42 | embodiment 43 | embodiment 44 |
|---|---|---|---|---|---|---|
| total | ratio of length L to | | 1.5 times | 2 times | 2 times | 3 times |
| | diagonal length D of exit | | | | | |
| | face | | | | | |
| | length L (mm) | | 3.825 | 5.10 | 5.10 | 7.65 |
| incident | incident portion length | | 0.9 | 1.5 | 0.8 | 1.0 |
| portion | L₂ (mm) | | | | | |
| (circular | incident portion size | | φ0.3 | φ0.3 | φ0.4 | φ0.3 |
| CPC) | a₃ × b₃ (mm) | | | | | |
| | inclination | side face | 41.1 | 37.3 | 36.5 | 37.2 |
| | angle β₁₀ | maximum | | | | |
| | | angle (°) | | | | |
| | | left/right | 26.4 | 28.0 | 25.7 | 23.3 |
| | | direction | | | | |
| | | minimum | | | | |
| | | angle (°) | | | | |
| | | upper/lower | 35.7 | 26.6 | 33.1 | 26.9 |
| | | direction | | | | |
| | | minimum | | | | |
| | | angle (°) | | | | |

| tapered | tapered portion length | 2.925 | 3.6 | 4.3 | 6.65 |
|---|---|---|---|---|---|
| portion | L₁ (mm) | | | | |
| (rectangular | incident face size | 1.1 × 0.71 | 1.0 × 0.83 | 0.93 × 0.66 | 0.90 × 0.73 |
| frustum) | a₁ × b₁ (mm) | | | | |
| | left/right face tapered | 11.2 | 9.4 | 8.5 | 5.6 |
| | angle β₈ (°) | | | | |
| | upper/lower face | 5.3 | 3.4 | 3.9 | 2.2 |
| | tapered angle β₇ (°) | | | | |
| | exit face size | 2.22 × 1.25 | | | |
| | H₂ × W₂ (mm) | | | | |

| | | | embodiment 45 | embodiment 46 | embodiment 47 | embodiment 48 | embodiment 49 |
|---|---|---|---|---|---|---|---|
| total | ratio of length L to | | 3 times | 3 times | 4 times | 4 times | 5 times |
| | diagonal length D of exit | | | | | | |
| | face | | | | | | |
| | length L (mm) | | 7.65 | 7.65 | 10.20 | 10.20 | 12.75 |
| incident | incident portion length | | 1.1 | 1.1 | 1.2 | 1.3 | 1.3 |
| portion | L₂ (mm) | | | | | | |
| (circular | incident portion size | | φ0.4 | φ0.5 | φ0.3 | φ0.4 | φ0.3 |
| CPC) | a₃ × b₃ (mm) | | | | | | |
| | inclination | side face | 36.0 | 35.5 | 39.6 | 37.0 | 39.7 |
| | angle β₁₀ | maximum | | | | | |
| | | angle (°) | | | | | |
| | | left/right | 22.4 | 23.1 | 23.9 | 26.0 | 22.9 |
| | | direction | | | | | |
| | | minimum | | | | | |
| | | angle (°) | | | | | |
| | | upper/lower | 30.2 | 30.9 | 23.5 | 22.9 | 23.3 |
| | | direction | | | | | |
| | | minimum | | | | | |
| | | angle (°) | | | | | |

| tapered | tapered portion length | 6.55 | 6.55 | 9.0 | 8.9 | 11.45 |
|---|---|---|---|---|---|---|
| portion | L₁ (mm) | | | | | |
| (rectangular | incident face size | 1.1 × 0.78 | 1.2 × 0.84 | 0.95 × 0.91 | 1.1 × 1.1 | 1.0 × 0.94 |
| frustum) | a₁ × b₁ (mm) | | | | | |
| | left/right face tapered | 5.0 | 4.6 | 4.0 | 3.7 | 3.0 |
| | angle β₈ (°) | | | | | |
| | upper/lower face | 2.1 | 1.8 | 1.1 | 0.5 | 0.8 |
| | tapered angle β₇ (°) | | | | | |
| | exit face size | 2.22 × 1.25 | | | | |
| | H₂ × W₂ (mm) | | | | | |

TABLE 9
tapered light tunnel having length 1.5
times of diagonal length D of exit face
length: 3.825 mm, exit face: 2.22 × 1.25 mm

| | comparative | comparative | comparative |
|---|---|---|---|
| | example 1 | example 2 | example 3 |
| incident face size | 0.3 × 0.3 mm | 0.7 × 0.4 mm | 1.1 × 0.6 mm |
| X divergence angle | ±19.26° | ±23.59° | ±25.47° |
| (FWHM) | | | |
| Y divergence angle | ±11.39° | ±15.12° | ±26.04° |
| (FWHM) | | | |
| uniformity of exit | X | X | X |
| light | | | |

fourth embodiment (incident portion: circular CPC)
total length L: 3.825 mm = 1.5D, incident face length
L₂: 0.9 mm, exit face: 2.22 × 1.25 mm,

| | embodiment 41 |
|---|---|
| incident portion size | 0.3 mmφ |
| X divergence angle | ±18.46° |
| (FWHM) | |
| Y divergence angle | ±19.26° |
| (FWHM) | |
| uniformity of exit | Δ |
| light | |

tapered light tunnel having length 2
times of diagonal length D of exit face
length: 5.10 mm, exit face: 2.22 × 1.25 mm

| | comparative | comparative | comparative |
|---|---|---|---|
| | example 4 | example 5 | example 6 |
| incident face size | 0.3 × 0.3 mm | 0.7 × 0.4 mm | 1.1 × 0.6 mm |
| X divergence angle | ±16.90° | ±17.17° | ±24.23° |
| (FWHM) | | | |
| Y divergence angle | ±12.36° | ±16.85° | ±26.65° |
| (FWHM) | | | |
| uniformity of exit | X | Δ | Δ |
| light | | | |

fourth embodiment (incident
portion: circular CPC)
total length L: 5.10 mm = 2D,
exit face: 2.22 × 1.25 mm

| | |
|---|---|
| embodiment 42 | embodiment 43 |

| | | | | |
|---|---|---|---|---|
| incident portion | 1.5 | mm | 0.8 | mm |
| length L₂ | | | | |
| incident portion size | 0.3 | mmφ | 0.4 | mmφ |

| | | |
|---|---|---|
| X divergence angle | ±10.52° | ±10.65° |
| (FWHM) | | |
| Y divergence angle | ±10.70° | ±20.67° |
| (FWHM) | | |
| uniformity of exit | Δ | Δ |
| light | | |

tapered light tunnel having length 3
times of diagonal length D of exit face
length: 7.65 mm, exit face: 2.22 × 1.25 mm

| | comparative | comparative | comparative |
|---|---|---|---|
| | example 7 | example 8 | example 9 |
| incident face size | 0.3 × 0.3 mm | 0.7 × 0.4 mm | 1.1 × 0.6 mm |
| X divergence angle | ±12.06° | ±14.66° | ±25.50° |
| (FWHM) | | | |
| Y divergence angle | ±11.81° | ±16.90° | ±26.92° |
| (FWHM) | | | |
| uniformity of exit | X | X | ◯ |
| light | | | |

fourth embodiment (incident
portion: circular CPC)
total length L: 7.65 mm = 3D,
exit face: 2.22 × 1.25 mm

| | embodiment 44 | | embodiment 45 | | embodiment 46 | |
|---|---|---|---|---|---|---|
| incident portion | 1.0 | mm | 1.1 | mm | 1.1 | mm |
| length L₂ | | | | | | |
| incident portion size | 0.3 | mmφ | 0.4 | mmφ | 0.5 | mmφ |

| | | | |
|---|---|---|---|
| X divergence angle | ±10.37° | ±12.59° | ±20.96° |
| (FWHM) | | | |
| Y divergence angle | ±14.34° | ±10.71° | ±15.10° |
| (FWHM) | | | |
| uniformity of exit | ⊚ | ⊚ | ◯ |
| light | | | |

tapered light tunnel having length 4
times of diagonal length D of exit face
length: 10.20 mm, exit face: 2.22 × 1.25 mm

| | comparative | comparative | comparative |
|---|---|---|---|
| | example 10 | example 11 | example 12 |
| incident face size | 0.3 × 0.3 mm | 0.7 × 0.4 mm | 1.1 × 0.6 mm |
| X divergence angle | ±9.01° | ±16.49° | ±27.68° |
| (FWHM) | | | |
| Y divergence angle | ±11.65° | ±18.08° | ±28.45° |
| (FWHM) | | | |
| uniformity of exit | X | Δ | ◯ |
| light | | | |

fourth embodiment (incident
portion: circular CPC)
total length L: 10.20 mm = 4D,
exit face: 2.22 × 1.25 mm

| | |
|---|---|
| embodiment 47 | embodiment 48 |

| | | | | |
|---|---|---|---|---|
| incident portion | 1.2 | mm | 1.3 | mm |

length L₂

| | | | | |
|---|---|---|---|---|
| incident portion size | 0.3 | mmφ | 0.4 | mmφ |

| | | |
|---|---|---|
| X divergence angle | ±6.56° | ±6.51° |
| (FWHM) | | |
| Y divergence angle | ±6.33° | ±6.61° |
| (FWHM) | | |
| uniformity of exit | ⊚ | ⊚ |
| light | | |

tapered light tunnel having length 5
times of diagonal length D of exit face
length: 12.75 mm, exit face: 2.22 × 1.25 mm

| | comparative | comparative | comparative |
|---|---|---|---|
| | example 13 | example 14 | example 15 |
| incident face size | 0.3 × 0.3 mm | 0.7 × 0.4 mm | 1.1 × 0.6 mm |
| X divergence angle | ±7.97° | ±17.56° | ±28.90° |
| (FWHM) | | | |
| Y divergence angle | ±11.62° | ±17.82° | ±27.74° |
| (FWHM) | | | |
| uniformity of exit | Δ | Δ | ◯ |
| light | | | |

fourth embodiment (incident portion: circular CPC)
total length L: 12.75 mm = 5D, incident portion length
L₂ = 1.3 mm, exit face: 2.22 × 1.25 mm

| | embodiment 49 |
|---|---|
| incident portion size | 0.3 mmφ |
| X divergence angle | ±4.96° |
| (FWHM) | |
| Y divergence angle | ±7.01° |
| (FWHM) | |
| uniformity of exit | ⊚ |
| light | |

In the cases where the total length L was 3, 4 and 5 times the diagonal length D of the exit face (Examples 44 to 49), the uniformity of the illuminance distribution at the exit face was extremely excellent and the divergence angle was also small. In the cases where the total length L was 2 times the diagonal length D of the exit face (Examples 42 and 43), about 5% variation was seen in the uniformity of the illuminance distribution at the exit face, and the divergence angle also became slightly larger. In the case where the total length L was 1.5 times the diagonal length D of the exit face (Example 41), the uniformity of the illuminance distribution at the exit face showed variation of about 10%, and the divergence angle also exceeded ±15°.

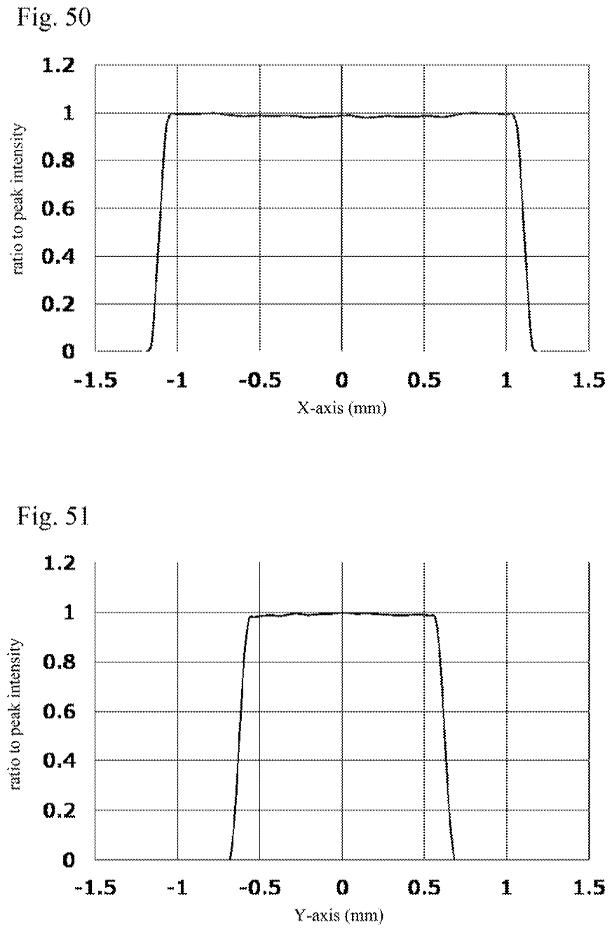

For Example 47, the ray-tracing simulation result, the illuminance distributions in the X and Y directions at the exit face and the divergence angle at the exit face position are shown in FIGS. 49, 50, 51 and 52, respectively. It can be seen that the uniformity of the illuminance distribution is excellent and the divergence angle is small with excellent rectilinearity.

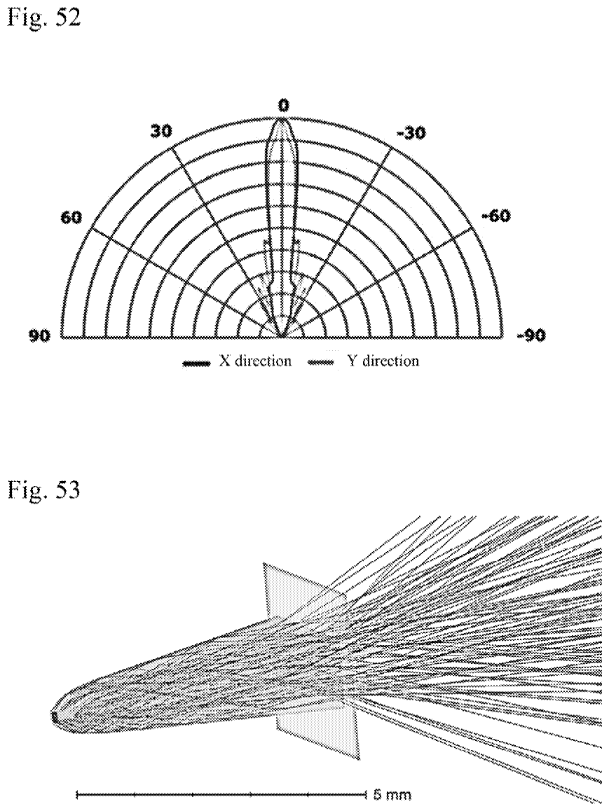

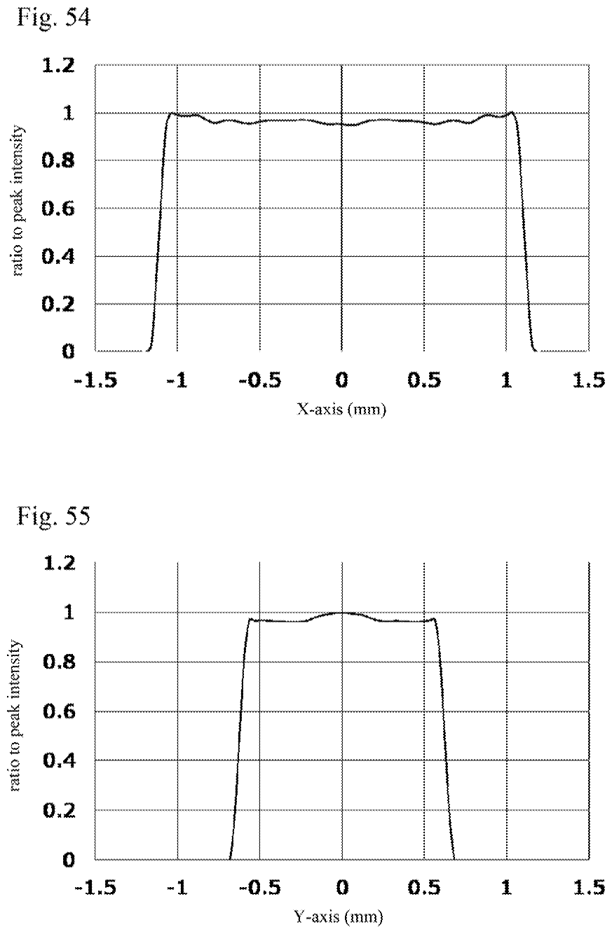

Next, for Example 42, the ray-tracing simulation result, the illuminance distributions in the X and Y directions at the exit face and the divergence angle at the exit face position are shown in FIGS. 53, 54, 55 and 56 respectively. Regarding the illuminance distribution at the exit face, about 5% variation was seen in both X and Y directions. The divergence angle was approximately +10°, which was at a non-problematic level.

### Example 5

From the results of [Example 1], [Example 2], [Example 3] and [Example 4] above, it is found that there exist both examples that show good results and examples that are insufficient, and that the boundary between them can be distinguished by the ratio of the total length L to the diagonal length D of the exit face (L/D) in each case where the incident portion is a rectangular CPC, a second rectangular frustum, an elliptical frustum and a circular CPC. When the incident portion is a rectangular CPC, the results were good even when L/D was 1.5, so the results were considered to be insufficient when L/D is 1.5 or less. When the incident portion was a second rectangular frustum, the results were good when L/D was 3. However, when L/D was 2, although the divergence angle was small, the uniformity of the illuminance distribution at the exit face was insufficient. Thus, the boundary is considered to lie between L/D values of 2 and 3. When the incident portion was an elliptical frustum, the results were good when L/D was 2 or more. However, when L/D became 1.5, although the divergence angle was small, the uniformity of the illuminance distribution at the exit face became insufficient. Thus, the boundary is considered to lie between L/D values of 1.5 and 2. When the incident portion was a circular CPC, the results were good when L/D is 3 or more. However, when L/D became 2 or less, although the divergence angle was small, the uniformity of the illuminance distribution at the exit face became insufficient. Thus, the boundary is considered to lie between L/D values of 2 and 3. Therefore, in order to determine the exact boundary value of L/D, simulations were performed by adding further examples. The shape model parameters for the additional simulations are shown in Tables 10 and 11, and the simulation results are shown in Table 12.

TABLE 10

| | compar- | compar- | compar- | compar- |
|---|---|---|---|---|
| | ative | ative | ative | ative |
| | exam- | exam- | exam- | exam- |
| | ple 21 | ple 22 | ple 23 | ple 24 |
| ratio of total length | 1.2 | 1.8 | 2.4 | 2.4 |
| to diagonal length | times | times | times | times |
| of exit face | | | | |
| total length (mm) | 3.06 | 4.59 | 6.12 | 6.12 |
| incident face size (mm) | 0.3 × 0.3 | 0.3 × 0.3 | 0.3 × 0.3 | 0.7 × 0.4 |
| left/right face tapered | 17.4 | 11.8 | 8.9 | 7.1 |
| angle (°) | | | | |
| upper/lower face tapered | 8.8 | 5.9 | 4.4 | 4.0 |
| angle (°) | | | | |

| | |
|---|---|
| exit face size (mm) | 2.22 × 1.25 |

TABLE 11

| total | ratio of length L to | | 1.2 times | 1.8 times | 2.4 times | 2.4 times | 2.4 times | 2.4 times |
|---|---|---|---|---|---|---|---|---|
| | diagonal length D of | | | | | | | |
| | exit face | | | | | | | |
| | total length L (mm) | | 3.06 | 4.59 | 6.12 | 6.12 | 6.12 | 6.12 |
| incident | shape of incident | | rectangular | elliptical | rectangular | rectangular | circular | circular |
| portion | portion | | CPC | frustum | frustum | frustum | CPC | CPC |
| | incident portion length | | 0.6 | 1.4 | 0.9 | 1.0 | 0.8 | 0.8 |
| | L₂ (mm) | | | | | | | |
| | incident | H₃ × W₃ | 0.3 × 0.3 | — | 0.3 × 0.3 | 0.4 × 0.4 | — | — |
| | face size | a₃ × b₃ | — | 0.3φ | — | — | 0.3φ | 0.4φ |
| | (mm) | | | | | | | |
| | left/right | maximum | 36.2 | — | — | — | — | — |
| | face | angle | | | | | | |
| | inclination | minimum | 16.4 | | | | | |
| | angle β₄ (°) | angle | | | | | | |
| | upper/lower | maximum | 37.2 | — | — | — | — | — |
| | face | angle | | | | | | |
| | inclination | minimum | 14.0 | | | | | |
| | angle β₃ (°) | angle | | | | | | |
| | left/right face | | — | — | 24.1 | 18.4 | — | — |
| | inclination angle β₆ (°) | | | | | | | |
| | upper/lower face | | | | 11.0 | 10.8 | | |
| | inclination angle β₅ (°) | | | | | | | |
| | inclination | major | — | 37.9 | — | — | — | — |
| | angle β₉ (°) | axis side | | | | | | |
| | | minor | — | 16.3 | — | — | — | — |
| | | axis side | | | | | | |
| | inclination | maximum | — | — | — | — | 37.7 | 37.3 |
| | angle β₁₀ (°) | angle | | | | | | |
| | | left/right | | | | | 32.7 | 37.0 |
| | | face min | | | | | | |
| | | angle | | | | | | |
| | | upper/lower | | | | | 24.5 | 23.4 |
| | | face min | | | | | | |
| | | angle | | | | | | |

| tapered | length L₁ (mm) | 2.46 | 3.19 | 5.22 | 5.12 | 5.32 | 5.32 |
|---|---|---|---|---|---|---|---|
| portion | incident face size | 0.78 × 0.81 | 1.30 × 0.96 | 1.1 × 0.65 | 1.1 × 0.78 | 0.70 × 0.75 | 0.99 × 0.60 |
| (rectangular | H₁ (a₁) × W₁ (b₁) (mm) | | | | | | |
| frustum) | left/right face tapered | 16.3 | 8.3 | 6.1 | 6.4 | 8.1 | 6.6 |
| | angle β₂ or β₈ (°) | | | | | | |
| | upper/lower face | 5.2 | 2.7 | 3.3 | 2.6 | 2.7 | 3.5 |
| | tapered angle β₁ or β₇ | | | | | | |
| | (°) | | | | | | |
| | exit face size | 2.22 × 1.25 | | | | | |
| | H₂ × W₂ (mm) | | | | | | |

TABLE 12
tapered light tunnel having length 1.2
times of diagonal length D of exit face
length: 3.06 mm, exit face: 2.22 × 1.25 mm

| | comparative |
|---|---|
| | example 21 |
| incident face size | 0.3 × 0.3 mm |
| X divergence angle | ±23.85° |
| (FWHM) | |
| Y divergence angle | ±11.61° |
| (FWHM) | |
| uniformity of exit | X |
| light | |

first embodiment (incident
portion: rectangular CPC)
total length L: 3.06 mm = 1.2D,
exit face: 2.22 × 1.25 mm

| | embodiment 51 | |
|---|---|---|
| incident portion | 0.6 | mm |
| length L₂ | | |
| L₂/L₁ | 24.4% | |
| incident face size | 0.3 × 0.3 | mm |

| | |
|---|---|
| X divergence angle | ±22.35° |
| (FWHM) | |
| Y divergence angle | ±18.11° |
| (FWHM) | |
| uniformity of exit | X |
| light | |

tapered light tunnel having length 1.8
times of diagonal length D of exit face
length: 4.59 mm, exit face: 2.22 × 1.25 mm

| | comparative |
|---|---|
| | example 22 |
| incident face size | 0.3 × 0.3 mm |
| X divergence angle | ±18.52° |
| (FWHM) | |
| Y divergence angle | ±12.28° |
| (FWHM) | |
| uniformity of exit | X |
| light | |

third embodiment (incident
portion: elliptical frustum)
total length L: 4.59 mm = 1.8D,
exit face: 2.22 × 1.25 mm

| | embodiment 52 | |
|---|---|---|
| incident portion | 1.4 | mm |
| length L₂ | | |
| L₂/L₁ | 43.90% | |
| incident face size | 0.3 × 0.3 | mm |

| | |
|---|---|
| X divergence angle | ±12.51° |
| (FWHM) | |
| Y divergence angle | ±8.60° |
| (FWHM) | |
| uniformity of exit | Δ |
| light | |

tapered light tunnel having length 2.4
times of diagonal length D of exit face
length: 6.12 mm, exit face: 2.22 × 1.25 mm

| | comparative | comparative |
|---|---|---|
| | example 23 | example 24 |
| incident face size | 0.3 × 0.3 mm | 0.7 × 0.4 mm |
| X divergence angle | ±11.94° | ±16.55° |
| (FWHM) | | |
| Y divergence angle | ±10.26° | ±16.38° |
| (FWHM) | | |
| uniformity of exit | Δ | Δ |
| light | | |

second embodiment (incident
portion: rectangular frustum)
total length L: 6.12 mm = 2.4D,
exit face: 2.22 × 1.25 mm

| | embodiment 53 | | embodiment 54 | |
|---|---|---|---|---|
| incident portion | 0.9 | mm | 1.0 | mm |

| | | |
|---|---|---|
| length L₂ | | |
| L₂/L₁ | 17.2% | 19.5% |

| | | | | |
|---|---|---|---|---|
| incident face size | 0.3 × 0.3 | mm | 0.4 × 0.4 | mm |

| | | |
|---|---|---|
| X divergence angle | ±12.52° | ±13.69° |
| (FWHM) | | |
| Y divergence angle | ±10.96° | ±16.09° |
| (FWHM) | | |
| uniformity of exit | ◯ | ⊚ |
| light | | |

fourth embodiment (incident portion: circular CPC)
total length L: 6.12 mm = 2.4D,
exit face: 2.22 × 1.25 mm

| | embodiment 55 | | embodiment 56 | |
|---|---|---|---|---|
| incident portion | 0.8 | mm | 0.8 | mm |

| | | |
|---|---|---|
| length L₂ | | |
| L₂/L₁ | 15.0% | 15.0% |

| | | | | |
|---|---|---|---|---|
| incident face size | 0.3 | mmφ | 0.4 | mmφ |

| | | |
|---|---|---|
| X divergence angle | ±13.15° | ±16.39° |
| (FWHM) | | |
| Y divergence angle | ±18.46° | ±20.51° |
| (FWHM) | | |
| uniformity of exit | ◯ | ◯ |
| light | | |

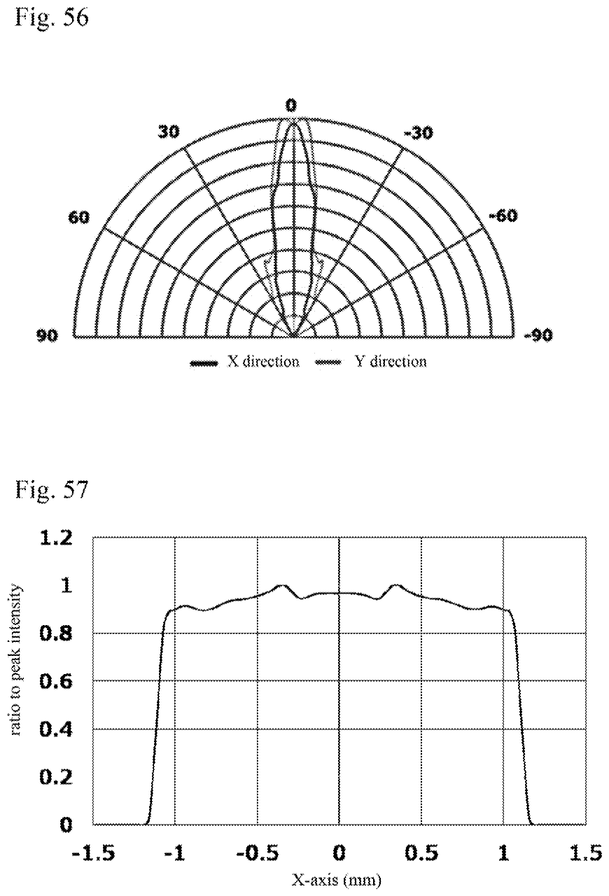

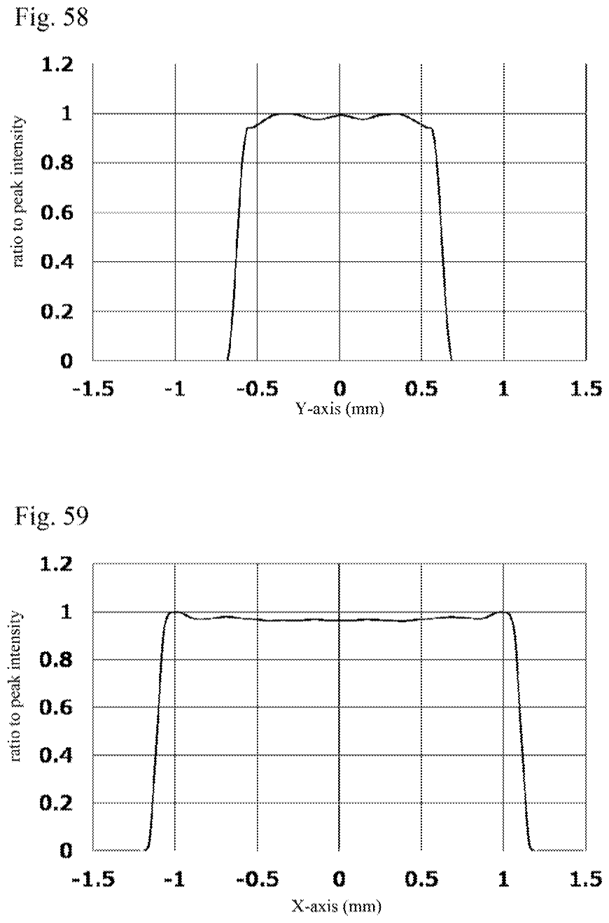

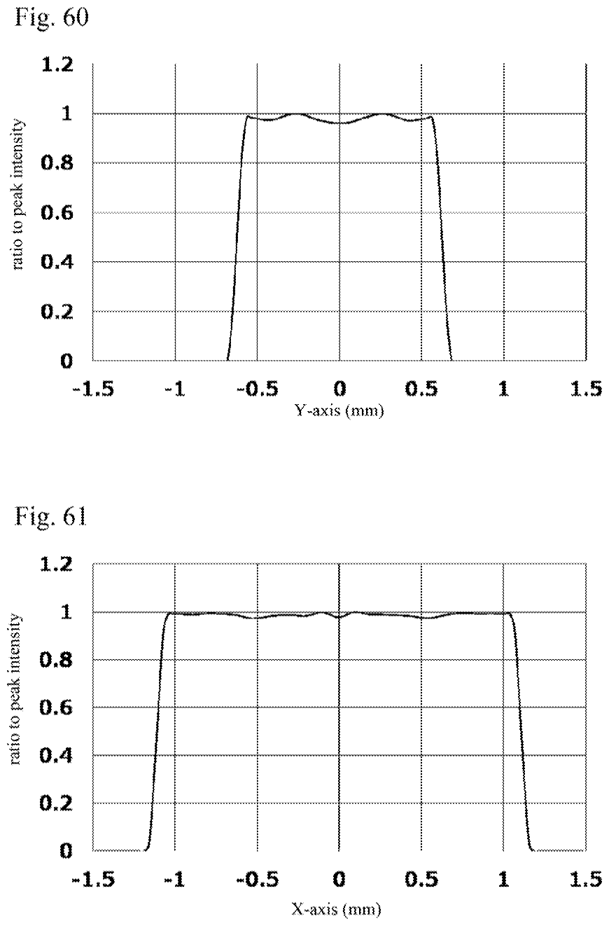

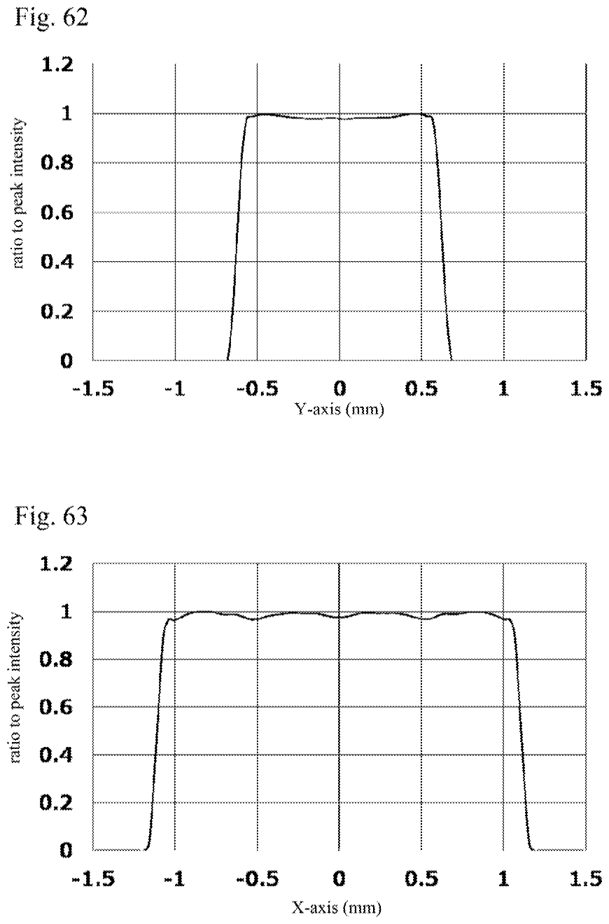

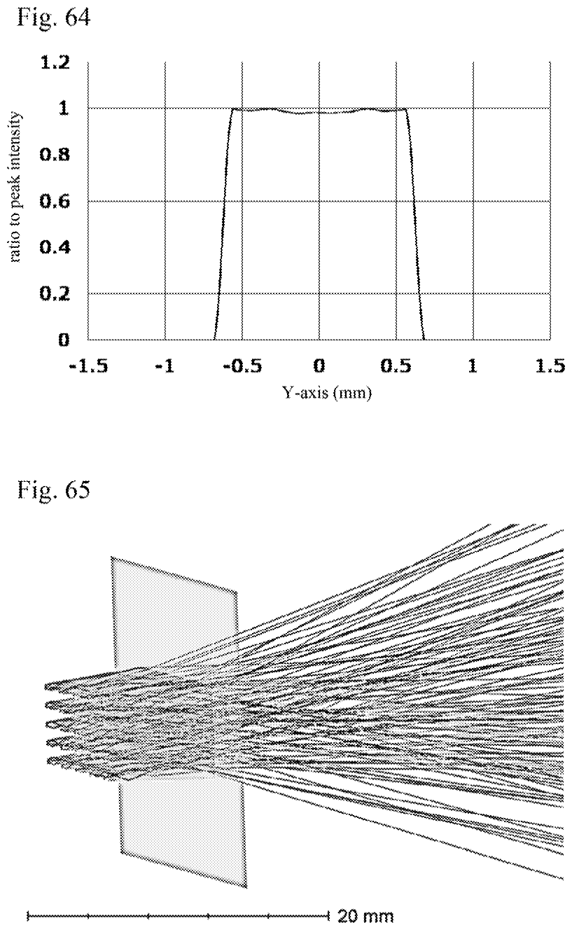

In Example 51, where the incident portion was a rectangular CPC and the total length L was 1.2 times the diagonal D of the exit face, as shown in FIGS. 57 and 58, both the X-direction and Y-direction illuminance distributions at the exit face showed variation of 10% or more and were not uniform. In Example 52, where the incident portion was an elliptical frustum and the total length L was 1.8 times the diagonal D of the exit face, the divergence angle at the exit face was good. However, as shown in FIGS. 59 and 60, both X-direction and Y-direction illuminance distributions showed variation of 5% or more and could not be said to be sufficiently uniform. In contrast, in Examples 53 and 54, where the incident portion was a rectangular frustum and the total length L was 2.4 times the diagonal D of the exit face, both had small divergence angles and the variation of the X-direction and Y-direction illuminance distributions was 5% or less, with excellent uniformity. The results for Example 54 are shown in FIG. 61 and FIG. 62. In Examples 55 and 56, where the incident portion was a circular CPC and the total length L was 2.4 times the diagonal D of the exit face, both had small divergence angles and the variation of the X-direction and Y-direction illuminance distributions was 5% or less, with excellent uniformity. The results for Example 55 are shown in FIG. 63 and FIG. 64.

From the above evaluation results regarding boundary values, the following was determined. When the incident portion is a rectangular CPC, good results for both uniformity of the illuminance distribution at the exit face and narrowing of the divergence angle are obtained when L/D is 1.5 to 5, but the uniformity deteriorates when L/D becomes 1.2. When the incident portion is an elliptical frustum, good results for both uniformity of the illuminance distribution at the exit face and narrowing of the divergence angle are obtained when L/D is 2 to 5, but the uniformity deteriorates when L/D becomes 1.8. When the incident portion is a rectangular frustum, good results for both uniformity of the illuminance distribution at the exit face and narrowing of the divergence angle are obtained when L/D is 2.4 to 5, but the uniformity deteriorates when L/D becomes 2.0. When the incident portion is a circular CPC, good results for both uniformity of the illuminance distribution at the exit face and narrowing of the divergence angle are also obtained when L/D is 2.4 to 5, but the uniformity deteriorates when L/D becomes 2.0.

### Example 6

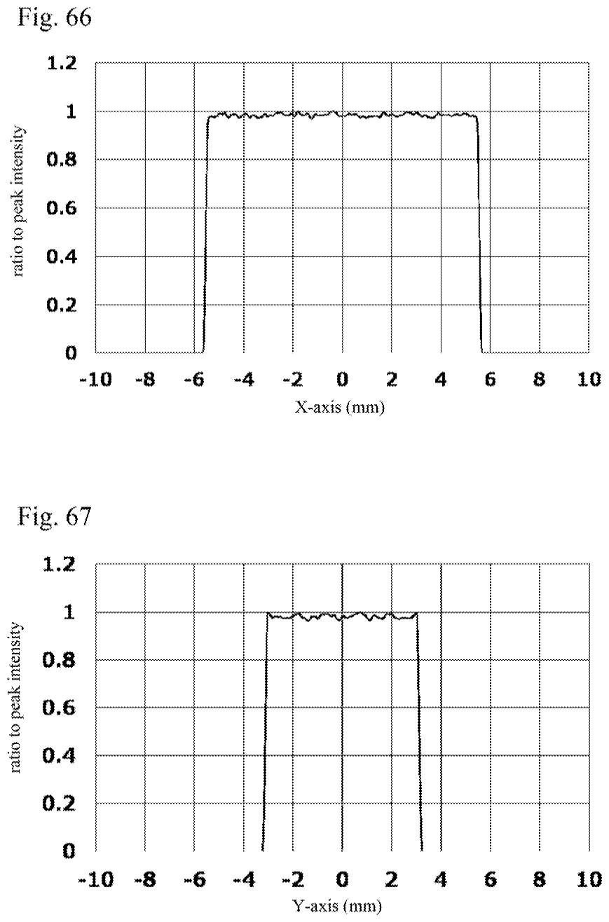

Next, the light-guiding optical component of Example 5 of the first embodiment shown in Table 1 was arranged in five rows in the height direction and five columns in the width direction without gaps, to obtain a light-guiding optical component in which 5-row-5-column light-guiding optical components were integrated. The LED elements were then arranged on the incident face of the incident portion of each of the 5-row-5-column light-guiding optical components to obtain a surface-emitting illumination device. A ray-tracing simulation (FIG. 65) was performed to evaluate the illuminance distribution (FIG. 66 and FIG. 67) at the exit face of the surface-emitting illumination. The left side of FIG. 65 shows the ray trajectory inside the light-guiding optical component, where the light beam appears dense. The exit face of the tapered portion is at the center (a rectangle indicating the exit face is visible), and to the right of the exit face of the tapered portion is outside the light-guiding optical component, where the light rays diverge from the exit face and appear sparse. Looking at the X-direction and Y-direction illuminance distributions, since the individual light-guiding optical components are in contact with each other, small non-uniformities that appear to be caused by stray light from adjacent light-guiding optical components are observed. The above described non-uniformities are considered to be avoidable by arranging the individual light-guiding optical components with gaps of approximately 0.1 mm to 0.3 mm. In addition, by arranging a condenser lens behind the above described light source, the uniformity of light entering the display element (light valve) of the projection display device is considered to be at a completely non-problematic level.

### Example 7

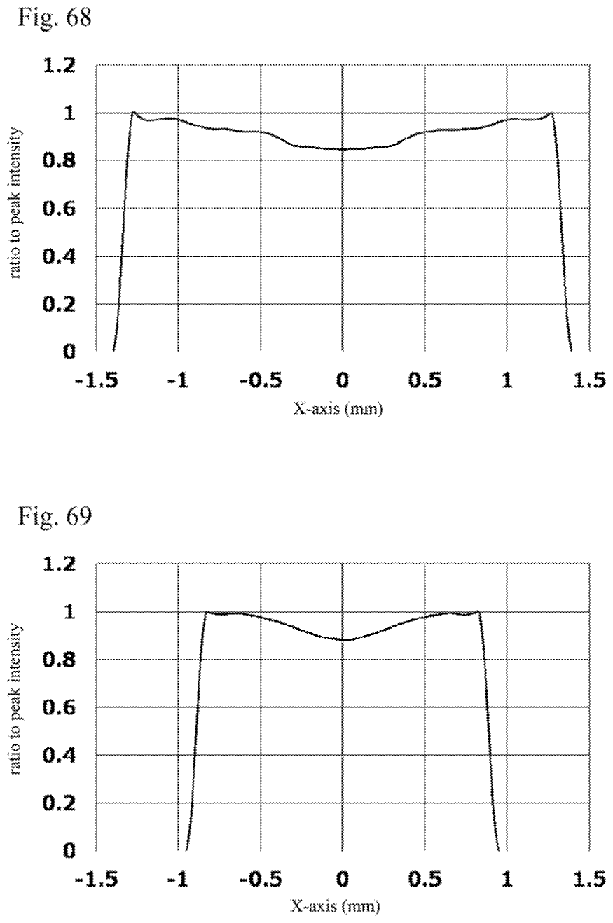

Next, in order to examine the effect of taper angles β₁ and β₂, the results of studying how the uniformity of the illuminance distribution and the divergence angle change when the taper angle is widened to enlarge the exit face, and when the taper angle is narrowed to reduce the exit face, using Examples 2 and 4 in Table 1 for [Example 1] as standard models, are shown in Table 13. The parameters used in the simulation are shown in Table 14. When the taper angle of Example 2 was widened to enlarge the exit face (FIG. 68) and when the taper angle was narrowed to reduce the exit face (FIG. 69), the uniformity of the illuminance distribution greatly deteriorated. When the taper angle of Example 4 was widened to enlarge the exit face as well, the illuminance distribution similarly deteriorated drastically. On the other hand, when the taper angle of Example 4 was narrowed to reduce the exit face, the uniformity of the illuminance distribution improved somewhat, but the divergence angle became extremely large and narrowing of the divergence angle was not achieved. In this study, no taper angle existed that could further improve the results of Examples 2 and 4 listed in Table 1.

TABLE 13
present (the first) invention having length
2 times of diagonal length D of exit face
length: 5.10 mm (incident portion: 0.5 mm),
incident face: 0.3 × 0.3 mm

| | embodiment 10 | embodiment 2 | embodiment 11 |
|---|---|---|---|
| exit face size | 2.67 × 1.50 | 2.22 × 1.25 | 1.78 × 1.00 |
| H₂ × W₂ | mm | mm | mm |
| standardization of | 1.2 times | standard | 0.8 times |
| exit face size | | | |
| X divergence | ±19.74° | ±13.35° | ±15.01° |
| angle (FWHM) | | | |
| Y divergence | ±13.31° | ±16.97° | ±21.74° |
| angle (FWHM) | | | |
| uniformity of exit | X | ◯ | X |
| light | | | |

present (the first) invention having length 2
times of diagonal length D of exit face
length: 5.10 mm (incident portion: 0.7 mm),
incident face: 0.7 × 0.4 mm

| | embodiment 12 | embodiment 13 | embodiment 4 | embodiment 14 |
|---|---|---|---|---|
| exit face size | 3.11 × 1.75 | 2.67 × 1.50 | 2.22 × 1.25 | 1.78 × 1.00 |
| H₂ × W₂ | mm | mm | mm | mm |
| standardization of | 1.4 times | 1.2 times | standard | 0.8 times |
| exit face size | | | | |
| X divergence | ±22.30° | ±22.14° | ±22.05° | ±33.87° |
| angle (FWHM) | | | | |
| Y divergence | ±15.70° | ±20.19° | ±22.56° | ±31.58° |
| angle (FWHM) | | | | |
| uniformity of exit | X | X | Δ | ◯ |
| light | | | | |

present (the first) invention having length
2 times of diagonal length D of exit face
incident face: 0.3 × 0.3 mm,
exit face: 2.22 × 1.25 mm

| | embodiment 15 | | embodiment 2 | | embodiment 16 | |
|---|---|---|---|---|---|---|
| total length L | 4.85 | mm | 5.10 | mm | 5.34 | mm |
| incident portion | 0.25 | mm | 0.5 | mm | 0.74 | mm |

length L₂

| | | | | | |
|---|---|---|---|---|---|
| standardization of | −0.25 | mm | standard | +0.24 | mm |

| | | | |
|---|---|---|---|
| length of incident | | | |
| face size | | | |
| X divergence | ±15.58° | ±13.35° | ±10.31° |
| angle (FWHM) | | | |
| Y divergence | ±18.78 | ±16.97° | ±15.88° |
| angle (FWHM) | | | |
| uniformity of exit | X | ◯ | X |
| light | | | |

TABLE 14

| | | | | |
|---|---|---|---|---|
| total | total length L (mm) | 5.10 | 5.10 | 5.10 |
| incident portion | incident portion | 0.5 | 0.5 | 0.5 |
| (rectangular CPC) | length L₂ (mm) | | | |
| | incident face size | 0.3 × | 0.3 × | 0.3 × |
| | H₃ × W₃ (mm) | 0.3 | 0.3 | 0.3 |
| tapered portion | tapered portion length | 4.6 | 4.6 | 4.6 |
| (rectangular | L₁ (mm) | | | |
| frustum) | incident face size | 0.59 × | 0.59 × | 0.59 × |
| | H₁ × W₁ (mm) | 0.57 | 0.57 | 0.57 |
| | left/right face tapered | 7.4 | 10.0 | 12.7 |
| | angle β₂ (°) | | | |
| | upper/lower face | 2.7 | 4.2 | 5.8 |
| | tapered angle β₁ (°) | | | |
| | standardization of exit | 0.8 times | standard | 1.2 times |
| | face size | | | |
| | exit face size | 1.78 × | 2.22 × | 2.67 × |
| | H₂ × W₂ (mm) | 1.00 | 1.25 | 1.50 |

| | | | | | |
|---|---|---|---|---|---|
| total | total length L (mm) | 5.10 | 5.10 | 5.10 | 5.10 |
| incident portion | incident portion | 0.7 | 0.7 | 0.7 | 0.7 |
| (rectangular CPC) | length L₂ (mm) | | | | |
| | incident face size | 0.7 × | 0.7 × | 0.7 × | 0.7 × |
| | H₃ × W₃ (mm) | 0.4 | 0.4 | 0.4 | 0.4 |
| tapered portion | tapered portion length | 4.4 | 4.4 | 4.4 | 4.4 |
| (rectangular | L₁ (mm) | | | | |
| frustum) | incident face size | 1.19 × | 1.19 × | 1.19 × | 1.19 × |
| | H₁ × W₁ (mm) | 0.76 | 0.76 | 0.76 | 0.76 |
| | left/right face tapered | 3.8 | 6.7 | 9.5 | 12.3 |
| | angle β₂ (°) | | | | |
| | upper/lower face | 1.6 | 3.2 | 4.8 | 6.4 |
| | tapered angle β₁ (°) | | | | |
| | standardization of exit | 0.8 times | standard | 1.2 times | 1.4 times |
| | face size | | | | |
| | exit face size | 1.78 × | 2.22 × | 2.67 × | 3.11 × |
| | H₂ × W₂ (mm) | 1.00 | 1.25 | 1.50 | 1.75 |

Next, in order to investigate how varying the length L₂ of the incident portion affects the illuminance distribution and the divergence angle, simulations were performed using Example 2 in Table 1 for [Example 1] as the standard model for the case of shortening the incident portion (Example 15) and the case of lengthening the incident portion (Example 16). The simulation results are listed in Table 13, and the parameters used in the simulation are shown in Table 15. Whether the length of the incident portion was shortened or lengthened, the uniformity of the exiting light (illuminance distribution) greatly deteriorated. When the length of the incident portion was shortened, the illuminance distribution in the X direction increased greatly near the center. When the length of the incident portion was lengthened, conversely, the X-direction illuminance distribution showed a large dip near the center. Namely, in this study, no length of the incident portion existed that exceeded Example 2.

TABLE 15

| | | | | |
|---|---|---|---|---|
| total | total length L (mm) | 4.85 | 5.10 | 5.34 |
| incident portion | incident portion length L₂ | 0.25 | 0.5 | 0.74 |
| (rectangular CPC) | (mm) | | | |
| | standardization of incident | −0.25 | standard | +0.24 |
| | portion length | | | |
| | incident face size | 0.3 × | 0.3 × | 0.3 × |
| | H₃ × W₃ (mm) | 0.3 | 0.3 | 0.3 |
| tapered portion | tapered portion length L₁ | 4.6 | 4.6 | 4.6 |
| (rectangular | (mm) | | | |
| frustum) | incident face size of tapered | 0.50 × | 0.59 × | 0.62 × |
| | portion H₁ × W₁ (mm) | 0.49 | 0.57 | 0.59 |
| | left/right face tapered angle β₂ | 10.6 | 10.0 | 9.9 |
| | (°) | | | |
| | upper/lower face tapered | 4.7 | 4.2 | 4.1 |
| | angle β₁ (°) | | | |
| | exit face size H₂ × W₂ (mm) | 2.22 × | 2.22 × | 2.22 × |
| | | 1.25 | 1.25 | 1.25 |

### SUMMARY

All simulated data are summarized in Table 16. As described above, the following conclusions can be drawn.

(1) With a conventional tapered light tunnel, unless the total length of the tapered light tunnel is 6 times or more the diagonal of the exit face, both uniformity of the illuminance distribution at the exit face and narrowing of the divergence angle of light entering from the incident face cannot be achieved.

(2) When an incident portion comprising a rectangular CPC is provided continuously with the tapered portion and the angle (β₃ and β₄) formed between the tangent plane at any position on the upper/lower side faces and left/right side faces forming the rectangular CPC and the optical axis is set greater than the taper angle (β₁ and β₂) of the corresponding tapered portion, both uniformity of the illuminance distribution at the exit face and narrowing of the divergence angle of light entering from the incident face can be achieved and the light-guiding optical component can be made high-performance and compact with a short total length L of 1.5 times or more and 5 times or less the diagonal D of the exit face of the tapered portion. At this time, the ratio L₂/L₁ of the length of the incident portion to the length of the tapered portion is in the range of 2.4% to 13.4%, the angle β₁ of the upper/lower face of the tapered portion is 1.9° to 5.8°, and the angle β₂ of the left/right face of the tapered portion is in the range of 4.1° to 13.8°.

(3) When an incident portion comprising a second rectangular frustum is provided continuously with the tapered portion and the angle (β₅ and β₆) formed between the upper/lower side faces and left/right side faces forming the second rectangular frustum and the horizontal plane and vertical plane containing the optical axis is set greater than the taper angle (β₁ and β₂) of the corresponding tapered portion, the light-guiding optical component can be made high-performance and compact with a short total length L of 2.4 times or more and 5 times or less the diagonal D of the exit face of the tapered portion. At this time, the ratio L₂/L₁ of the length of the incident portion to the length of the tapered portion is in the range of 5.8% to 19.6%, the angle β₁ of the upper/lower face of the tapered portion is 1.1° to 3.3°, and the angle β₂ of the left/right face of the tapered portion is in the range of 3.3° to 6.4°.

(4) When an incident portion comprising an elliptical frustum is provided continuously with the tapered portion and the angle (39) formed between the optical axis and the inclination angle at any position on the inclined face of the elliptical frustum is set greater than the taper angles (β₇ and β₈) of the tapered portion, both uniformity of the illuminance distribution at the exit face and narrowing of the divergence angle of light entering from the incident face can be achieved and the light-guiding optical component can be made high-performance and compact with a short total length L of 2 times or more and 5 times or less the diagonal D of the exit face of the tapered portion. At that time, the ratio L₂/L₁ of the length of the incident portion to the length of the tapered portion is in the range of 14.2% to 41.6%, the angle β₇ of the upper/lower face of the tapered portion is 1.2° to 4.2°, and the angle β₈ of the left/right face of the tapered portion is in the range of 3.1° to 7.3°.

(5) When an incident portion of a circular CPC is provided continuously with the tapered portion and the angle (β₁₀) formed between the tangent plane at any position on any side face forming the circular CPC and the optical axis is set greater than the taper angles (β₇ and β₈) of the tapered portion, both uniformity of the illuminance distribution at the exit face and narrowing of the divergence angle can be achieved, and the light-guiding optical component can be made high-performance and compact with a short total length L of 2.4 times or more and 5 times or less the diagonal D of the exit face of the tapered portion. At this time, the ratio L₂/L₁ of the length of the incident portion to the length of the tapered portion is in the range of 11.3% to 16.7%, the angle β₇ of the upper/lower face of the tapered portion is 0.5° to 3.5°, and the angle β₈ of the left/right face of the tapered portion is in the range of 3.0° to 8.1°.

(6) By arranging a plurality of the light-guiding optical components described in (2) to (5) above, a light-guiding optical component can be obtained that has a uniform illuminance distribution and small divergence angle over a wide exit face.

(7) By arranging an LED light source in contact with the incident face of the light-guiding optical components described in (2) to (6) above, an illumination device with a uniform illuminance distribution and small divergence angle can be obtained.

(8) By using the illumination device described in (7) above together with lens means, a light valve, an enlargement optical lens system and a screen, a projection display device with excellent uniform illuminance distribution and minimal color unevenness can be obtained.

TABLE 16

| | total length L/ratio | 1.2 | | 1.5 | | 1.5 | | 1.5 | | 1.8 | | 2 | | 2 | 2 | | 2 | |
|---|---|---|---|---|---|---|---|---|---|---|---|---|---|---|---|---|---|---|
| | of diagonal length D | | | | | | | | | | | | | | | | | |
| | of exit face | | | | | | | | | | | | | | | | | |
| | incident face size | 0.3*0.3 | | 0.3*0.3 | | 0.7*0.4 | | 1.1*0.6 | | 0.3*0.3 | | 0.3*0.3 | | 0.4*0.4 | 0.7*0.4 | | 1.1*0.6 | |
| | mm | | | | | | | | | | | | | | | | | |
| without | left/right face | 17.4 | | 14.1 | | 11.2 | | 8.3 | | 11.8 | | 10.7 | | | 8.5 | | 6.3 | |
| incident | tapered angle β₂ | | | | | | | | | | | | | | | | | |
| portion | upper/lower face | 8.8 | | 7.1 | | 6.3 | | 4.9 | | 5.9 | | 5.3 | | | 4.8 | | 3.6 | |
| | tapered angle β₁ | | | | | | | | | | | | | | | | | |
| | divergence angle X-Y | Δ | ⊚ | ◯ | ⊚ | Δ | ⊚ | Δ | X | ◯ | ⊚ | ◯ | ⊚ | | ◯ | ◯ | Δ | X |

| | uniformity | X | | X | | X | X | X | X | | | | Δ | | Δ |
|---|---|---|---|---|---|---|---|---|---|---|---|---|---|---|---|
| rectangular | length of incident | 1/4.1 | | 1/8.6 | | | | | 1/9.2 | | 1/7.5 | | 1/6.3 | | |
| CPC | portion L₂/L₁ | | | | | | | | | | | | | | |
| | left/right face | 16.3 | | 13.8 | | | | | 10.0 | | 9.2 | | 6.7 | | |
| | tapered angle β₂ | | | | | | | | | | | | | | |
| | upper/lower face | 5.2 | | 5.8 | | | | | 4.2 | | 4.0 | | 3.2 | | |
| | tapered angle β₁ | | | | | | | | | | | | | | |
| | divergence angle X-Y | Δ | ◯ | ◯ | ⊚ | | | | ⊚ | ◯ | ⊚ | ◯ | Δ | Δ | |

| | uniformity | X | ◯ | | | | ⊚ | | ◯ | | Δ | |
|---|---|---|---|---|---|---|---|---|---|---|---|---|
| rectangular | length of incident | | 1/8.6 | | | | 1/4.1 | | 1/3.6 | | 1/2.9 | |
| frustum | portion L₂/L₁ | | | | | | | | | | | |
| | left/right face | | 13.1 | | | | 9.2 | | 6.4 | | 4.4 | |
| | tapered angle β₂ | | | | | | | | | | | |
| | upper/lower face | | 6.3 | | | | 3.6 | | 0.8 | | 2.3 | |
| | tapered angle β₁ | | | | | | | | | | | |
| | divergence angle X-Y | | ◯ | ⊚ | | | ⊚ | ⊚ | ⊚ | ⊚ | ◯ | ◯ |
| | uniformity | | Δ | | | | Δ | | Δ | | Δ | |
| circular | length of incident | | 1/3.3 | | | | 1/2.4 | | 1/5.4 | | | |
| CPC | portion L₂/L₁ | | | | | | | | | | | |
| | left/right face | | 11.2 | | | | 9.4 | | 8.5 | | | |
| | tapered angle β₂ | | | | | | | | | | | |
| | upper/lower face | | 5.3 | | | | 3.4 | | 3.9 | | | |
| | tapered angle β₁ | | | | | | | | | | | |
| | divergence angle X-Y | | ◯ | ◯ | | | ⊚ | ⊚ | ⊚ | ◯ | | |
| | uniformity | | Δ | | | | Δ | | Δ | | | |
| elliptical | length of incident | | 1/2.5 | | 1/2.3 | | 1/2.4 | | 1/6.3 | | 1/5.4 | |
| frustum | portion L₂/L₁ | | | | | | | | | | | |
| | left/right face | | 10.2 | | 8.3 | | 7.3 | | 6.9 | | 6.3 | |
| | tapered angle β₂ | | | | | | | | | | | |
| | upper/lower face | | 5.0 | | 2.6 | | 2.1 | | 4.2 | | 3.5 | |
| | tapered angle β₁ | | | | | | | | | | | |
| | divergence angle X-Y | | ⊚ | ⊚ | ⊚ | ⊚ | ◯ | ⊚ | ◯ | ◯ | Δ | Δ |

| | uniformity | | | Δ | | | | | Δ | ◯ | ◯ | | ◯ | | | |
|---|---|---|---|---|---|---|---|---|---|---|---|---|---|---|---|---|
| | total length L/ratio | 2.4 | | 2.4 | 2.4 | | 3 | | 3 | 3 | 3 | | 3 | | 4 | |
| | of diagonal length D | | | | | | | | | | | | | | | |
| | of exit face | | | | | | | | | | | | | | | |
| | incident face size | 0.3*0.3 | | 0.4*0.4 | 0.7*0.4 | | 0.3*0.3 | | 0.4*0.4 | 0.5*0.5 | 0.7*0.4 | | 1.1*0.6 | | 0.3*0.3 | |
| | mm | | | | | | | | | | | | | | | |
| without | left/right face | 8.9 | | | 7.1 | | 7.2 | | | | 5.7 | | 4.2 | | 5.4 | |
| incident | tapered angle β₂ | | | | | | | | | | | | | | | |
| portion | upper/lower face | 4.4 | | | 4.0 | | 3.6 | | | | 3.2 | | 2.4 | | 2.7 | |
| | tapered angle β₁ | | | | | | | | | | | | | | | |
| | divergence angle X-Y | ⊚ | ⊚ | | ◯ | ◯ | ⊚ | ⊚ | | | ⊚ | ◯ | Δ | X | ⊚ | ⊚ |

| | uniformity | Δ | | | | Δ | X | | | | | | X | ◯ | X | |
|---|---|---|---|---|---|---|---|---|---|---|---|---|---|---|---|---|
| rectangular | length of incident | | | | | | 1/18.1 | | 1/18.1 | | | | | | 1/24.5 | |
| CPC | portion L₂/L₁ | | | | | | | | | | | | | | | |
| | left/right face | | | | | | 6.4 | | 6.1 | | | | | | 5.1 | |
| | tapered angle β₂ | | | | | | | | | | | | | | | |
| | upper/lower face | | | | | | 3.2 | | 2.6 | | | | | | 2.3 | |
| | tapered angle β₁ | | | | | | | | | | | | | | | |
| | divergence angle X-Y | | | | | | ⊚ | ⊚ | ⊚ | ◯ | | | | | ⊚ | ⊚ |
| | uniformity | | | | | | ◯ | | ◯ | | | | | | ⊚ | |
| rectangular | length of incident | 1/5.8 | | 1/5.1 | | | 1/8.6 | | 1/8.6 | | | | | | 1/11.8 | |
| frustum | portion L₂/L₁ | | | | | | | | | | | | | | | |
| | left/right face | 6.1 | | 6.4 | | | 5.2 | | 4.8 | | | | | | 4.4 | |
| | tapered angle β₂ | | | | | | | | | | | | | | | |
| | upper/lower face | 3.3 | | 2.6 | | | 2.6 | | 1.6 | | | | | | 2.0 | |
| | tapered angle β₁ | | | | | | | | | | | | | | | |
| | divergence angle X-Y | ⊚ | ⊚ | ⊚ | ◯ | | ⊚ | ⊚ | ⊚ | ⊚ | | | | | ⊚ | ⊚ |
| | uniformity | ◯ | | ⊚ | | | ◯ | | ◯ | | | | | | ⊚ | |
| circular | length of incident | 1/6.7 | | 1/6.7 | | | 1/6.7 | | 1/6.0 | | 1/6.0 | | | | 1/7.5 | |
| CPC | portion L₂/L₁ | | | | | | | | | | | | | | | |
| | left/right face | 8.1 | | 6.6 | | | 5.6 | | 5.0 | | 4.6 | | | | 4.0 | |
| | tapered angle β₂ | | | | | | | | | | | | | | | |
| | upper/lower face | 2.7 | | 3.5 | | | 2.2 | | 2.1 | | 1.8 | | | | 1.1 | |
| | tapered angle β₁ | | | | | | | | | | | | | | | |
| | divergence angle X-Y | ⊚ | ◯ | ◯ | ◯ | | ⊚ | ⊚ | ⊚ | ⊚ | ◯ | ⊚ | | | ⊚ | ⊚ |

| | uniformity | ◯ | ◯ | | | | ⊚ | | ⊚ | | ◯ | | | | | | ⊚ | |
|---|---|---|---|---|---|---|---|---|---|---|---|---|---|---|---|---|---|---|
| elliptical | length of incident | | | | | | 1/6.7 | | 1/5.4 | | | | | | | | 1/4.4 | |
| frustum | portion L₂/L₁ | | | | | | | | | | | | | | | | | |
| | left/right face | | | | | | 5.2 | | 5.5 | | | | | | | | 4.0 | |
| | tapered angle β₂ | | | | | | | | | | | | | | | | | |
| | upper/lower face | | | | | | 2.4 | | 2.2 | | | | | | | | 1.2 | |
| | tapered angle β₁ | | | | | | | | | | | | | | | | | |
| | divergence angle X-Y | | | | | | ⊚ | ⊚ | ⊚ | ⊚ | | | | | | | ⊚ | ⊚ |
| | uniformity | | | | | | ⊚ | | ⊚ | | | | | | | | ⊚ | |
| | total length L/ratio | 4 | 4 | | 4 | | 5 | | 5 | | 5 | | 6 | | 6 | | 6 | |
| | of diagonal length D | | | | | | | | | | | | | | | | | |
| | of exit face | | | | | | | | | | | | | | | | | |
| | incident face size | 0.4*0.4 | 0.7*0.4 | | 1.1*0.6 | | 0.3*0.3 | | 0.7*0.4 | | 1.1*0.6 | | 0.3*0.3 | | 0.7*0.4 | | 1.1*0.6 | |
| | mm | | | | | | | | | | | | | | | | | |
| without | left/right face | | 4.3 | | 3.1 | | 4.3 | | 3.4 | | 2.5 | | 3.6 | | 2.8 | | 2.1 | |
| incident | tapered angle β₂ | | | | | | | | | | | | | | | | | |
| portion | upper/lower face | | 2.4 | | 1.8 | | 2.1 | | 1.9 | | 1.5 | | 1.8 | | 1.6 | | 1.2 | |
| | tapered angle β₁ | | | | | | | | | | | | | | | | | |
| | divergence angle X-Y | | ◯ | ◯ | X | X | ⊚ | ⊚ | ◯ | ◯ | X | X | ⊚ | ⊚ | ◯ | ◯ | X | X |

| | uniformity | | | Δ | ◯ | Δ | | Δ | ◯ | ⊚ | ⊚ | ⊚ |
|---|---|---|---|---|---|---|---|---|---|---|---|---|
| rectangular | length of incident | 1/16.0 | | | | 1/41.5 | | | | | | |
| CPC | portion L₂/L₁ | | | | | | | | | | | |
| | left/right face | 4.8 | | | | 4.1 | | | | | | |
| | tapered angle β₂ | | | | | | | | | | | |
| | upper/lower face | 1.9 | | | | 1.9 | | | | | | |
| | tapered angle β₁ | | | | | | | | | | | |
| | divergence angle X-Y | ⊚ | ◯ | | | ⊚ | ⊚ | | | | | |
| | uniformity | ⊚ | | | | ⊚ | | | | | | |
| rectangular | length of incident | 1/9.2 | | | | 1/17.2 | | | | | | |
| frustum | portion L₂/L₁ | | | | | | | | | | | |
| | left/right face | 3.3 | | | | 3.5 | | | | | | |
| | tapered angle β₂ | | | | | | | | | | | |
| | upper/lower face | 1.1 | | | | 1.5 | | | | | | |
| | tapered angle β₁ | | | | | | | | | | | |
| | divergence angle X-Y | ⊚ | ⊚ | | | ⊚ | ⊚ | | | | | |
| | uniformity | ⊚ | | | | ⊚ | | | | | | |
| circular | length of incident | 1/6.8 | | | | 1/8.8 | | | | | | |
| CPC | portion L₂/L₁ | | | | | | | | | | | |
| | left/right face | 3.7 | | | | 3.0 | | | | | | |
| | tapered angle β₂ | | | | | | | | | | | |
| | upper/lower face | 0.5 | | | | 0.8 | | | | | | |
| | tapered angle β₁ | | | | | | | | | | | |
| | divergence angle X-Y | ⊚ | ⊚ | | | ⊚ | ⊚ | | | | | |
| | uniformity | ⊚ | | | | ⊚ | | | | | | |
| elliptical | length of incident | 1/6.8 | | | | 1/7.0 | | | | | | |
| frustum | portion L₂/L₁ | | | | | | | | | | | |
| | left/right face | 3.8 | | | | 3.1 | | | | | | |
| | tapered angle β₂ | | | | | | | | | | | |
| | upper/lower face | 1.4 | | | | 1.2 | | | | | | |
| | tapered angle β₁ | | | | | | | | | | | |
| | divergence angle X-Y | ⊚ | ⊚ | | | ⊚ | ⊚ | | | | | |

| | | |
|---|---|---|
| uniformity | ⊚ | ⊚ |

### DESCRIPTION OF THE REFERENCE NUMERALS

101: rectangular-pillar-shaped light tunnel
102: incident face of rectangular-pillar-shaped light tunnel
103: exit face of rectangular-pillar-shaped light tunnel
104: side face of rectangular-pillar-shaped light tunnel
201: tapered light tunnel
202: incident face of tapered light tunnel
203: exit face of tapered light tunnel
204: side face of tapered light tunnel
301: one example of light-guiding optical component of the present invention
302: incident face of one example of light-guiding optical component of the present invention
303: exit face of one example of light-guiding optical component of the present invention
304: left/right side face of tapered portion of one example of light-guiding optical component of the present invention
305: upper/lower side face of tapered portion of one example of light-guiding optical component of the present invention
306: top face of tapered portion of one example of light-guiding optical component of the present invention (also bottom face of incident portion)
307: upper/lower side face of incident portion of one example of light-guiding optical component of the present invention
308: left/right side face of incident portion of one example of light-guiding optical component of the present invention
309: one example of lens portion of one example of light-guiding optical component of the present invention
310: exit face of one example of lens portion of one example of light-guiding optical component of the present invention
701: LED light source
702: condenser lens
703: primary lens
704: light valve
705: reflective mirror
706: enlargement projection unit

1. A light-guiding optical component comprising a solid tapered portion and a solid incident portion, wherein
the solid tapered portion has a length L₁ and is a flared rectangular frustum that widens in a propagation direction of light at an angle β₁ in a height direction and at an angle β₂ in a width direction with respect to an optical axis from an incident face having a rectangular or square shape with a height H₁ and a width W₁ toward an exit face having a rectangular shape with a height H₂ and a width W₂,
$$the height {H}_{2} > the height {H}_{1} ,$$
$$the width {W}_{2} > the width {W}_{1} ,$$
the solid incident portion has a length L₂ and is formed continuously with the solid tapered portion, the solid incident portion being a rectangular CPC having a bottom face of a rectangular or square shape with the height H₁ and the width W₁ and a top face having a rectangular or square shape with a height H₃ and a width W₃,
all upper/lower side faces and left/right side faces constituting the rectangular CPC are formed of internally reflective compound parabolic surfaces,
an angle β₃ formed between a tangent plane at any position on the upper/lower side face and a horizontal plane containing the optical axis is greater than the angle β₁,
an angle β₄ formed between a tangent plane at any position on the left/right side face and a vertical plane containing the optical axis is greater than the angle β₂, and
a total length L of the length L₁ of the solid tapered portion and the length L₂ of the rectangular CPC is 1.5 times or more and 5 times or less a diagonal length D of the exit face of the solid tapered portion.

2. The light-guiding optical component according to claim 1, wherein
the length L₂ of the rectangular CPC is in the range of 2.4% to 13.4% of the length L₁ of the solid tapered portion.

3. The light-guiding optical component according to claim 1, wherein
the angle β₁ is in the range of 1.9° to 5.8° and the angle β₂ is in the range of 4.1° to 13.8°.

4. A light-guiding optical component comprising a solid tapered portion and a solid incident portion, wherein
the solid tapered portion has a length L₁ and is a first flared rectangular frustum that widens in a propagation direction of light at an angle β₁ in a height direction and at an angle β₂ in a width direction with respect to an optical axis from an incident face having a rectangular or square shape with a height H₁ and a width W₁ toward an exit face having a rectangular shape with a height H₂ and a width W₂,
$$the height {H}_{2} > the height {H}_{1} ,$$
$$the width {W}_{2} > the width {W}_{1} ,$$
the solid incident portion has a length L₂ and is formed continuously with the solid tapered portion, the solid incident portion being a second rectangular frustum having a bottom face of a rectangular or square shape with the height H₁ and the width W₁ and a top face of a rectangular or square shape with a height H₃ and a width W₃,
four side faces of the second rectangular frustum are formed of flat trapezoids,
an angle β₅ formed between each of the flat trapezoids of upper/lower side faces and a horizontal plane containing the optical axis is greater than the angle β₁ at any position,
an angle β₆ formed between each of the flat trapezoids of left/right side faces and a vertical plane containing the optical axis is greater than the angle β₂ at any position,
a total length L of the length L₁ of the solid tapered portion and the length L₂ of the second rectangular frustum is 2.4 times or more and 5 times or less a diagonal length D of the exit face of the solid tapered portion that is the first flared rectangular frustum, and
the length L₂ of the second rectangular frustum is in the range of 5.8% to 19.6% of the length L₁ of the solid tapered portion.

5. The light-guiding optical component according to claim 4, wherein
the angle β₁ is in the range of 1.1° to 3.3° and the angle β₂ is in the range of 3.3° to 6.4°.

6. A light-guiding optical component comprising a tapered portion and an incident portion, wherein
the tapered portion has a length L₁ and is a first flared solid rectangular frustum that widens in a propagation direction of light at an angle β₇ in a height direction and at an angle β₈ in a width direction with respect to an optical axis from an incident face having a rectangular shape with a height a₁ and a width b₁ toward an exit face having a rectangular shape with a height H₂ and a width W₂,
$$the height {H}_{2} > the height {a}_{1} ,$$
$$the width {W}_{2} > the width {b}_{1} ,$$
the solid incident portion has a length L₂ and is formed continuously with the tapered portion, the incident portion being an elliptical frustum having a bottom face having a rectangular shape with a height a₁ and width b₁ and a top face having an ellipse shape with a minor axis a₃ and a major axis b₃,
an angle β₉ formed between an inclined face and the optical axis of the elliptical frustum is greater than the angle β₇ and the angle β₈ at any position, and
a total length L of the length L₁ of the tapered portion and the length L₂ of the elliptical frustum is 2 times or more and 5 times or less a diagonal length D of the exit face of the tapered portion.

7. The light-guiding optical component according to claim 6,
the length L₂ of the elliptical frustum is in the range of 14.2% to 41.6% of the length L₁ of the solid tapered portion.

8. The light-guiding optical component according to claim 6,
the angle β₇ is in the range of 1.2° to 4.2° and the angle β₈ is in the range of 3.1° to 7.3°.

9. A light-guiding optical component comprising a tapered portion and an incident portion, wherein
the tapered portion has a length L₁ and is a flared rectangular frustum that widens at an angle β₇ in a height direction and at an angle β₈ in a width direction with respect to an optical axis from an incident face having a rectangular shape with a height a₁ and a width b₁ toward an exit face having a rectangular with a height H₂ and a width W₂,
the incident portion has a length L₂ and is formed continuously with the tapered portion, the incident portion comprising a circular CPC having a bottom face of a rectangular shape with a height a₁ and a width b₁, a top face of a circular shape with a diameter a₃, and a side face that is an internally reflective paraboloid,
$$the height {a}_{1} = the width {b}_{1} ,$$
an angle β₁₀ formed between a tangent plane on the side face of the incident portion and the optical axis is greater than the angle β₇ and the angle β₈ at any position, and
a total length L of the length L₁ of the tapered portion and the length L₂ of the circular CPC is in the range of 2.4 times or more and 5 times or less a diagonal length D of the exit face of the tapered portion.

10. The light-guiding optical component according to claim 9, wherein
the length L₂ of the circular CPC is in the range of 11.3% to 16.7% of the length L₁ of the tapered portion.

11. The light-guiding optical component according to claim 9, wherein
the angle β₇ is in the range of 0.5° to 3.5° and the angle β₈ is in the range of 3.0° to 8.1°.

12. The light-guiding optical component according to claim 1, wherein
a lens having a converging action or diverging action is integrated at a position of the exit face of the solid tapered portion.

13. The light-guiding optical component according to claim 4, wherein
a lens having a converging action or diverging action is integrated at a position of the exit face of the solid tapered portion.

14. The light-guiding optical component according to claim 6, wherein
a lens having a converging action or diverging action is integrated at a position of the exit face of the solid tapered portion.

15. The light-guiding optical component according to claim 9, wherein
a lens having a converging action or diverging action is integrated at a position of the exit face of the solid tapered portion.

16. A light-guiding optical component in which a plurality of light-guiding optical components is arranged and integrated, each of the plurality of light-guiding optical components being the light-guiding optical component according to claim 1.

17. A light-guiding optical component in which a plurality of the light-guiding optical components is arranged and integrated, each of the plurality of light-guiding optical components being the light-guiding optical component according to claim 4.

18. A light-guiding optical component in which a plurality of the light-guiding optical components is arranged and integrated, each of the plurality of light-guiding optical components being the light-guiding optical component according to claim 6.

19. A light-guiding optical component in which a plurality of the light-guiding optical components is arranged and integrated, each of the plurality of light-guiding optical components being the light-guiding optical component according to claim 9.

20. An illumination device in which an LED optical element is arranged in contact with the incident face of the solid incident portion of the light-guiding optical component according to claim 1 to cause light emission.

21. A projection display device comprising the illumination device according to claim 20, a lens unit, a light valve, an enlargement optical lens system and a screen, wherein
the light from an LED element reaching the exit face of the light-guiding optical component of the illumination device is condensed by the lens unit and irradiates the light valve, and an output image generated by the light valve is enlarged by the enlargement optical system and projected onto the screen.
